(19) United States
(12) Patent Application Publication
(10) Pub. No.: US 2016/0162882 A1
(43) Pub. Date: Jun. 9, 2016

(54) Digital money choice and eWallet selection

(71) Applicant: GUY LAMONTE MCCLUNG, III, San Antonio, TX (US)

(72) Inventor: Guy Lamonte McClung, III, San Antonio, TX (US)

(21) Appl. No.: 14/544,199

(22) Filed: Dec. 8, 2014

(51) Int. Cl. G06Q 20/36; G06Q 20/22

(52) U.S. Cl. CPC G06Q 20/36; G06Q 20/227

(57) ABSTRACT

Methods and systems for facilitating a choice by a consumer of one of a plurality of eWallets from an eWallet entity or from an eWallet provider and/or choice of a particular digital money from a plurality of virtual currency providers, with or without choice of taxing or fee country or jurisdiction for doing the transaction, with or without choice of a shipment entity for the shipment of good(s); and, in certain aspects, each eWallet provider and/or digital money provider able to access a master account of a consumer and/or digital money account(s) of the consumer; and in certain such methods, multiple entities bidding regarding price and/or incentive(s) in order to influence the consumer to choose a particular eWallet and/or a particular digital money to effect a transaction, e.g., a sales or rental transaction or a transaction for services; and such methods in which a consumer's multi-card is used. Methods and systems for funding an account, in one aspect, a pension account, insurance account, or college fund; and computer applications for effecting such funding; in certain aspects using an electronic wallet and/or a chosen digital money. Methods and systems for providing a GIFTSURANCE (trademark) insurance policy to a person or persons; and, in certain aspects, a computer application for funding such a GIFTSURANCE (trademark) policy. This abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### RELATED APPLICATIONS

This is a continuation-in-part of U.S. application Ser. No. 13/987,725 filed Aug. 24, 2013. The present invention and this patent document claim priority under the U.S. Patent Laws from U.S. Application Ser. Nos. 61/743,141, filed 27 Aug. 2012; 61/796,856 filed 21 Nov. 2012; 61/797,419 filed 6 Dec. 2012; 61/849,916 filed 5 Feb. 2013; 61/963,661 filed Dec. 9, 2013; and Ser. No. 13/987,725, filed Aug. 24, 2013—all said applications incorporated fully herein in their entirety for all purposes.

### BACKGROUND OF THE INVENTION

1. Field of the Invention

The present invention is directed to: eWallet selection for a transaction from a plurality of eWallets; digital money (virtual money, virtual currency, electronic money) choice for a transaction from a plurality of digital monies; transactions in which each of multiple eWallet providers and/or of multiple digital money providers can access a consumer's master account for payment funds; bidding methods for eWallet selection and/or digital money selection; funding a variety of accounts, particularly such funding dependent on the use of an eWallet, virtual wallet, electronic wallet, or “digital wallet” and/or use of a chosen digital money; funding systems including a pension account and methods for funding a pension account; to such systems and methods including funding based on events and/or transactions effected with or facilitated by use of a credit card, a smart card, a cellphone, internet session, computer, digital money provider, electronic wallet, smart wallet, mobile wallet or digital wallet; and such systems and methods in which not only can a person whose account is funded (e.g., but not limited to a pension account) fund the account, but other persons or entities may also fund the account; such systems and methods for funding accounts other than pension accounts, e.g., but not limited to accounts for brides and grooms, children, and relatives; and to methods for providing a gift insurance policy to a person.

2. Description of Related Art

A variety of electronic wallets, digital wallets, eMoney (virtual currency), and eWallets are available for entering into agreements and for finalizing transactions, e.g., transactions between a seller and a buyer, between a customer and a business, and between a consumer and an entity that provides a product or a service—both online (e.g., via the Internet) and offline (e.g, in a typical retail sale situation). A variety of devices are useful in such transactions (e.g., phone, cellphone, laptop computer, netbook, smartphone, desktop, notebook, iPad, tablet computer, etc.) and a variety of computer applications (“apps”) are available for facilitating such transactions. In certain aspects, such transactions are done at a business location and, in other aspects, the consumer is not present at a business location.

A wide variety of systems and methods are known for creating and funding a pension plan or retirement account and for electronic or online financial transactions; including, but not limited to, and simply by way of example and not meant as an exhaustive listing, those described in U.S. Pat. Nos. 6,064,986; 7,398,241; 7,657,489; 7,712,658; 7,783,566; 7,792,748; 7,801,829; 7,899,744; 7,962,409; 7,983,992; 8,020,754; 8,024,248; 8,070,056; 8,103,585; 6,150,767; 8,155,999; 8,190,521; 8,250,027; 8,250,244; 8,250,568; 8,255,991; 8,261,190; 8,261,293; 8,261,299; 8,276,095; 8,276,133; 8,279,831; 8,281,317; 8,286,152; 8,286,160; 8,286,174; 8,296,266; 8,296,402; 8,296,781; 8,301,771; 8,307,378; 8,307,418; 8,312,047; 8,312,127; 8,312,138; 8,314,960; 8,321,928; and 8,195,517; and in U.S. application Ser. Nos. 11/251,030; 13/032,373; 13/155,476; 13/165,180; 13/264,633; 13/299,865; 13/354,220; 13/412,957; and 13/330,264 and in all the patents and applications referred to by number below (all said patents and applications incorporated fully herein for all purposes).

### SUMMARY OF THE PRESENT INVENTION

In certain aspects, the present invention provides unique features for an eWallet provider which makes the choice of that eWallet provider more desirable to a consumer. In certain aspects, the present invention provides unique features for a digital money provider which makes the choice of that digital money provider more desirable to a consumer. For example, those features include, but are not limited to, a provider (eWallet and/or eMoney) offering automatic funding of a consumer account each time the consumer chooses to use that particular eWallet provider or that particular eMoney provider, e.g., funding of a consumer's retirement account, college fund account, wedding expense account, insurance account, present (e.g., birthday or anniversary) account, or vacation account; and/or the gift of an insurance policy to the consumer.

In certain aspects, the present invention discloses methods in which multiple entities, e.g., but not limited to, multiple eWallet providers or multiple digital money providers, bid for a consumer to choose a particular entity. In certain aspects, the present invention provides unique features for an eWallet provider which makes the choice of that eWallet provider more desirable to a consumer. In certain aspects, the present invention provides unique features for a digital money provider which makes the choice of that digital money provider more desirable to a consumer. For example, those features include, but are not limited to, a provider (eWallet and/or eMoney) offering automatic funding of a consumer account; and/or for a particular provider, negotiating, effecting and finalizing a transaction. Bids can be based on price alone or on other factors and/or additional incentives, e.g., award points, travel miles, gifts, account funding, altcoins, free or reduced shipping charges, favored/best tax/tariff treatment, most desirable and/or economical and/or valuable digital money, or warranties. “Digital money” includes, but is not limited to: eMoney, digital currency, digital coin, digital tokens, virtual currency, and Bitcoins; and the digital money provided by digital money providers, including, but not limited to altcoin providers, including but not limited to e.g. entities such as Bitcoin, Ripple, fireflycoin, bbqcoin, zeuscoin, Peercoin, and Litecoin. “eMoney” may be a synonym for “digital money.”

In certain aspects, methods are disclosed in which a single provider (eWallet and/or eMoney) has access to a consumer's master account or multiple entities, e.g., multiple providers, bid for a consumer to choose it for effecting and finalizing a transaction and each entity has access to the consumer's master account.

In certain methods herein a thing—card, drive, item with tag or chip passive or active or interactive, computer, computers, computerized phone, app, or personalized computerized devices are used in a step or steps of a method according to the present invention to convey a list of potential bidders for a and/or instructions to facilitate and/or effect bidding and bidder choice. A multi-card may be used, a card modified according to the present invention e.g. a known electronic device or card such as a known COIN (trademark) card; a card according to the present invention which contains information on a plurality of entities (credit card entities, banks, virtual money providers, eWallet providers) who the card owner wishes to be contacted as bidders. The owner may add to or delete entity listings and information, and every entity represented on, or only chosen entities, are contacted when the card is scanned, accessed or swiped; and/or if the card is interactive, or can be re-programmed, the owner can selectively choose which of the entities of the plurality of entities on a card are to be potential bidders.

In certain aspects, the present invention provides a system for funding an account each time a person chooses and engages in an action, or conducts a transaction with an entity (e.g., but not limited to with a particular eWallet provider, with a particular eMoney provider, and/or using a particular digital money). Funding can be based on both using a particular eWallet provider and doing the transaction with a particular digital money, whether or not it is done with the provider of the particular digital money. The funding may be from the person involved in the transaction and/or by another person.

In one aspect, a person receives funding of an account by entering an entity's place of business, by contacting an entity, or by accessing an entity's electronic presence, e.g., by accessing an entity's website on the Internet and/or searching a website.

In one aspect, a person receives an amount funding the person's account by the action of another person or entity based solely on the discretion of the other person or entity; for example, but not limited to, an entity pays a discretionary amount to the person's based on the age of the account; based on the loyalty of the person to the paying entity (loyalty determined by any suitable criteria by the funding entity such as, but not limited to, based on an amount of money spent by the person, number of transactions entered into) and/or based on an occurrence, e.g. the person's birthday, wedding day, wedding day anniversary, funeral, Mother's Day, Father's Day or the like, specific holiday, birth of a child; based on the entity's profits; based on an entity's payment of a dividend; or based on the sheer generosity of the entity, a “Share The Wealth” payment or “STW” payment, which can be based on any fact, anything or any event.

The entity may be a company or another person. Such a payment funding a person's account may be made by an entity that is a bank, debit, or credit card issuer, internet service provider, host system, sponsor, or digital wallet provider, with the payment made based on any suitable criteria, including, but not limited to, the fact that a charge is made to a card, the money amount of a charge, an aggregated amount of money for a plurality of charges, or a plurality of charges.

In certain aspects, the present invention provides systems and methods in which multiple entities who want to take part in persons' account funding (in any way disclosed herein) are associated together (an “associated entity” or “AE”) or under the umbrella of an overseeing entity. Such an association or umbrella may have a distinct public identity so that a person engaging in an action or conducting a transaction need only see or become aware of an entity's association to know that that entity is one that can fund the person's account under the system. In certain aspects, the identity of and the existence of an account of a person who has an account according to the present invention are maintained by an overseeing entity and/or by an AE and—whether or not the person is aware in a particular transaction with a particular AE that the particular AE is indeed an AE—the person's account is appropriately funded since the AE is an AE. Discounts and incentives can be provided based on the number of persons who sign up for a particular type of funding or account.

In other aspects, an overseeing entity, umbrella entity, or association entity funds a person's account for an action or event not involving an AE, but which involves an entity outside the association (an “outside entity” or “OE”). In one such case a person purchases an item or service from an OE and the item is made by or the service is provided by an AE. Optionally, the AE itself can fund the account.

It is within the scope of the present invention for a “pension account” in any system or method herein to be any suitable known pension account, account in a pension plan, retirement plan, or retirement account or to be an account set up specifically for the purposes of funding by a system and method according to the present invention, with improvements according to the present invention. Any pension account according to the present invention may be part of a plan or system that includes:
no payment of taxes on any of the money (or value, assets, etc.) that funds the plan until withdrawals begin
tax-deferral of any interest, dividends, or capital gains that accumulate until withdrawal

In certain aspects, the assets (money, value, points, shares, cash equivalents, etc.) of an account funded according to the present invention (by any method and/or system according to the present invention) may not be cashed out by the account owner until a predetermined date, e.g., upon the owner reaching a certain age (e.g., but not limited to, 50, 55, 60, 62, 65, 67 or 70.5 years of age), or the account assets are given to a beneficiary (for immediate use by the beneficiary or with a date limitation that prevents a beneficiary from receiving the account balance until a date in the future and/or until the beneficiary reaches a certain age). Transfer of the account assets to a beneficiary may occur upon the death of the account owner or upon a predetermined date being reached; i.e., the account can be for the benefit of the beneficiaries—in whole or in part—rather than for the benefit—in whole or in part—of the account owner. In other aspects, the assets of an account (any according to the present invention) may—in whole or in part—be transferred to the account owner—or to a designated beneficiary—at any time.

It is within the scope of the present invention that instead of funding a “pension account” in any system or method herein that the account be some other type of account—any disclosed herein. Also, the account may be legally set up so that it survives certain selected types of events, including, but not limited to, bankruptcy, dissolution, acquisition, merger, sale of company, and change of legal entity, e.g. from corporation to LLP, from LLC to Limited partnership, or vice versa. The accounts herein may be set up to be “hands off”, untouchable by the funding entities; they may also be escrowed and only transferable later to the owner.

Beneficiaries may receive funds only upon death of an owner or upon elapse of a stated post-death time; and/or the beneficiary may have no choices about amount and date of funds disbursement. Any account can be funded non-monetarily for example, by points, shares, options, or cash equivalents.

In certain aspects, the present invention provides a method and a system in which an account of a person is funded during an accumulation period. “Funding” means and includes the funding done by the person whose account it is and/or by another person or entity, such funding including any funding technique or method herein according to the present invention based on any funding action, event, or transaction disclosed herein; and in particular aspects “funding” includes the transfer or deposit into an account of money (or value; e.g., but not limited to points, shares, cash equivalents, etc.) based on the use of a network (e.g., the Internet; e.g., a transaction done in e-commerce) for a transaction and/or the use of a particular digital money and/or and/or the use of an electronic “wallet” (e.g., a smart wallet, a digital wallet, a mobile wallet, a cellphone-based wallet, and/or a cloud-based wallet).

Any transaction of a method according to the present invention or funding of a pension account according to the present invention can be based on the use of electronic money (“digital money” or “e-money”) of electronically accessing an electronic wallet or service entity, setting and storing the value of money electronically (so that it takes the role of cash in trade) and using the e-money in a transaction. Depending on where the cash value is stored, the e-money is classified into IC e-money (integrated circuit) card type of e-money and network type e-money.

In one aspect, the IC card is a card (e.g., but not limited to, credit card size) with built-in IC chips or other electronic devices for storing cash value and/or information in the form of electronic data and/or codes, e.g., so-called “smart cards”. In certain aspects, the IC card is relatively safe from forgery and alteration as it uses the IC chips for storing e-money and has an embedded CPU (central processing unit) offering computing functions. As the existing cash cards are used to withdraw cash from ATMs (automatic teller machines), the IC card can replace the cash withdrawal with an amount of e-money recharged to the IC card at a recharge machine, functioning as cash in a card affiliated store where payment is made by the e-money stored in the IC card for goods or services at a reading machine of a seller and then that payment price is transferred automatically to the seller's bank account linked; or such a card can be used over the Internet with appropriate scanner or reader. Such transactions with the IC card type of e-money resemble credit card transactions but the credit card transactions involve interventions of the credit card issuer in the payment process by making a beforehand payment of the price and waiting for the purchaser to pay back the corresponding amount, whereas certain-money IC card transactions skip such intervention stage resulting in an immediate transfer of fund which is of big difference. Recharging fund to the e-money IC card may be done repeatedly at ATMs equipped with the recharge machine, telephone handsets, bank tellers, PC (personal computer) and others. Such IC card-type e-money is useless in electronic commerce unless it is compatible with its networked counterpart. Any action with or related to use of an IC card may be the event that triggers a funding of a pension account; including, but not limited to, initially signing up for an IC card account.

In certain aspects, network type e-money is electronic money used in a computer network including PC communications and the Internet, and it is often used in the e-commerce. Users of the networked e-money go through a computer network to withdraw funds from their banks and pay the purchase price of goods in the form of computer files. The networked e-money can work on the network with an initial installation of a networked e-money program followed by purchasing desired amount of e-money and then purchasing of a product through e-commerce which is completed with payment of the purchase price. Any action with or related to use of a network money may be the event that triggers a funding of a pension account; including, but not limited to, initially signing up for a network money account.

In certain aspects of systems according to the present invention that effect funding of an account, digital technology and communication technology which diversify the capabilities of mobile communication terminals are mobile communication terminal based digital wallet or e-wallet services utilizing an IC card installed in the terminal which then functions as a method of payment. Any action with or related to use of such a wallet may be the event that triggers a funding of an account; including, but not limited to, initially signing up for an e-wallet account.

The terminal based eWallet service involves having credentials for payment prestored in the eWallet of the terminal and clearing a wireless internet eCommerce transaction or off-line payment of purchase price simply by using the stored e-wallet credentials. Such use alone and/or the amount of a transaction can be the basis for account funding according to the present invention, for funding an account. Such services may employ a wireless public key infrastructure (WPKI) solution installed as well as multilevel security measures for accessing exclusively by the identified user without fear of information leaks.

A funding according to the present invention based on or due to such “network” activity, use of e-money, or wallet use can be funding of an amount of money (or value) automatically transferred to the account based on use of the network action, use of e-money, and/or use of the wallet in a transaction, to include one, some or all of the following (so long as they are not contradictory in use):
purchase (includes rental and lease) of an item or service using a network, e-money, or an electronic wallet
activation of an e-wallet, or e-money, and/or accessing a network site
the purchase price of an item or service
a total number of transactions, events, network activations or wallet activations, transactions, and/or purchases
initially signing up for specific network access, e-money account and/or creating/signing up for an electronic wallet service
discretionary funding by another entity

For any funding method according to the present invention, whether it is a recharge method or any method described herein according to the present invention, upon an event (including transaction) occurring that effects a funding of an account of a subscriber or account owner, the funding may be from an account of the subscriber or owner himself or herself, so that every time an event occurs, the person is automatically funding his or her own account. Such funding can be at any set amount and can be based on the occurrence of one event or on the occurrence of a plurality of events, and/or on an event at a certain monetary level, on a plurality of events at a certain monetary level, and/or on a total monetary amount which is the sum of the monetary amounts for a plurality of events.

In certain aspects, the present invention provides computer-implemented methods for a funding an account including: using one or more computer servers to execute software instructions stored on a computer-readable medium, the software instruction causing the one or more computer servers to execute at least: the steps of any method for an account according to the present invention. In certain aspects, the present invention provides a system for effecting any method according to the present invention for funding an account including: a computer processor; a computer readable medium comprising instructions executable by said computer processor for effecting the steps of any method according to the present invention executable by a computer. In any such system and method, a pension account may be a tax-deferred account that is one of a 401(k), 403(b), 457, and 409A account.

The basic raison d'etre of most business entities is to make money and, hopefully, to make a profit. Diametrically opposed to this motive is the giving away of money simply out of human charity or goodness. Presented with the choices of paying a dividend to shareholders or giving the dividend money to the needy, most entities will ignore the needy. For such reasons a “Share The Wealth” funding of a person's account according to the present invention is a nonobvious improvement to current funding methods—the dominant business motive teaches away from giving money away free for no reason. This is why the “Share The Wealth” funding of a person's account according to the present invention will capture the hearts and minds of the public and this is one reason why funded accounts according to the present invention will be successful.

With incredulity, bank customers, for example, or credit card account holders will say “I can't believe it is true . . . they actually gave me money!” Such real generosity will engender customer loyalty. Such “generosity” can be practiced by any entity that can fund an account according to the present invention.

Accordingly, the present invention includes features and advantages believed to enable it to advance, inter alia, selection of an eWallet and/or eMoney for a transaction, account funding technology, pension plan and retirement account technology, and insurance sales.

Characteristics and advantages of the present invention described above and additional features and benefits will be readily apparent to those skilled in the art upon consideration of the following detailed description of preferred embodiments and referring to the accompanying drawings. What follows are some of, but not all, the objects of this invention. In addition to the specific objects stated below for at least certain preferred embodiments of the invention, there are other objects and purposes which will be readily apparent to one of skill in this art who has the benefit of this invention's teachings and disclosures.

It is an object of certain embodiments of this invention to provide: New, useful unique, efficient, nonobvious systems and methods for making a choice of a particular entity (eWallet and/or virtual currency) desirable to a consumer.

It is, therefore, an object of at least certain embodiments of the present invention to provide: New, useful unique, efficient, nonobvious systems and methods for funding an account, in one aspect, a pension account or an insurance account; with provision for funding by an account owner or designee and/or funding by an entity or person other than the account owner or designee.

It is, therefore, an object of at least certain embodiments of the present invention to provide such systems and methods which also provide for Share-The-Wealth discretionary funding of an account; for funding related to use of a cellphone, credit card, or electronic wallet; and for funding an account, e.g., a pension account or an insurance account or a college fund account, at an event like a game, race, funeral, party, or wedding. In certain aspects, this is accomplished via a downloadable computer “app” which is made available to all at an event, either before the event commences or at the site of the event.

To one of skill in this art who has the benefits of this invention's teachings, other purposes will be appreciated from the descriptions herein. The detail in these descriptions is not intended to thwart this patent's object to claim this invention no matter how others may later disguise it by variations in form, changes, or additions of further improvements.

It will be understood that the various embodiments of the present invention may include one, some, or any possible combination of the disclosed, described, and/or enumerated features, aspects, and/or improvements and/or technical advantages and/or elements in claims to this invention.

Certain embodiments of the invention are described in detail below. Various aspects and features of embodiments of the invention are described below. Any combination of aspects and/or features described below can be used except where such aspects and/or features are mutually exclusive or contradictory. It should be understood that the appended description herein are of certain embodiments is not intended to limit the invention. On the contrary, the intention is to cover all modifications, equivalents and alternatives falling within the spirit and scope of the invention as defined by the appended claims.

As used herein the various portions (and headings), the terms “invention”, “present invention” and variations thereof mean one or more embodiments, and are not intended to mean the claimed invention of any particular embodiment. So long as they are not mutually exclusive or contradictory any aspect or combination of aspects or features of any embodiment disclosed herein may be used in any other embodiment disclosed herein. The present invention includes a variety of aspects, which may be combined in different ways. Further, this description should further be understood to support and encompass descriptions and claims of all the various embodiments, systems, techniques, methods, devices, and applications with any number of the disclosed elements, with each element alone, and also with any and all various possible permutations and combinations of all elements in this or any subsequent application. It will be understood by one of ordinary skill in the art that the embodiments may be practiced without these specific details. Individual embodiments may be described as a process which is described in terms of steps of a process.

Embodiments of the invention may be implemented, at least in part, either manually or automatically. Manual or automatic implementations may be executed, or at least assisted, through the use of machines, hardware, software, firmware, middleware, microcode, computers, hardware description languages, or any combination thereof.

When implemented in software, firmware, middleware or microcode, the program code or code segments to perform the necessary tasks may be stored in a machine readable medium. A processor(s) may perform the necessary tasks, e.g., but not limited to, computers, PLC's, laptops, cellphones, smartphones, netbooks, desktops, smartphones, and tablet computers; including, but not limited to, any task or function of any control system, control system component, or detector described below.

### BRIEF DESCRIPTION OF THE DRAWINGS

FIG. 1 is a block diagram depicting an operating environment of, inter alia, a system with a computer application according to the present invention and an optional digital wallet, in accordance with certain exemplary embodiments.

FIG. 2 is a block diagram depicting a general component architecture of a computer system with one or more computer applications according to the present invention, in accordance with certain exemplary embodiments.

FIG. 3 is a schematic view of a personal device displaying a plurality of touch icons for choosing options according to a method of the present invention.

FIG. 3A is a schematic view of a personal device displaying a plurality of touch icons for choosing options according to a method of the present invention.

FIG. 4 is a schematic view of a system according to a method of the present invention.

FIG. 5 is a schematic view of a system according to a method of the present invention.

FIG. 6 is a schematic view of a system according to a method of the present invention.

FIG. 7 is a schematic view of a system according to a method of the present invention.

FIG. 8 is a schematic view of a system according to a method of the present invention.

FIG. 9 is a block diagram illustrating an example process adapted according to one embodiment of the present invention.

FIG. 10 a signal diagram illustrating an example process in which a customer at a merchant pays for goods using a non-traditional funding source according to one embodiment of the present invention.

FIG. 11 illustrates an example interface, adapted to an online transaction embodiment.

FIG. 12 illustrates an example interface, adapted according to an online transaction embodiment of the present invention.

FIG. 13 is an illustration of example relationship among various components of a system according to the present invention, e.g. as in FIG. 10.

FIG. 14 is a simplified block diagram of an example payment service provider according to one embodiment of the present invention

FIG. 15 is a block diagram of an example computer system suitable for implementing various methods and devices described herein.

FIG. 16A is a system diagram depicting an exemplary mobile device, including a variety of optional hardware and software components.

FIG. 16B is a generalized example of a suitable environment in which described embodiments, techniques, and technologies can be implemented.

FIG. 17 is a is a flow chart of an exemplary method, according to the present invention.

Any combination of one or some aspects and/or of one or some features described above, below, in independent claims, or in dependent claims can be used except where such aspects and/or features are mutually exclusive. It should be understood that the appended drawings and description herein are of certain embodiments and are not intended to limit the invention or the appended claims.

On the contrary, the intention is to cover all modifications, equivalents and alternatives falling within the spirit and scope of the invention as defined by the appended claims. In showing and describing these embodiments, like or identical reference numerals are used to identify common or similar elements.

The figures are not necessarily to scale and certain features and certain views of the figures may be shown exaggerated in scale or in schematic in the interest of clarity and conciseness. As used herein and throughout all the various portions (and headings) of this patent, the terms “invention”, “present invention” and variations thereof mean one or more embodiments, and are not intended to mean the claimed invention of any particular appended claim(s) or all of the appended claims.

Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein. The drawing figures present the embodiments preferred at the time of filing for this patent.

Certain embodiments of the invention are shown in the above-identified figures and described in detail below. Various aspects and features of embodiments of the invention are described below.

Any combination of aspects and/or features described below can be used except where such aspects and/or features are mutually exclusive.

It should be understood that the appended drawings and description herein are of certain embodiments and are not intended to limit the invention.

On the contrary, the intention is to cover all modifications, equivalents and alternatives falling within the spirit and scope of the invention as defined by the appended claims.

In showing and describing these embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiments, and are not intended to mean the claimed invention of any particular embodiment.

Accordingly, the subject or topic of each such reference is not automatically or necessarily part of, or required by, any particular embodiment.

So long as they are not mutually exclusive or contradictory any aspect or feature or combination of aspects or features of any embodiment disclosed herein may be used in any other embodiment disclosed herein. The present invention includes a variety of aspects, which may be combined in different ways.

The following descriptions are provided to list elements and describe some of the embodiments of the present invention, including those preferred at the time of filing for this patent.

These elements are listed with initial embodiments, however it should be understood that they may be combined in any manner and in any number to create additional embodiments. The variously described examples and preferred embodiments should not be construed to limit the present invention to only the explicitly described systems, techniques, methods and applications.

Further, this description should further be understood to support and encompass descriptions and claims of all the various embodiments, systems, techniques, methods, devices, and applications with any number of the disclosed elements, with each element alone, and also with any and all various possible permutations and combinations of all elements in this or any subsequent application.

The ensuing description provides exemplary embodiments only, and is not intended to limit the scope, applicability or configuration of the disclosure.

Rather, the ensuing description of the exemplary embodiments will provide those skilled in the art with an enabling description for implementing one or more exemplary embodiments.

Various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details.

For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged.

A process may be terminated when its operations are completed, but could have additional steps not discussed or included in a figure. Furthermore, not all operations in any particularly described process may occur in all embodiments.

A process may correspond to a method, a function, a procedure, a subroutine, a subprogram, etc. When a process corresponds to a function, its termination corresponds to a return of the function to the calling function or the main function.

Embodiments of the invention may be implemented, at least in part, either manually or automatically. Manual or automatic implementations may be executed, or at least assisted, through the use of machines, hardware, software, firmware, middleware, microcode, hardware description languages, or any combination thereof.

When implemented in software, firmware, middleware or microcode, the program code or code segments to perform the necessary tasks may be stored in a machine readable medium. A processor(s) may perform the necessary tasks.

### DETAILED DESCRIPTION OF THE INVENTION

The present invention, in certain aspects, provides a method and system for funding a retirement account. In certain aspects the retirement account is a portable retirement investment. In certain aspects, such a method and system provide improvements to the subject matter of U.S. Pat. No. 7,398,241 (incorporated fully herein for all purposes) and this patent does not disclose, teach of suggest the improved methods and systems, nor are the improved systems and methods obvious in view of this patent or this patent in combination with any other patent, application, applications, or patents.

In certain aspects, the present invention provides a method and a system in which a retirement account of a person is funded during an accumulation period. “Funding” means and includes the funding done by the person whose account it is and/or by another person or entity, such funding including any funding technique or method herein according to the present invention based on any funding action, event, or transaction disclosed herein.

In certain aspects, the present invention provides a system and method for providing a user with one or with a plurality of periodic retirement income payments, the methods including Funding of an account according to the present invention and, in certain aspects, optionally the steps of receiving an input including a retirement date and/or the step of calculating the retirement date, and the length of an accumulation period defined by the retirement date and a current age of the user; receiving a Funding payment amount from the user and/or from another person or entity during the accumulation period; optionally investing the received Funding payment amount in any suitable manner, including but not limited to, in the account in a manner consistent with one or more predefined objectives during the accumulation period resulting in a retirement income amount. The process can further include the step of transmitting the retirement income amount to at least one of the user and a designated beneficiary (or beneficiaries) or a receiver at a designated time after the end of the accumulation period. Optionally, the account accumulates a non-monetary amount of value indicators (points, shares, etc.) which are translated into money and/or things and/or services when the designated time is reached.

The present invention, in certain aspects, provides a method and system for funding a pension account. In certain aspects the account is a pension account for which monetary funding contributions are managed for deferred retirement savings. In certain aspects, such a method and system provide improvements to the subject matter of U.S. Patent Application Pub. No 20060229964 (incorporated fully herein for all purposes) and this patent does not disclose, teach of suggest the improved methods and systems, nor are the improved systems and methods obvious in view of this patent application or in view of this patent application in combination with any other patent, application, applications, or patents.

In certain aspects, the present invention provides a system and method of managing funding amounts (money and/or value), e.g., monetary contributions for a pension account that has a deferred payment system for retirement; and, optionally, wherein a consumer (and/or another person or entity) funds the account by making contributions into the account, and/or wherein the process is not tied to any particular entity, employer, and/or employment status.

In certain aspects, and as may be true for any method according to the present invention, funding amounts for a pension account according to the present invention are professionally managed and, in one aspect, can be held in a trust, similar to the way funds are held in a traditional defined benefit pension plan. In one particular aspect, a personal pension account of a system according to the present invention is offered by a person's employer offers some or all funding.

The present invention, in certain aspects, provides a method and system for funding a pension account. In certain aspects the account is a pension account which can be administered and assisted by appropriate computerized methods employing appropriate computer systems and software. In certain aspects, such a method and system provide improvements (e.g., account funding according to the present invention) to the subject matter of U.S. Pat. No. 6,064,986 (incorporated fully herein for all purposes) and this patent does not disclose, teach of suggest the improved methods and systems, nor are the improved systems and methods obvious in view of this patent application or in view of this patent application in combination with any other patent, application, applications, or patents. In certain aspects, creation of the pension account and its use are facilitated by a computer assisted and/or implemented process and architecture for pension account creation, maintenance and administration for a retirement program.

In certain aspects such a system includes a computer program product used in a computer to assist in pension account creation and administration for the benefit of a pension account owner and/or of a beneficiary.

The present invention, in certain aspects, provides a method and system for funding an account, e.g. a pension account. In certain aspects the account is a pension account which can be administered and assisted by appropriate computerized methods employing appropriate computer systems and software. In certain aspects, such a method and system provide improvements (e.g., account funding according to the present invention) to the subject matter of U.S. Patent Application Publication No. 20120123841 (incorporated fully herein for all purposes), which patent application does not disclose, teach of suggest the improved methods and systems, nor are the improved systems and methods obvious in view of this patent application or in view of this patent application in combination with any other patent, application, applications, or patents. In certain aspects, creation of the pension account and its use are facilitated by a computer assisted and/or implemented process and architecture for pension account creation, maintenance and administration for a retirement program.

The present invention provides a method for performing funding of a pension account, the funding dependent on completion of a payment transaction by a user using a user device, the method comprising: receiving electronically by a processor of a payment provider an indication of a desire by a user to purchase an item; accessing, by the processor, an account of the user with the payment provider; determining, by the processor a determined amount of funding of a pension account due the user upon completion of the transaction; processing the payment; and funding the pension account in the amount of the determined amount.

Any method for performing a payment transaction using a user device of U.S. Patent Application Publication No. 20120123841 is within the scope of the present invention which includes and is improved by adding a funding step (any suitable according to the present invention) and/or a funding method (any suitable according to the present invention) for funding a pension account (either of the user or of another person) with a determined funding amount, the method, optionally, further comprising: receiving, electronically by a processor of a payment provider, an indication of a desire by a user to purchase an item; accessing, by the processor, an account of the user with the payment provider; determining, by the processor, a funding amount for funding the pension account based on completion or the purchase; processing the payment using one funding instrument or using one or more funding instruments of a plurality of funding instruments; and funding the pension account with the determined funding amount.

A method of any of the three preceding paragraphs above (or any suitable method according to the present invention) may include one, some, or any possible combination of the following: wherein the plurality of funding instruments comprises one or more of credit cards, debit cards, gift cards, and coupons; wherein the user device is one of mobile device, electronic device, electronic wallet, computer, digital wallet, mobile wallet, cellphone, tablet computer, netbook computer, laptop computer, and desktop computer.

In certain aspects, the present invention provides a non-transitory machine-readable medium for facilitating effecting of any method according to the present invention as disclosed herein, the method including a plurality of machine-readable instructions which when executed by one or more processors of a server are adapted to cause the server to perform said method.

In certain particular aspects, mobile devices are used in methods according to the present invention to make payments through payment providers, such as, but not limited to, PayPal, Inc. of San Jose, Calif., Google, and Amazon.com. Funding of an associated account according to the present invention is based on payments made (and, in other aspects, is based at least in part, simply on contacting the payment provider). Such payment providers, employed in methods according to the present invention can allow a consumer to make a payment through the user's mobile device, such as through the use of barcodes, communication between the payment provider and a merchant, and other methods. In certain aspects, after authentication and/or authorization, the payment is made through a user account with the payment provider, where the account is funded through a funding source, such as the user's bank or credit card. The funding source can be a single default source selected by the user. The account which is funded in such methods can be an account of the user, a user beneficiary, or of another person.

In certain methods, a payment provider may also provide payment directly from a funding source to the merchant so that the recipient need not have an account with the payment provider. This may also apply when the user does not have a payment provider account.

In certain aspects, in a method according to the present invention in which an account is funded (any suitable method according to the present invention), the method is a method in which a payment provider processes a payment from a user's smart wallet and the payment provider receives an indication that the user is ready to make a payment for items or services. Items or services, as used herein, may include physical goods, digital goods, services, donations, and anything that the user is making a payment for, to, or regarding. In one embodiment, the user is at a physical location or point of sale (POS) for the payment, such as at a store. In other embodiments, the user may be shopping online and making the payment through a merchant device, mobile device, computer or cellphone.

The indication may be received in any number of ways. One example is the user accessing a payment app on a user mobile device at the POS, which makes a call to the payment provider through the mobile device. The user may enter credentials to access the user's account and enable payment through the mobile device. Another example is the merchant communicating a purchase transaction to the payment provider at the POS through a merchant device. These can be when the user begins a checkout process, during a checkout process, or after all items have been scanned and totaled. In one embodiment, the minimum information communicated is a desire for the user to make a payment and user identity/account information. The latter allows the payment provider to access the user's account and data associated with the account and to determine that an associate pension account exists and its identity.

Determination of a funding amount for such an account (and for any account herein) may be based, in whole or in part on the use of a particular payment provider, on the fact of accessing the payment provider, seller or merchant identity, product manufacturer or service provider identity, on using a particular payment source (e.g., bank or credit card issuer), and/or on the number or money amount of purchase(s).

A mobile device or electronic wallet may be used in methods according to the present invention with an NFC-enabled device or an NFC chip.

In certain aspects, a wallet used in a method according to the present invention is an application residing on a mobile device and linked to the payment provider wallet in the cloud. Some components of the wallet (e.g., user interfacing) can be normal applications such as Java applet, widget or native type. In one embodiment, in a method according to the present invention, an electronic wallet, e.g., a smart wallet or account, remains in the cloud at all times.

The following provides one example of a smart wallet use case. A XYZ store customer has an ABC XYZ-branded card. He also goes on a regular basis to a XYZ store located near his home. By monitoring the payment history of this user in that store/merchant, the payment provider will know that the user pays 90% of the time with this card and that the 10% remaining are payments made with a QRS debit card. Both instruments are registered with the user's payment provider account.

Determination of a funding amount for funding of an account associated with the user can be based on: the identity of the payment provider, the activation of the provider's smart wallet, the store identity, the card issuer and/or the debit card issuer.

Signals used in the method may be store “wireless” signals sent to the mobile device of the user and “read” by a smart wallet (e.g., through an NFC tag, Bluetooth (existing pairing), WiFi, or other). In one particular aspect the communication is an NFC communication through a POS device. By doing triangulation of data, the smart wallet may be able to enhance the choice of payment instruments.

In one aspect, when a user arrives at a cash register, he connects to the payment provider, such as through an NFC channel, a remote/online session, etc. Transaction information, such as amount, store, merchant, type of purchase, etc., is communicated to the payment provider, as well as the location of the user and/or POS and any other information needed by the payment provider. The payment provider accesses the user's account and preferences and decides which funding instrument or combination of funding instruments to use automatically. The transaction is completed and a fund funding amount is determined and the account is funded in that amount.

In certain aspects a networked system is used in a method according to the present invention and the networked system is configured to handle a transaction using an electronic wallet, e.g., a digital wallet or a smart wallet in accordance with an embodiment of the invention. Such a networked system can include a user device, a merchant server, and a payment provider server in communication over a network. The payment provider server may be maintained by a payment provider, such as PayPal, Inc. of San Jose, Calif. or Google Wallet. A user, such as a sender or consumer, utilizes the user device to perform a transaction using the payment provider server. “Transaction,” as used herein, refers to any suitable action.

The user device, the merchant server, and the payment provider server may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of the system, and/or accessible over the network.

The network may be implemented as a single network or a combination of multiple networks. For example, in various embodiments, the network may include the Internet or one or more intranets, landline networks, wireless networks, and/or other appropriate types of networks.

The user device may be implemented using any appropriate hardware and software configured for wired and/or wireless communication over the network. For example, in one embodiment, the user device may be implemented as a personal computer (PC), a smart phone, personal digital assistant (PDA), laptop computer, and/or other types of computing devices capable of transmitting and/or receiving data, such as an iPad.

The user device may include one or more browser applications which may be used, for example, to provide a convenient interface to permit the user to browse information available over the network. For example, in one embodiment, a browser application may be implemented as a web browser configured to view information available over the Internet, including accessing a loyalty site.

The user device may further include other applications as may be desired in particular embodiments to provide desired features to the user device. For example, and not by way of limitation, an application may be included that presents a total balance in an associated pension account and/or a listing of funding amounts, sources, and dates.

The merchant server may be maintained, for example, by a merchant or seller offering various products and/or services in exchange for payment to be received over the network. The merchant server may be used for POS or online purchases and transactions. Generally, merchant server may be maintained by anyone or any entity that receives money, which includes charities as well as retailers and restaurants. In one aspect, the merchant server includes a database identifying available products and/or services (e.g., collectively referred to as items) which may be made available for viewing and purchase by the user, optionally, with an associated amount of pension account funding for purchasing the product or service.

In certain aspects, the payment provider server may be maintained, for example, by an online payment service provider which may provide payment between the user and the operator of the merchant server.

In certain aspects, a transaction processing application, which may be part of a payment application or separate, may be configured to receive information from a user device and/or merchant server for processing and storage in a payment database. Transaction processing application may include one or more applications to process information from a user for processing an order and payment using various selected funding instruments as described herein. A transaction processing application may store details of an order associated with a phrase from individual users and/or may calculate and/or make a deposit of a funding amount to a pension account.

In certain aspects a computer system suitable for implementing one or more embodiments of the present invention may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system, e.g., as described below.

Components of such a computer system can also include a system memory component (e.g., RAM), a static storage component (e.g., ROM), and/or a disk drive. The computer system can perform specific operations by a processor and other components by executing one or more sequences of instructions contained in a system memory component. Logic may be encoded in a computer readable medium, which may refer to any medium that participates in providing instructions to the processor for execution. Such a medium may take many forms, including but not limited to, non-volatile media, volatile media, and transmission media. In various implementations, non-volatile media includes optical or magnetic disks, volatile media includes dynamic memory, such as a system memory component, and transmission media includes coaxial cables, copper wire, and fiber optics, including wires that comprise a bus. In one embodiment, the logic is encoded in non-transitory computer readable medium. In one example, transmission media may take the form of acoustic or light waves, such as those generated during radio wave, optical, and infrared data communications. Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In certain embodiments of the present disclosure, execution of instruction sequences to practice the present disclosure may be performed by a computer system. In various other embodiments of the present disclosure, a plurality of computer systems coupled by communication link to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa. Any software herein may be a computer application or “app.” This can be an app downloadable to a cellphone, computer, or smartphone.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The present invention provides an account funding service system, funding server, and funding method for funding an account; and, in one aspect, the account funding service system includes: recipient terminal for receiving and storing e-money in the account; payer terminal for payment of e-money to fund the account; and the recipient terminal or the payer terminal or both for receiving input of money information including information on the whole or part of identification of the recipient terminal, identification of the payer terminal, funding amount, and methods of payment from an entity other than a pension owner, and for a person, e.g., the account designee or owner, transmitting message of inquiry to either terminal of funding event and/or funding amount.

In certain aspects, such a method and system provide improvements (e.g., account funding according to the present invention) to the subject matter of U.S. Patent Application Publication No. 20120036067 (incorporated fully herein for all purposes), which patent application does not disclose, teach of suggest the improved methods and systems, nor are the improved systems and methods obvious in view of this patent application or in view of this patent application in combination with any other patent, application, applications, or patents.

The present invention provides, in certain aspects, funding of an account when an electronic payment system account is recharged, the amount of funding of the account dependent on the fact of recharging an account and/or on the amount of the recharge. In certain aspects, account funding occurs with the use of an electronic money recharge service system comprising: a recipient terminal for receiving and storing an electronic money; a payer terminal for performing a settlement approval procedure for payment of the electronic money loaded into the recipient terminal; and a money recharge server for receiving an input of money information including information on the whole or part of an identification of the recipient terminal, an identification of the payer terminal, a recharge amount, and a method of payment, from a subscriber to the electronic money recharge service, wherein the money recharging server recharges the recipient terminal with the electronic money corresponding to the recharge amount and makes a payment for settling the recharge amount of money through the method of payment for the subscriber acting as a money payer, and transmits a message of inquiry to the payer terminal of a settlement approval of the recharge amount and recharges the recipient terminal with the electronic money corresponding to the recharge amount if the settlement approval is issued by the payer terminal for the subscriber acting as a money recipient. Such a method may be a method for replenishing a mobile communication account.

Another aspect of the present disclosure provides an electronic money recharge method including: receiving an input of money information from a subscriber to a money recharge service, the money information including information on a subscriber terminal, a payer terminal of a money payer, and a recharge amount; transmitting a message of inquiry to the payer terminal of a settlement approval of the recharge amount and information on a method of payment; if a settlement approval signal is received from the payer terminal in response to the message, funding an account of the subscriber and recharging the subscriber terminal with electronic money up to the recharge amount; and processing an invoice for the electronic money recharged into the subscriber terminal by using the method of payment.

In any system for effecting an account funding according to the present invention, although the components of the aspects of the present disclosure may have been explained as assembled or operatively connected as a unit, the present disclosure is not intended to limit itself to such aspects. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such program may be easily deduced by a person skilled in the art. The computer program may be stored in computer readable media, which in operation can realize the aspects of the present disclosure. The computer readable media may include magnetic recording media, optical recording media, and carrier wave media.

The present invention provides systems and methods that include funding of an account of a person who owns the account and/or who will have access to account assets and/or ownership of the account at a future date which is part of a system and method for providing and/or facilitating complete on-line payment services while protecting the privacy of the transaction participants. In certain aspects, such a comprehensive payment service is based upon a consolidated account used to store value acquired through on-line transactions and the funding of the pension account is effected or triggered in any way described herein according to the present invention. In certain aspects the invention provides private payment numbers for protecting the identities of the participants and includes processes for authenticating participants, authorizing transactions, settling payments, initiating and authorizing pension account funding, and effecting the pension account funding. In certain aspects, such a method and system provide improvements (e.g., an account funding according to the present invention) to the subject matter of U.S. Pat. No. 7,783,566 (incorporated fully herein for all purposes), which patent does not disclose, teach of suggest the improved methods and systems, nor are the improved systems and methods obvious in view of this patent or in view of this patent in combination with any other patent, application, applications, or patents. Using any system and any method disclosed in U.S. Pat. No. 7,783,566 funding of an account is initiated, authorized, and effected by any type of pension account funding described herein according to the present invention.

The present invention provides a method for funding an account of a user, via a computer-based system for providing an on-line transaction, a consolidated account substantially simultaneously from a plurality of different funding sources, wherein at least one of an acquisition order is determined according to a user-defined funding profile and a proportion of the value from each of the plurality of different funding sources is determined according to a user-defined funding profile, and wherein the consolidated account stores a value funded from the plurality of different funding sources; setting, by the computer-based system, a predetermined usage restriction in a database, wherein the predetermined usage restriction is associated with at least one of the plurality of different funding sources; performing, by the computer-based system and after the funding, a predetermined enforcement policy on at least part of the funds in the consolidated account, wherein the predetermined enforcement policy is based at least in part on the setting; and paying, by the computer-based system, a payee with at least part of the funded value; and the present invention also provides a system for this which includes an account administrator in communication with a transaction administrator and one or more value sources and an account, the transaction administrator configured to perform the steps of: funding the account and a consolidated account.

In certain aspects, in one embodiment of the present invention, persons attending an event (e.g., a game, a concert, a race, a wedding, a funeral, a competition, a graduation, a baptism, a confirmation, a bar mitzvah, a bat mitzbah, a track meet, a competition, a reunion, a convention, a fund raiser, an auction; the birth of a child or grandchild, neice or nephew; birthday party, anniversary party,) have, via their cellphones, smartphones, and/or personal computers (e.g., laptops, netbooks, tablets), access to effect funding of an account of a particular person or persons (or multiple accounts of multiple persons or charities) during the event. The money for funding can come for any selected account of the person or entity that is doing the funding (e.g., but not limited to, from a checking account, from a savings account, charged to a credit card account, and from a debit account). The funded account can be a pension account.

In one aspect, on the cellphone or computer and/or on publicly viewable screen(s) at the event, a total amount of funding of the account in real time is made available to all at the event. A person (which can be an individual human person or a legal person such as a company or corporation) provides a funding amount to the account by using the cellphone or personal computer. In one particular aspect, once the person has downloaded an application (“app”) at the event (or before the event) simply pressing one button (or key) or a series of buttons (or keys) identifies the person and connects the person to the funding system with respect to the specific account to be funded; the system identifies the person (or entity) and then the person selects the amount of funding desired and, upon indicating “FINISH” or “COMPLETE” or “FUND” or some similar command, the system effects funding of the pension account in the desired amount.

Of course, as is true with all other embodiments herein that refer to a “pension account,” it is within the scope of the present invention for the account to be any account of any type of any person or entity (e.g., but not limited to, a company, a partnership, a campaign, a charity, a corporation), including, but not limited to a bank account, checking account, savings account, debit card account, utilities account, credit card account, health savings account, insurance account, college fund account, charity account, a make-a-wish account, retirement account, education funding, a honeymoon account, a home purchase account, account, pay-off-student-loan account, new car account).

Any method herein according to the present invention can be effected and/or facilitated by a computer application, or “app,” that effects some, most, or all of the steps of the method and/or provides the necessary connections and/or communication between a person (or entity) and other components and apparatuses and devices used in a system that effects account funding. Such an “app” in certain aspects facilitates the funding and identifies the person; accesses the appropriate systems, software and servers; provides communication between the person and the systems, software, and servers; receives and transmits the funding request; communicates with the funding source (e.g entity that provides and/or administrates a checking account, savings account, credit card account, electronic wallet); effects the transfer of the amount; and finalizes the funding of the account. Optionally the app provides confirmation to the person.

For example, a wedding is attended by 600 people and the bride has set up a pension account for her and a pension account for the groom. Before arrival and/or as guests arrive at the wedding reception, via their cellphones and/or personal computers, they download the BGPF App—the Bride Groom Pension Fund Application. Once installed, the person wishing to fund one of the accounts can then access the funding system, choose an account (the bride's or the groom's), choose a dollar amount, and enter a funding command. The desired amount of funding is transferred from the account selected by the person (or charged to the charge account selected by the person) to the selected pension account. Optionally, this funding transaction and the amount are instantaneously displayed on a screen or screens viewable by all at the reception—optionally with the identity of the person doing the funding displayed. Optionally, the bride and groom can have alerts from their cellphones or personal computers; e.g., each time an account is funded and/or when a certain funding level is achieved. Optionally, such alerts can also be provided via the publicly viewable screen(s). Optionally, other accounts may also be funded—e.g., honeymoon account, home furnishings account, insurance accounts (life, home, car, personal effects, travel insurance, boat), new car account, pay-off-student-loans account, etc.

Such wedding funding can also be made available at any time before or after the actual wedding ceremony with a computer app downloadable at any time before a wedding. In certain aspects, the availability of the downloadable app is included in the engagement announcement and/or with the wedding invitations. It can also be made available at any entity at which the bride registers for gifts (as is true for any event and for the funding of any account in any method herein according to the present invention). In addition to a wedding, the funding of the various types of accounts can be effected with respect to any other event or happening.

A wedding app according to the present invention can also include software for effecting:
display of photographs before, during, and/or after a ceremony
display of photos and/or biographies of each person involved in the wedding (including, but no limited to, all parents, groom, bride, bridesmaids, groomsmen, ring bearer, musicians, and clergy)
display of each commercial entity involved in the wedding with identity, location, link to website, and services (in one particular aspects with a coupon or discount for using them in the future)
display of a PHOTOCREATE sub-app that allows the computerized combination of bride, groom, parent, grandparent photos to see computer-generated views of what children of the bride and groom might look like
display of age forward pictures of what the bride and groom might look like in the future, e.g. after 10, 20, 30, 50 years of marriage
display with audio and/or video of favorite song(s), movies, vacation spots, etc. of anyone involved in the wedding, bride, groom, etc.
display of bios and/or photos of anyone involved in the wedding who is not yet married; and/or of anyone attending the wedding who is not yet married
a computerized “catch the bouquet” or “catch the garter” app in which anyone can sign in for a chance to catch a digital bouquet and/or digital garter, with or without a monetary charge for the chance
a computerized “dance with the bride” or “dance with the groom” app which schedules dances at the reception with the bride or groom; and, in one aspect, a contest for the first dance with the bride after the bride dances with her father or a first dance with the groom after he dances with someone; and, in one aspect, such a contest in which there is a chance selection of the person who gets to dance; and, in one particular aspect, with each person who wants a chance paying for entry into the pool of possible dancers
periodic alerts to each person who signs up and downloads the wedding app for RSVPs, and for “how many days left to wedding”

In one particular app, funding is provided for a life insurance policy account for the groom and for the bride. The policies can be for a year, multiple years, or for life; and they can be term or whole life, or a combination thereon. In one particular aspect, with a program prearranged with an insurance company, there is a floating amount of insurance and the final amount that applies to a spouse's life is an amount funded by individual funding amounts effected by attendees at the wedding (and/or by persons not present but who have access to the app). For example, an insurance company agrees to provide a term life policy for the first year of marriage for the groom with the bride as beneficiary and the amount of insurance depends on how much funding is provided; for example, the prospective policy is for $250,000 of term insurance for one year if $400 total is provided in funding, $500,000 for $800 of funding, and $1,000,000 if $1600 in funding is provided.

Such an insurance app may be provided in relation to any event, e.g. any life milestone (birth, reaching teenage, confirmation, bar mitzvah, high school graduation, college graduation, funeral, etc.), or such a program, app, and system can be set up for no reason other than generosity or as a gift to anyone at any time. For example, an insurance company obtains information regarding a potential insured and then an app is made available to those who are interested in funding an insurance policy for that person. A time period for funding is determined and the policy funding period commences. Anyone can provide a funding amount (in any way disclosed herein using any method and any system disclosed herein). Running totals and running total funding can be provided during the funding period. Optionally, the insurance company and/or any other entity can provide a funding amount and/or match a funding amount during the funding period or at the end of the funding period. Once the funding period expires, the total funding is announced, the amount of the insurance policy is announced, the policy is finalized and goes into effect, and the policy details and/or hard copy of the policy are provided to the insured. This can be done with or without previous knowledge of the insured and the policy may be of any selected type, e.g., term, whole life, etc. In one aspect, this is done for multiple people simultaneously; and in one particular aspect, an incentive amount of funding is provided by the insurance company that depends on the number of persons involved to be insured and/or on the amounts of funding reached during the funding period. The policy or policies may be for a year, for multiple years, or for life of an insured. Optionally, a potential insured is notified before funding commences and the potential insured chooses a beneficiary or beneficiaries. In one aspect, the potential insured publicizes the identity of the beneficiary or beneficiaries.

In certain aspects, a person (or entity) effects automatic periodic funding of an account by authorizing periodic payments. The period and the amount can be set by the persons (or by the entity) and the payments can be associated with an event or not. In certain aspects a particular account is accorded a code (e.g., a barcode, a symbol code, bocode, bokode, or QR code) that can be accessed by any suitable reader, camera, or scanner so that the account can be identified and/or accessed by the person in whose name the account is or by a person or entity wishing to fund the account. The code can be reproducible and/or password protected.

In one aspect, everyone attending an event can be, possibly, the person (or persons) whose account is funded and the person can be chosen at random by any suitable method (e.g., but not limited to, by seat number or ticket stub number). Optionally, prior to or during funding, a person can pay a fee to be in the pool of person whose pension account will be funded.

In another embodiment, 85,000 people attend a NASCAR race. As each person with a cellphone or personal computer enters the race location (or before) they can download an app which enters them in a pool from which will be selected one person (or multiple persons) whose account can be funded during the race. Details about the person are made publicly available once the person is chosen, e.g. via publicly viewable screens and/or sound systems and/or via cellphones and/or personal computers. As the race unfolds, anyone who has downloaded the appropriate app can fund the chosen person's account. Running totals of the funding level are made public. Optionally, before funding ceases, the total amount to that time is displayed and a countdown indicator is displayed to let the people know that at a predetermined time the ability to fund the account will cease. Such funding opportunities may also be made to persons not present at the actual race site so that anyone can fund the account during the race. There may also be an option so that a person not at the race site can have a personal account funded in his or her name, even though he or she is not present at the race (and, of course, these options apply to any other event).

In one scenario for funding related to an event in a method according to the present invention, the identity of the person whose account is being funded is kept secret either until the event is concluded or up to a certain time; for example, and not by way of limitation, at a soccer game when two-thirds of the time has elapsed; at a football game when the game is over; at a baseball game at the end of the fifth inning; at a race when a pre-set number of laps or miles has been completed; when the event is half sold out; when the event is sold out; when a pre-set percentage of the vent is soldout; at a basketball game when a certain total score is reached; at a concert before the last song or after the star or star group is first introduced; and only when a pre-set amount of funding is reached, e.g., at a charity fundraiser when $100,000 has been reached either for the charity or for the pension account of one of the donors or donees.

For charity fundraising, the account being funded can be an account of the charity rather than an account of one of the donors/guests.

Advertisers, celebrities, and sponsors can be part of a funding method according to the present invention in several ways. In one aspect, a company or celebrity can do an initial funding of an account, e.g., Coca-Cola Co.'s name flashes on a screen when the funding account status is first displayed, e.g., with an announcement such as “Coca-Cola proudly contributes the initial $10,000 to the pension account;” or “Gary Sinise starts this education funding account with $5,000;” or “Bank of American gets this effort off the ground with $1,000.” In other aspects, a company or celebrity can match any funding done at a certain level by an individual; for example, “Motorola has just matched the $1000 donated by John Jones'” or “Rush Limbaugh has contributed another $100,000 to match the $100,000 given by Sean Hannity;” or “Now Ann Coulter has funded the account to the tune of $200,000 matching both Rush and Sean.” Optionally, a company or entity can announce matching funding at any time during the funding method at an event. For example, after the halftime of a football game, the announcement is made that “Lowes will now match any funding done in the third quarter of the game” or “Angie Harmon will match any funding done when the Cowboy offense is on the field.”

In any funding method according to the present invention, funding may be added to or matched by a competitor or by a winner or by a loser. For example, the Dallas Cowboys beat the Green Bay Packers 67-3 and before the game the Cowboys have announced that, if they win, they will match any amount of funding of an account (or, e.g., a percentage, e.g., half). Alternatively, the Green Bay Packers agree to an additional $2,000,000 of funding if they lose by over 60 points. Funding may also be made dependent on an something occurring, such as, but not limited to, a home run, a touchdown, a 70 yard punt, a soccer goal, a triple play, a safety, lapping a competitor in a race, a hat trick, a seventy yard field goal, a double play, a no-hitter, a perfect game, win in sudden death, win of a championship, win of a race, etc.

The present invention provides systems and methods for funding an account (pension, insurance, college, or other account) when a card-present transaction is accomplished and finalized with a system that facilitates card-present type transactions with a merchant over a public network. In certain aspects of such methods and systems according to the present invention, a host system is configured to accept authentication data from a user via an authentication device. The host system, after authenticating a user is configured to retrieve the user's account information from a user database system, to identify a user's account number, and to translate a user account number into a temporary transaction number. The temporary transaction number is then transmitted directly from the host system to the merchant, thereby eliminating the need for the user to send to the merchant over the internet, the user's transaction account number; and upon completion of the transaction, the user's account is funded, either from an account of the user, from an account of the host system, and/or from an account of the merchant.

In certain aspects, such a method and system provide improvements (e.g., account funding according to the present invention; account funding according to the present invention) to the subject matter of U.S. Pat. No. 7,963,992 (incorporated fully herein for all purposes), which patent does not disclose, teach of suggest the improved methods and systems, nor are the improved systems and methods obvious in view of this patent or in view of this patent in combination with any other patent, application, applications, or patents. Using any system and any method disclosed in U.S. Pat. No. 7,983,992 funding of an account (or other account) is initiated, authorized, and effected by any type of account funding described herein according to the present invention.

In certain aspects, an account is funded in relation to the passing away of a person and/or in the context of a funeral. So long as there is no contradiction with features of the various embodiments herein, funding of an account can be provided for someone (wife, husband, child, relative, friend) of a deceased. For example, and not by way of limitation, a college account can be funded for a child of parents who die in an accident. For example, and not by way of limitation, a life expenses account can be funded for a wife of a deceased husband. For example, and not by way of limitation, a LEGACY (trademark) account can be funded for a child of a deceased parent, the account monies to be given to the child upon the child reaching a certain age or commencing college or military service.

In a recent survey, the most despised entities were banks, airlines, and utilities. According to the present invention, the image of such entities and how they are viewed by the consuming public is enhanced by such an entity providing a pension account (or any type of account disclosed herein) to a customer. Optionally, when the customer initially opens an account with such an entity, a pension account (or other account) is also opened and the entity provides an initial funding amount. As time passes and the customer stays with the entity, additional funding amounts are made to the account. For example, a utility can fund a customer's pension account based on how many kilowatt hours of power the person uses. For example, a cellphone provider can fund a customer's insurance account based on how many minutes the person uses for calls. For example, an airline can create and fund a pension account based on a number of flights and/or a number of miles traveled. A television provision company can fund an account (e.g., insurance, college expenses, pension) for a child of a customer based on how long a person remains a customer and/or on how many hours of programs are watched.

Any funding according to the present invention may be done with both “card present” transactions and “online” or “digital” transactions. Unlike a typical “card-present” transaction where a consumer is present at a merchant's retail establishment and presents a physical charge card to the merchant, the merchant in an online or other remote transaction does not physically see the consumer nor the consumer's charge card.

In conducting an online purchase according to the present invention, funding of an account (pension or other account) is done in a method in which a consumer, optionally, browses the internet for items to purchase; identifies goods and/or services for purchase by viewing an online advertisement such as a hypertext markup language (HTML) document provided via a World Wide Web (WWW) browser; selects an item to add to a virtual shopping cart; proceeds to a virtual checkout, where the consumer is prompted for payment and delivery information; enters the appropriate delivery and transaction account information, wherein the transaction account number is typically obtained directly from the consumer's physical transaction card, which information includes identification of the consumer's pension account; information is then transmitted electronically to the merchant over a public network such as the Internet via a secure channel such as a secure sockets layer (SSL) connection; the merchant then processes the transaction account number by, for example, sending authorization from the card issuer, completing the transaction, automatically funding the account in a pre-set amount, and submitting a record of charge (ROC) and/or summary of charges (SOC) and/or summary of accounting funding to the person, and/or to the card issuer or acquirer for settlement. While the authorization process (authorization code provided to merchant) may occur contemporaneously with the transaction, the settlement process is generally accomplished by a batch process during periodic intervals. The funding can be by the person, by the card issuer, by a host system, by a sponsor or advertiser, and/or by the merchant

Any system and method according to the present invention and the online card-present transaction system of the present invention may be described herein in terms of functional components, flow pathways, screen shots, optional selections and various processing steps. It should be appreciated that such steps may be realized by any number of hardware and/or software components configured to perform the specified functions. For example, the present invention may employ various integrated circuit components, e.g., memory elements, processing elements, logic elements, look-up tables, and the like), which may carry out a variety of functions under the control of one or more microprocessors or other control devices. Similarly, the software elements of the present invention may be implemented with any programming or scripting language such as C, C++, Java, COBOL, assembler, PERL, XML, ActiveX, or the like, with the various algorithms being implemented with any combination of data structures, objects, processes, routines or other programming elements. Further, it should be noted that the present invention may employ any number of conventional techniques for data transmission, signaling, data processing, network control, and the like.

Although the terms “online” or “internet” are used herein to refer to a computerized network, one skilled in the art will appreciate that a network may include any system for exchanging data or transacting business, such as the Internet, an intranet, an extranet, WAN, LAN, satellite or wireless communications, and/or the like. The user may interact with the host system's transaction system or a merchant via any input device such as a telephone, keyboard, mouse, kiosk, personal digital assistant, touch screen, voice recognition device, transponder, biometrics device, handheld computer (e.g., Palm device, and/or the like). Similarly, the invention could be used in conjunction with any type of personal computer, network computer, workstation, minicomputer, mainframe, or the like, running any operating system. Moreover, although the invention uses protocols such as TCP/IP to facilitate network communications, it will be readily understood that the invention could also be implemented using IPX, Appletalk, IP-6, NetBIOS, OSI or any number of existing or future protocols or platform services, such as SOAP, WDSL, UDDI, and/or the like. Moreover, the system contemplates the use, sale, exchange, transfer, or any distribution of any goods, services or information over a network having similar functionality described herein.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having a computer-readable program code means embodied in the storage medium. Any suitable computer-readable storage medium may be utilized, including hard disks, CD-ROM, optical storage devices, magnetic storage devices, flash card memory, and/or the like.

Communication between the parties (e.g., user, host system, and/or merchant) to the transaction and the system of the present invention may be accomplished through any suitable communication means, such as, for example, a telephone network, intranet, internet, point of interaction device (point of sale device, personal digital assistant, cellular phone, kiosk, and/or the like), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, digital security systems and/or the like.

“Smart card”, as defined herein, includes any type of transaction, authentication, and/or financial instrument (e.g., charge card, credit card, loyalty card, identification card, stored value card, and/or the like) that is capable of storing, generating, and/or transmitting digital certificates or other authentication information so that the host system and/or merchant is able to better authenticate and identify the user and the account. ‘Smart card” includes other readable and/or read/write data storage and retrieval devices (e.g., optical scanner, bar code, bokode, QR code, bar code reader, and/or the like). As will be apparent to one of skill in the art, it may be desirable for some embodiments to utilize a bar code and code reader or other similar alternative means of storing and reading data. Other authenticating methods and devices included within the scope of this invention, which may or may not be incorporated within the processing functions and capabilities of the smart card device, include retinal, voice, fingerprint or other biometric identification/recognition devices, challenge/password, and/or the like.

It is within the scope of the present invention to improve the systems and methods in any of the patents and applications mentioned in this paragraph by adding account funding according to the present invention and “smart card” includes any transaction and/or financial instrument such as loyalty cards, gift cards, stored value cards, and/or the like; and for more information on loyalty systems, smart card systems, transaction systems, and electronic commerce systems, is in, for example, a method and system for using loyalty points as disclosed in U.S. Ser. No. 09/834,478, filed on Apr. 13, 2001, the Shop AMEX (trademark) system as disclosed in U.S. Ser. No. 60/230,190, filed Sep. 5, 2000; a digital wallet system as disclosed in U.S. Ser. No. 09/652,899, filed Aug. 31, 2000; a stored value card as disclosed in U.S. Ser. No. 09/241,188, filed on Feb. 1, 1999; a system and method for facilitating the handling of a dispute as disclosed in U.S. Ser. No. 09/537,506, filed on Mar. 29, 2000; a system for facilitating transactions using secondary transaction numbers as disclosed in Ser. No. 09/800,461, filed on Mar. 7, 2001; methods and apparatus for illuminating a transaction card as disclosed in U.S. Ser. No. 09/734,098, filed Dec. 11, 2000; smart card systems as disclosed in U.S. Ser. No. 60/232,040, filed on Sep. 12, 2000; and U.S. Pat. Nos. 5,742,845, 5,898,838 and 5,905,908, owned by Datascape, all of which are incorporated fully herein by reference.

A “merchant” may be any hardware, software, system, company, entity, person and/or business suitably configured to provide goods or services to users via a computerized network such as the internet. The merchant system can include hardware and software components such as web servers, application servers and databases to facilitate the online shopping presence (i.e., a shopping website) and/or the pension funding. In the online embodiment, the merchant shopping website, in one aspect, is a virtual shopping page accessible to a user via the user's web browser. In certain aspects, the merchant is suitably configured with software (e.g., code string) that can detect host system user files and pension account file or files associated with smart card reader software. Upon detecting the user's smart card reader, the merchant system can trigger the appearance of a smart card payment button on a web browser.

In certain aspects, the host system includes any hardware and/or software suitably configured to facilitate the transaction between the user and the merchant and the account funding. The host system may or may not include open loop financial banking systems and/or telephone or utility companies or other account management institutions and/or financial institutions. Optionally, a host system may also include various front end and back end banking systems that facilitate, inter alia, the generation and processing of the secondary transaction numbers and/or the identification of and/or funding of the account.

The present invention provides methods and systems for funding an account, e.g., a pension, college, or insurance account, which are part of a method and system for performing a financial transaction using a user interface. In certain aspects such a system and method for performing a financial transaction determine a master account number associated with one or more accounts that a user may access (including a pension account), providing data to generate a user interface displaying a list of the accounts and an indicator associated with a financial transaction, receiving indicator information associating the indicator with one or more of the accounts, receiving terms for the financial transaction, performing the financial transaction, and then, based on the transaction, funding the pension account by the user and/or by any entity involved in the transaction and/or the performing of the transaction.

In certain aspects, such a method and system provide improvements (e.g., account funding, e.g., pension account funding, according to the present invention) to the subject matter of U.S. Pat. No. 7,792,748 (incorporated fully herein for all purposes), which patent application does not disclose, teach of suggest the improved methods and systems, nor are the improved systems and methods obvious in view of this patent application or in view of this patent application in combination with any other patent, application, applications, or patents.

The present invention provides systems and methods which effect funding of a user's account in addition to the devices and steps of any system or method of U.S. Pat. No. 7,792,748. In certain of these new systems and methods, software is provided for effecting pension account funding; and, in certain aspects, including: transmitting identifying information associated with a user, displaying a user interface, transmitting indicator information reflecting an association between an indicator and one or more accounts, and transmitting terms for a financial transaction.

The present invention provides systems and methods for effecting account funding for systems and methods for payment application lifecycle management in a contactless smart card. In certain aspects, such methods include: managing the lifecycle of a card software application for pension account funding received from a remote trusted service manager (TSM) for a secure element of a contactless smart card including receiving, from the remote TSM, the card application for an account funding and an instruction for performing a function on the card application. Optionally, the card application includes account information of one card instrument and an application identifier (AID) and the instruction is rendered in the secure element to perform the function on the card application. Optionally, the card application is registered in a control application of the secure element using the AID. Optionally the control application includes a list of AIDs of previously received and registered card software applications and a card application status tag for each of the listed AIDs; and the card application status tag of the registered card application is updated in the control application based on the function performed.

In certain aspects, such a method and system provide improvements (e.g., account funding, e.g., pension account funding, according to the present invention) to the subject matter of U.S. Pat. No. 8,196,131 (incorporated fully herein for all purposes), which patent application does not disclose, teach of suggest the improved methods and systems, nor are the improved systems and methods obvious in view of this patent application or in view of this patent application in combination with any other patent, application, applications, or patents.

In certain exemplary embodiments, a computer-implemented method for funding an account and for controlling a plurality of contactless smart card software applications using a control software application, the control software application and the plurality of contactless smart card software applications resident in a secure element includes receiving, at the control software application in the secure element, an application identifier (AID) of a selected contactless smart card software application from the plurality of registered contactless smart card software applications and a software code for an instruction to be performed on the selected contactless smart card software application; executing, in the secure element, at one of the control software application, the card runtime environment, or the selected contactless smart card software application, a process method function call associated with the software code, thereby performing the instruction on the selected contactless smart card software application; and updating, at the control software application, a registered list of the plurality of contactless smart card software applications with a software coded tag responsive to the instruction performed; wherein the software applications include, inter alia, a software application for funding an account, e.g., a pension account of a user (e.g., a user of a credit card, of a cellphone, of a computer device, or of a GSM phone).

The present invention, in certain aspects, provides improvements to the subject matter of U.S. Patent Application Publication No. 20120166333 (incorporated fully herein for all purposes), which patent application does not disclose, teach of suggest the improved methods and systems according to the present invention, nor are the improved systems and methods obvious in view of this patent application or in view of this patent application in combination with any other patent, application, applications, or patents. These improvements include, inter alia, the addition of funding of an account according to the present invention (any account and any funding system and any funding method according to the present invention) and/or any computer application (or “app”) according to the present invention.

In certain aspects, the present invention provides a system with a computer application or “app” (or “computer module” or “app module” or “application module”) that facilitates fast, convenient, and secure commerce using a mobile electronic device (or non-mobile electronic device) and stores information associated with transactions, such as account fundings, funding confirmations, purchase confirmations and/or receipts. The system, computer application (any according to the present invention), a user device, and/or a digital wallet can store information for use in fundings and/or transactions, including information associated with one or more financial accounts, funding sources, user information, and/or shipping information. To complete an online account funding and/or a purchase, the system, computer application, user device, and/or digital wallet can interact with a financial institution's website, a merchant's website, and/or a funding source website to obtain information regarding the funding and/or purchase. The system, user device, computer application, and/or digital wallet provides a user interface for the user to review and confirm the purchase information. The user interface can also allow the user, in certain aspects, to select from multiple account funding sources, to select payment options, to customize shipping information, and/or to provide information requested by an account funding source, a financial institution, an Internet service provider, and/or a merchant. The system computer application, user device and/or digital wallet can transmit user confirmation to a financial institution, a funding source, and/or a merchant's website and receive a receipt for the funding, transaction, and/or purchase. The system, suer device, computer application, and/or digital wallet can store the receipt and synchronize the receipt with a remote storage location.

An aspect of the present invention provides a computer-implemented method for completing an online transaction. A digital wallet module resident on a client device receives a request for payment information to complete the transaction. The request originates from a website of a merchant. In response to receiving the request, the digital wallet module retrieves the payment information from a storage location on the client device and transmits the retrieved payment information to the merchant website.

Another aspect of the present invention provides a computer program product for completing an online transaction. The computer program product includes a computer-readable storage device having computer-readable program instructions stored therein. The computer-readable program instructions includes computer program instructions for receiving a request for payment information to complete the transaction, the request originating from a website of a merchant; computer program instructions for retrieving, in response to the request, the payment information; and computer program instructions for transmitting the retrieved payment information to the website.

Another aspect of the present invention provides an apparatus for completing an electronic purchase from a merchant via a distributed network. The apparatus includes a web browser application a digital wallet module logically coupled to the web browser application. The digital wallet module is configured to receive a request for payment information to use in completing the purchase from the merchant website; retrieve payment information from a computer-readable storage device logically coupled to the digital wallet module; and transmit the retrieved payment information to the merchant.

Another aspect of the present invention provides a computer-implemented method for completing a purchase from a merchant via a website of the merchant. A digital wallet module embedded in a web browser in communication with the merchant website receives a purchase request message including a request for payment information for use in compensating the merchant for the purchase. In response to receiving the purchase request message, the digital wallet module presents a confirmation display requesting a user to authorize the purchase. In response to receiving authorization from the user, the digital wallet module retrieves stored payment information and transmits a payment authorization message including the retrieved payment information to the merchant website.

One or more aspects of the invention may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as the act may be performed by more than one computer. The inventive functionality of the invention will be explained in more detail in the following description, read in conjunction with the figures illustrating the program flow.

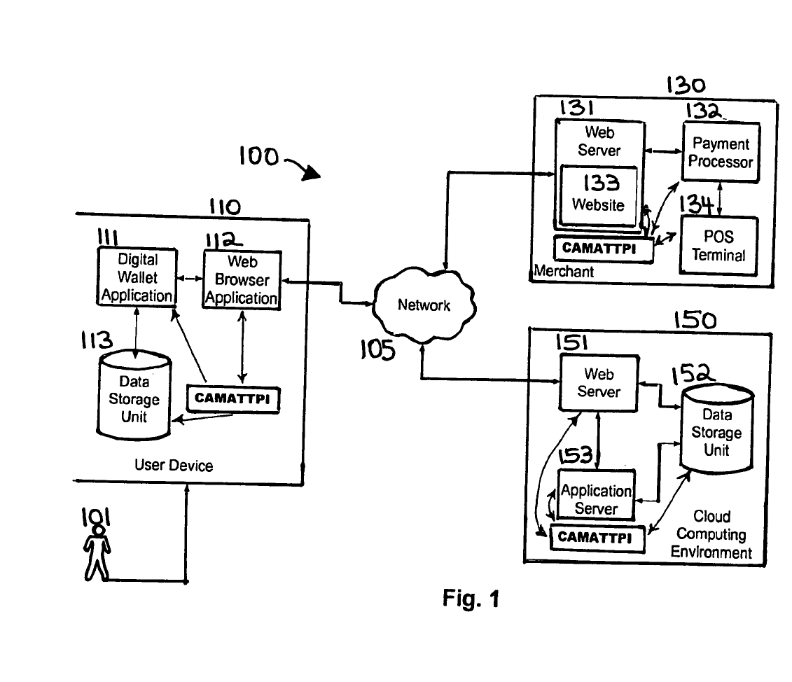

Turning now to the drawings, in which like numerals represent like (but not necessarily identical) elements throughout the figures, exemplary embodiments of the present invention are described in detail. FIG. 1 is a block diagram depicting an operating environment 100 for a computer application module according to the present invention—“CAMATTPI”—and, optionally, a digital wallet.

Referring to FIG. 1, an exemplary operating environment 100 includes a merchant system 130, a cloud computing environment 150, and a user device 110 associated with a user 101. The user device 110 may be a personal computer, mobile device, (for example, notebook computer, tablet computer, netbook computer, personal digital assistant (PDA), video game device, GPS locator device, cellular telephone, smartphone, or other mobile device), or other appropriate technology that includes or is coupled to a web browser application module 112, such as GOOGLE'S CHROME, MICROSOFT'S INTERNET EXPLORER®, or MOZILLA'S FIREFOX®.

In certain exemplary embodiments, the web browser application 112 is an HTML5 compliant web browser. HTML5 compliant web browsers include a cross-document messaging application programming interface (API) and a local storage API that previous HTML versions did not have. The cross-document messaging API of HTML5 compliant web browsers enables documents, such as web pages, to communicate with each other. For example, a first document can send a message to a second document requesting information. In response, the second document can send a message including the requested information to the first document. The local storage API of HTML5 compliant web browsers enables the web browser to store information on a client device upon which the web browser is installed or is executing, such as the user device 110. Websites also can employ the local storage API to store information on a client device. Other web browsers having cross-document messaging and/or local storage capabilities also may be used in certain exemplary embodiments.

The user 101 can use the web browser application 112 to view, download, upload, or otherwise access documents or web pages via a distributed network 105. The network 105 includes a wired or wireless telecommunication system or device by which network devices (including devices 110, 130, and 150) can exchange data. For example, the network 105 can include a local area network (“LAN”), a wide area network (“WAN”), an intranet, an Internet, or any combination thereof. Throughout the discussion of exemplary embodiments, it should be understood that the terms “data” and “information” are used interchangeably herein to refer to text, images, audio, video, or any other form of information that can exist in a computer based environment.

The web browser application 112 can interact with web servers (or other computing devices) connected to the network 105, such as web server 132 of the merchant system 130 and/or web server 151 of the cloud computing environment 150. “Merchant” is to be understood to include, inter alia, account funding source(s) and/or entities for effecting a goal or goals of a CAMATTPI—with an appropriate processor substituted for or used with the “Payment Processor.” Similarly the “Application Server” includes the necessary items, hardware, software, connections, etc. to be a server for a CAMATTPI.

The user device 110 also includes a CAMATTPI application module and, optionally, a digital wallet application module 111. The CAMATTPI and/or exemplary digital wallet 111 can interact with the web browser application 112 or can be embodied as a companion application of the web browser application 112. As a companion application, the CAMATTPI and/or the digital wallet 111 executes within the web browser application 112. That is, the CAMATTPI and/or the digital wallet 111 may be an application program embedded in the web browser application 112.

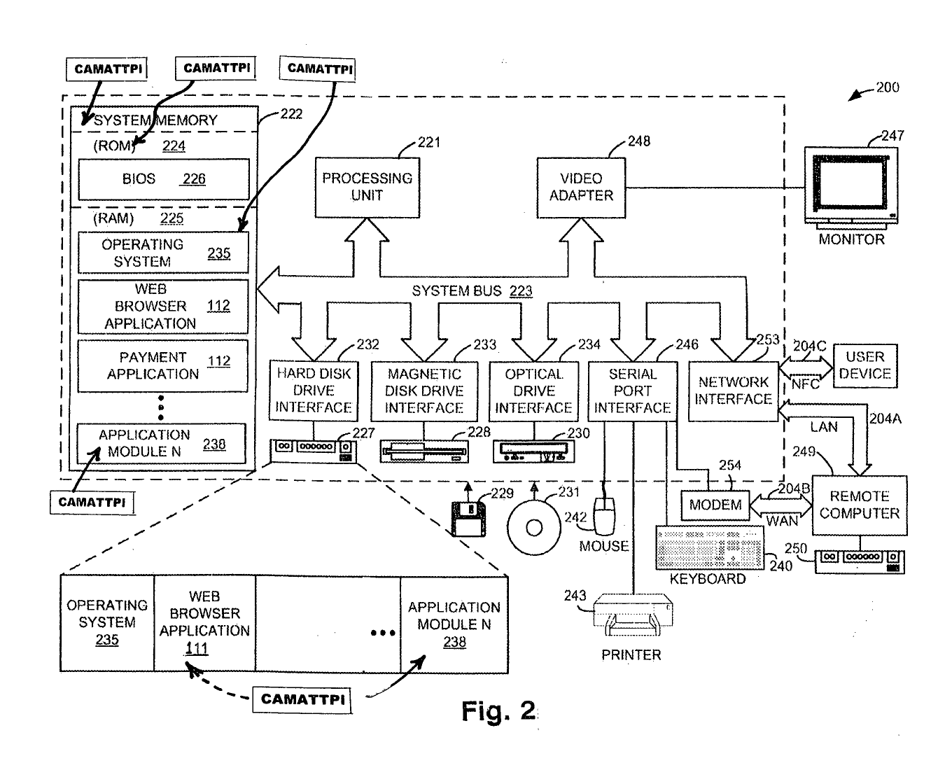

The user device 110 also includes a data storage unit 113 accessible by the CAMATTPI and/or by the digital wallet 111 and the web browser application 112. The exemplary data storage unit 113 can include one or more tangible computer-readable storage devices as discussed below with reference to FIG. 2. The data storage unit 113 can be stored on the user device 110 or can be logically coupled to the user device 110. For example, the data storage unit 113 can include on-board flash memory and/or one or more removable memory cards or removable flash memory.

In certain aspects, the CAMATTPI enables storage of one or more account funding options that can be used for online account funding and/or offline account funding. Each option can include or be associated with a financial account, such as a credit card account, a debit card account, a checking account, a savings account, a loyalty rewards account, or other type of account that can be used to fund an account according to the present invention. The CAMATTPI can enable storage of one or more account funding options that can be used for online funding and/or for offline funding. This information can include a financial account identifier (for example, account number, card number), an expiration date of one or more financial cards associated with the financial account, and a billing address for the account. The information can also include information associated with the user 101, such as name, contact information (for example, residential address, phone number, e-mail address), demographic information, or any other suitable information associated with the user 101. The information for each funding option can be maintained by CAMATTPI, by the digital wallet 111, or by both, and can optionally be stored in the data storage unit 113.

The user 101 can interact with a user interface to add, modify, or remove funding information from the CAMATTPI and/or from the digital wallet 111. In a web browser companion application embodiment, this user interface can be provided via the web browser application 112. In addition or in the alternative, the funding information may be synchronized with a remote storage location, such as the cloud computing environment 150. In such an embodiment, the user 101 can access the information stored at the remote location using another device, such as a desktop computer connected to the network 105. The remote storage location can update the CAMATTPI and/or the digital wallet 111 in response to any changes made at the remote storage location.

In certain aspects, the funding options stored in a CAMATTPI can be used to complete funding from a site such as, but not limited to, an event site, a point of sale apparatus, an ATM, or a merchant site.

Option(s) stored in the digital wallet 111 can be used to complete purchases from merchants via a merchant's website 133 operating on the web server 131 or via a merchant's point of sale device 134. In certain exemplary embodiments, each merchant's website 133 (operating on the web server 131) that accepts payment via a digital wallet 111 and/or funding via a CAMATTPI can include a set of computer-readable program instructions, for example, using JavaScript, that enable the merchant's website 133 to interact with the digital wallet 111 and/or with the CAMATTPI. These program instructions can include program instructions for detecting whether the user device 110 includes a digital wallet 111 and/or a suitable CAMATTPI and program instructions for attaching to a detected CAMATTPI and/or to a digital wallet 111. Once attached, the merchant's website 133 can communicate with the CAMATTPI and/or digital wallet 111, for example, via cross-document messaging.

In certain exemplary embodiments, the computer-readable instructions also include program instructions for downloading a CAMATTPI and/or digital wallet 111 onto a user device 110. For example, if a funding source website or a merchant's website 133 detects that a user device 110 does not have a CAMATTPI and/or a digital wallet 111, the website can prompt the user 101 to download and install the CAMATTPI and/or digital wallet 111. If the user 101 elects to download the CAMATTPI and/or digital wallet 111, the computer-readable program code can download and install the CAMATTPI and/or digital wallet 111 on the user device 101. Embedding this computer-readable program instructions in a website 133 for interacting with a CAMATTPI and/or digital wallet 111 can support a simpler and efficient integration for a funding system and/or a merchant system 130 compared to integrating with a third party processor.

The funding and/or merchant's website and the CAMATTPI and/or digital wallet 111 can communicate using a defined messaging protocol and encoded messages where the messages are decoded using the protocol. Similarly, a website can encode a message using the protocol and send the encoded message to the CAMATTPI and/or to the digital wallet 111 where the message is decoded using the protocol.

The merchant system 130 includes a payment processor 132 logically coupled to the web server 131. The payment processor 132 can receive payment information via the web server 131 and interact with the financial institution (not shown) or an acquirer (not shown) to authorize payment information.

To complete an online purchase via the Internet (or an online account funding), the digital wallet 111 (or CAMATTPI for an online funding) can interact with a website 133 of the merchant system 130 (or of a funding source) and with the user 101. The user 101 can browse the merchant's website 133 for products using the web browser 112 and indicate a desire to purchase one or more products (or browse account funding options). As used throughout the specification, the term “products” should be interpreted to include tangible and intangible products, as well as services, as well as accounts for funding according to the present invention. After the user 101 has indicated a desire to purchase the product(s) (for example, by actuating a “checkout” link), (or to fund an account) the merchant's website 133 can present a user interface in the form of a web page to receive payment information from the user 101 (or a form for a specific CAMATTPI). The merchant's website 133 also can detect whether the user device 110 includes a CAMATTPI and/or a digital wallet 111. If the CAMATTPI or digital wallet 111 is detected, the merchant's website 133 can automatically attach to the CAMATTPI or to the digital wallet 111. In addition or in the alternative, the merchant's website 133 can include a “pay with wallet” link or control that, when actuated, causes the merchant's website 133 to attach to the digital wallet 111. Once attached, the merchant's website 133 (or funding website) sends a purchase request message (or account funding request message) to the CAMATTPI and/or digital wallet 111 requesting payment information and/or funding information. The request message also can include information regarding the requested funding, and/or purchase, including information regarding the account to be funded, product(s) for purchase (for example, name and/or description of each product, price for each product, total price, etc.), information regarding the merchant system 130 (for example, merchant name, acceptable funding methods, payment methods accepted by merchant, etc.), and/or requests for the user 101 to provide additional information. In response to receiving a request message, the CAMATTPI and/or digital wallet 111 can present a user interface to the user 101 for the user 101 to confirm the funding request and/or purchase. This user interface can display all or a portion of the information in the request and an actuatable button or link for the user 101 to confirm the funding or the purchase. This user interface also can allow the user 101 to select from multiple funding options and/or payment options stored by the CAMATTPI and/or by the digital wallet 111 to use as funding for a selected account or for payment for selected product(s).

If the user 101 confirms a particular account funding, the CAMATTPI can retrieve the information requested in the funding request message, generate a request message that contains the information and the confirmation, and transmit the request message to a funding source website. If the funding is authorized via a funding processor, the funding website can transmit an electronic confirmation and/or a receipt to the CAMATTPI and then detach from the CAMATTPI. The CAMATTPI can store the confirmation and/or receipt at the user device 110 and also synchronize with the cloud computing environment 150.

An exemplary cloud computing environment 150 can include the web server 151, one or more data storage units 152, and one or more application servers 153, including one or more for CAMATTPIs. The cloud computing environment 150 may be provided by the provider of the CAMATTPI or the digital wallet, by a funding source, by a merchant 130, by a financial institution, or by another party. In certain exemplary embodiments, multiple cloud computing environments 150 may be employed. For example, a first cloud computing environment may store receipt information and provide access to the receipts from a user device 110 connected to the first cloud computing environment, and a second cloud computing environment may provide security information, such as lists of non-trusted merchants, to the CAMATTPI and/or digital wallet 111. Although the illustrated environment includes a cloud computing environment, other types of computing environments, such as a client-server environment may be used instead.

The application server 153 can maintain a CAMATTPI account for each CAMATTPI user, including the user 101. This account can store (in the data storage unit 152) the account funding options and the payment options created by the user 101 and their associated funding information and payment information and receipts and other information obtained by the CAMATTPI and/or by the digital wallet 111 in response to completed fundings and/or transactions. The application server 153 can synchronize this information with the CAMATTPI and/or digital wallet 111 periodically, on command (for example, by the user 101), or in response to an update in information or at the cloud computing environment 150.

The CAMATTPI and/or the digital wallet 111 and the web browser application 112 can interact with the application server 151 via the web server 151. The application server 153 can provide a user interface via the web server 151 that enables the user 101 to access, view, and/or modify content stored in the user's CAMATTPI account and/or digital wallet account using the user device 110 or another device connected to the network.

For example, the user 101 may add or modify funding source information using a web browser application residing on a desktop computer having a better user interface for entering a significant amount of information.

The exemplary digital wallet 111 can include a user interface for accessing receipt information stored on the user device 110 or at the cloud computing environment 150 in a meaningful and useful way. One feature of this user interface enables the user 101 to search the receipts for information.

One or more of the components of the exemplary operating environment 100, such as the user device 110, the web server 131, the web server 151, and the application server 153 can include one or more computer systems, such as the computer system 200 illustrated in FIG. 2. Referring to FIG. 2, the computer system 200 includes a processing unit 221, a system memory 222, and a system bus 223 that couples system components, including the system memory 222, to the processing unit 221. The system bus 223 can include any of several types of bus structures, including a memory bus or memory controller, a peripheral bus, or a local bus, using any of a variety of bus architectures. The system memory 222 includes a read-only memory (“ROM”) 224 and a random access memory (“RAM”) 225. A basic input/output system (BIOS) 226 containing the basic routines that help to transfer information between elements within the computer system 200, such as during start-up, is stored in the ROM 224.

The computer system 200 also includes a hard disk drive 227 for reading from and writing to a hard disk (not shown), a magnetic disk drive 228 for reading from or writing to a removable magnetic disk 229 such as a floppy disk, and an optical disk drive 230 for reading from or writing to a removable optical disk 231 such as a CD-ROM, compact disk-read/write (CD/RW), DVD, or other optical media. The hard disk drive 227, magnetic disk drive 228, and optical disk drive 230 are connected to the system bus 223 by a hard disk drive interface 232, a magnetic disk drive interface 233, and an optical disk drive interface 234, respectively. Although the exemplary computer system 200 employs a ROM 224, a RAM 225, a hard disk drive 227, a removable magnetic disk 229, and a removable optical disk 231, other types of computer-readable media also can be used in the exemplary computer system 200. For example, the computer-readable media can include any apparatus that can contain, store, communicate, propagate, or transport data for use by or in connection with one or more components of the computer system 200, including any electronic, magnetic, optical, electromagnetic, infrared, or semiconductor system (or apparatus or device) or propagation medium, such as magnetic cassettes, flash memory cards, digital video disks, Bernoulli cartridges, and the like. The drives and their associated computer-readable media can provide nonvolatile storage of computer-executable instructions, data structures, program modules, and other data for the computer system 200.

A number of modules (e.g., at least one CAMATTPI or a plurality of CAMATTPIs) can be stored on the ROM 224, RAM 225, hard disk drive 227, magnetic disk 229, or optical disk 231, including an operating system 235, an application module 238 e.g. with at least one CAMATTPI, and the web browser application 112, the optional digital wallet 111, and the website application discussed above in connection with FIG. 1. The web browser application 112, the digital wallet 111, website application, and application module 238—and any CAMATTPI—can include routines, sub-routines, programs, objects, components, data structures, etc., which perform particular tasks or implement particular abstract data types.

A user, such as user 101, can enter commands and information to the computer system 200 through input devices, such as a keyboard 240 and a pointing device 242. The pointing device 242 can include a mouse, a trackball, an electronic pen that can be used in conjunction with an electronic tablet, or any other input device, such as a microphone, joystick, game pad, satellite dish, scanner, or the like. These and other input devices are often connected to the processing unit 222 through a serial port interface 246 that is coupled to the system bus 223, but can be connected by other interfaces, such as a parallel port, game port, a universal serial bus (USB), or the like. A display device 247, such as a monitor, also can be connected to the system bus 223 via an interface, such as video adapter 248. In addition to the display device 247, the computer 220 can include other peripheral output devices, such as speakers and a printer 243 (e.g., 2D or 3D printer).

The computer system 200 is configured to operate in a networked environment using logical connections to one or more remote computers 249. The remote computer 249 can be any network device, such as a personal computer, a server, a router, a network PC, a peer device, or other device. While the remote computer 249 typically includes many or all of the elements described above relative to the computer system 200, only a memory storage device 250 has been illustrated in FIG. 2 for simplicity. The logical connections depicted in FIG. 2 include a LAN 204A and a WAN 204B. Such networking environments are commonplace in offices, enterprise-wide computer networks, intranets, and the Internet.

When used in a LAN networking environment, the computer system 200 is often connected to the LAN 204A through a network interface or adapter 253. When used in a WAN networking environment, the computer system 200 typically includes a modem 254 or other means for establishing communications over the WAN 204B, such as the Internet. The modem 254, which can be internal or external, is connected to system bus 223 via a serial port interface 246. In a networked environment, program modules depicted relative to computer system 200, or portions thereof, can be stored in the remote memory storage device 250.

It will be appreciated that the network connections shown are exemplary and other means of establishing a communications link between the computers can be used. Moreover, those having ordinary skill in the art having the benefit of the present disclosure will appreciate that the computer system 200 illustrated in FIG. 2 can have any of several other suitable computer system configurations. Furthermore, those skilled in the art having the benefit of the present disclosure will recognize that certain components of the computer system 200 may be added, deleted, or modified in certain alternative embodiments. For example a user device 101 embodied as a mobile phone or handheld computer may not include all the components depicted in FIG. 2 and/or described above.

The exemplary embodiments described herein can be used with computer hardware and software that perform the methods and processing functions described previously. The systems, methods, computer applications, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The exemplary methods and acts described in the embodiments presented previously are illustrative, and, in alternative embodiments, certain acts can be performed in a different order, in parallel with one another, omitted entirely, and/or combined between different exemplary embodiments, and/or certain additional acts can be performed, without departing from the scope and spirit of the invention. Accordingly, such alternative embodiments are included in the inventions described herein.

Any feature, method, or aspect of any particular computer application described herein may be added to, made part of, or implemented with any other computer application (so long as such implementation is not contradictory of some other aspect or feature). For example, and not by way of limitation, the various insurance features of the wedding apps described above can be used, inter alia, with the apps described for game events, NASCAR races, funerals, and baptisms.

Any computer application herein may include, or a separate computer application is provided, that provides “event expense” protection. Such “event protection” may be “account funding protection” and may apply to any amount funding any account according to the present invention. Any person who has spent money on a gift or on expenses related to an event (e.g., catering, cost of tickets, transportation expense, photography, reception site rental, clothes rental or purchase, musicians, DJ, bartender expense, wedding present, flower expense, tuxedo expense, birthday present, dress expense, etc.) may take part in a pool to which a person makes a contribution. The pool is closed and ends up with a closing amount, a total amount of money in the pool. At a later date following the date of closing of the pool, the pool is disbursed. In one aspect the pool is disbursed to all those who contributed based on each person's pro rata share of contribution to the pool.

Such distribution, in one aspect, is conditioned upon a subsequent event happening or not happening. For example, with regard to a wedding event, pool distribution to those who have contributed to it is conditioned upon the bride and groom getting divorced. For example, 25 persons contribute to a wedding expense pool in various amounts, including the bride's parents contributing $10,000, a sister of the bride contributes $1000, and the total closing amount is $95,000. The persons contributing to the pool agree that either the bride and groom get the total closing amount of $95,000 if they stay married for 5 years or the pool amount is disbursed to the persons who have contributed if they get divorced before the 5 years is up. For example, under the scenario of a divorce 4 years after the marriage, the bride's parents receive $10,000, the bride's sister receives $1000, and the other contributors receive what they contributed.

Any app may also include expense insurance. For example, for an event a person provides a gift; e.g. at a wedding shower, a baby shower, or a wedding reception. A person gives the gift (which in one aspect is an amount funding an account) and also buys the expense insurance. In the event a pre-condition is met (e.g. a baby is not born or a wedding is canceled or a divorce occurs after a wedding) the person giving the gift is reimbursed the price paid for the gift. Optionally, that price is donated to a charity or good cause chosen by the person—and this may be done with any account, payout, reimbursement, or insurance amount in any method or computer application according to the present invention.

The present invention provides systems according to the present invention with an account funding step or steps—any suitable account, any funding, any step or steps according to any method for funding previously described herein according to the present invention—as improvements to the systems and methods of United States Patent Application Publication No. 20120144461 published Jun. 7, 2012 (incorporated fully herein for all purposes). In certain aspects, the present invention provides a system for such funding according to the present invention which includes funding an account (any account disclosed herein, any funding disclosed herein) and the system configured to: receive an authentication request for a transaction from a web server; identify a phone number of the mobile device based on identifying information of the user in the authentication request and the user information, transmit a message to the mobile device based on the phone number, receive a message response from the mobile device, determine whether the mobile device provided a mobile pin pad authentication for the user based on the message response, and transmit a success authentication response to the web server when the mobile device provided the mobile pin pad authentication for the user.

The present invention provides, in certain aspects, a method including: generating, by a server device, a message based on an authentication request for a transaction; transmitting, by the server device, the message to a remote device based on the authentication request, where the message prompts a pin pad application; receiving, by the server device, a message response from the remote device, where the message response comprises a first one time password (OTP) generated by the pin pad application of the remote device; validating, by the server device, the first OTP; generating, by the server device, a success authentication response when the validating of the first OTP is successful, where the success authentication response is an approval of the transaction; transmitting, by the server device, the success authentication response; completion of the transaction; and funding an account based on said completion or on said validating. Such a method can include, in any possible combination, the further subject matter of the claims of U.S. application Pub. No. 20120144461.

The present invention provides, in certain aspects, a system including: a memory to store user information for a user of a mobile device; and a processor, connected to the memory, to: receive an authentication request for a transaction from a web server; identify a phone number of the mobile device based on identifying information of the user in the authentication request and the user information, transmit a message to the mobile device based on the phone number, where the message prompts a mobile pin pad application of the mobile device, receive a message response from the mobile device, determine whether the mobile device provided a mobile pin pad authentication for the user based on the message response, and transmit a success authentication response to the web server when the mobile device provided the mobile pin pad authentication for the user; and said processor or another processor or processors to complete the transaction and said processor or another processor or processors for funding an account based on said completion or on another step of this method.

In one embodiment according to the present invention, a user may proceed to a merchant (e.g., but not limited to, a restaurant, sporting event, gas station, department store, etc.) to make a purchase. In a method according to the present invention, the user may request an operator of computer terminal located at a location of the merchant, to pay for the purchase by using a digital wallet associated with the user. An authentication server may have access to/store information about the digital wallet. The digital wallet may be associated with one or more accounts (e.g., a credit card account, a checking account, a digital wallet account (e.g., a user may transfer money from another account to the digital wallet account, etc.) of the user. The user may present to the operator a first form of identification (e.g., a reward card) to serve as a first form of authentication for a transaction of making the purchase using the digital wallet. The operator may use computer terminal to transmit information about the transaction and the first form of identification to a web server. To receive a second form of authentication for the user via a mobile pin pad authentication of using a mobile device, the web server may transmit an authentication request for the transaction to an authentication server. The authentication request may include information about the transaction (e.g., a description of the purchase, an identifier of the merchant, amount of the transaction, geographic location coordinates of the merchant, etc.) and the user and a description of what information is being requested (e.g., an authentication request for the transaction, a risk score, geographic location coordinates of the mobile device, etc.).

The present invention provides, in certain aspects, a computer-readable media storing a program for causing a computer to perform a method, the method comprising: any method disclosed in the preceding four paragraphs; the method, in certain aspects related to an event. The present invention provides, in certain aspects, a computer application or “app” for effecting the method according to the present invention; and, in one aspect, it is an app such as a CAMAATTPI as in FIGS. 1 and 2. above.

In any method according to the present invention that involves a transaction and/or the funding of an account, one or multiple funding sources, one or multiple digital wallet providers or electronic wallet providers, one or multiple internet providers, one or multiple manufacturers, multiple warehousing entities, multiple phone service providers, and/or merchants can bid (there being at least two bidders form the same category or from different categories) for the business of a particular transaction either prior thereto or in real time just prior to transaction completion (and, inter alia, such a bidding method according to the present invention may be combined with the subject matter of any numbered claim in any listing of numbered claims herein). In another aspect, such bidding occurs automatically and the transaction, sale, purchase, etc. is finalized according to a preset protocol, pre-chosen rule, and/or predetermined choice of a consumer.

In one embodiment, when there are multiple bidders that submit a bid, a consumer has preselected a bidder of the multiple bidders to “win” the bid, so long as that selected bidder is one of the actual bidders (if not, the consumer can select one of the actual bidders). For example, a consumer scans a product at a Walmart (e.g., identifies a product to be purchased using a camera on a phone, e.g., by scanning a barcode, nanocode, RFID identifier, or some other identification code, structure or material). A computer application in the phone and/or at a server of the phone service provider alerts potential entities through whom the transaction can be completed and each of them makes a decision whether or not to bid for the business. Via the server, ans employing the computer app, of all those who decide to bid, e.g., a phone service provider, a credit card issuer and a wallet provider (e.g., one of electronic, digital, on-line wallet providers), each provides a bid. The server sends the bids to the consumer. In one aspect, the computer application has already been adjusted, changed, and/or programmed so that when three such entities, and/or when any of these three particular entities make a bid, the consumer has already chosen the winner. For example, the consumer may have decided that, due to award points provided by the credit card issuer, if the credit card issuer bids, that is the entity chosen; or the consumer has decided that, because of free phone minutes provided by the phone service provider, that is the entity chosen. In another example, a consumer has pre-selected a chosen particular eWallet provider in the event that multiple eWallet providers submit a bid for a product or service.

In the embodiment in which consumer choice is not effected automatically based on a consumer preselection, the consumer is provided information about the various bids and then selects the most desirable bidding option. Upon selection, the transaction, sale, etc. is finalized in accord with the consumer's wishes.

In one embodiment, the bidding is done by entities that provide a selected product or service in an apples-to-apples comparison of price—the product or service in each bid being identical. The entities may be similar entities, e.g. WalMart and Target or XYZ Tickets and ABC tickets. In one particular aspect, the bidding entities are electronic wallet providers who have pre-arranged relationships with entities that provide the product or service. Each wallet entity states a price that will secure the product or service so long as the consumer chooses that particular wallet provider to effect and finalize the transaction, sale, etc.

“Apples-to-apples” bidding may include the same warrandy terms and/or the same service-after-the sale terms. “Apples-to-apples” bidding may include the Same delivery date if the product or service is not presently available on site.

In other embodiments, the bidding provides an apples-to-oranges bidding environment. For example, although the price may be the same, the consumer may be five miles away from one bidder and twelve miles away from another bidder or a bidder may not be able to provide the product or service immediately and there will be a shipping or provision delay. In another example, although price and distance to retail location may be similar, sales tax may differ between locations. “Apples-to-Oranges” bidding methods according to the present invention can involve differences in, e.g., warranties available; delivery immediately or delivery at a future date; different product (more expensive, less expensive; fewer features, more features; fewer associated items, more associated items, e.g., but not limited to, cables, speakers, batteries, lights, software, carrying case, supports, etc); no after transaction service, after transactions service; account funding—any according to the present invention; and/or service on site or return-to-seller service.

In certain “apples-to-oranges” bidding situations according to the present invention, different bidders offer incentives from different categories which are presented to a consumer, e.g., on a screen, e.g. but not limited to, a screen of a POS system, a screen of a laptop computer, a screen of a smartphone, a screen of an iPad, a screen of a netbook or notebook, or a screen of a tablet computer. The consumer reviews the offered incentives and selects a bidder based on the incentive offered. For example, and not by way of limitation, a consumer desires to purchase a plane ticket for a round trip between Houston, Tex. and Geneva, Switzerland for specified travel dates. Working via her laptop computer, she activates a computer application that places her ticket order and which also alerts potential bidders, including, but not limited to, credit card issuers, airlines, wallet providers, travel agencies, and hotel chains. The computer app presents all bids to her and she reviews them. For example, the bids include these bidders offering these incentive: Visa Card—in addition to any other award points associated with the transaction, an additional 15,000 award points for that card account; American Airlines—10,000 miles for its frequent flyer program awards; Four Seasons Hotels—a free room night for the stay in Geneva; and PayPal—a free rental car for a weekend while she is in Geneva. Each bidder and the corresponding incentive is displayed on the laptop's screen. She chooses the Four Seasons Hotel bid. Via the bidding computer app, and/or via a related app, the ticket purchase is finalized and a reservation is made for the free night at the hotel. She receives a confirmation alert on her laptop screen and/or a confirmatory email at her on-file email address. In another aspect, bidders each bid on the price of the ticket—in addition to incentives or without them.

In another example of a bidding method according to the present invention, a person desires to purchase a new computer from Dell Computers, Austin Tex. and—via a cellphone or smartphone goes to the Dell website and chooses the particular computer and accessories and software. Dell quotes a final total price. Via a previously-loaded computer app on the phone, four eWallet entities, A, B, C, and D present bids to the person, each with either an incentive for choosing that entity or with a discount off the Dell-quoted price. The person chooses entity C, e.g., by pressing a button on the phone and/or by saying the choice verbally, and the transaction is finalized, via the bid computer app and/or other suitable apps, either on the phone, on a server, or both. In place are the necessary arrangements and agreements between the eWallet entities and Dell. In one aspect, Dell has the option to match or exceed the eWallet offers and to present the Dell offer to the person.

In certain particular aspects, a method according to the present invention, and a corresponding computer app according to the present invention, provide a price guarantee for a transaction. The price guarantee is based on monitoring of multiple providers of a product or service chosen by a consumer in a first finalized transaction who pays a first purchase amount. In the event that that product or that service is the subject of a second later transaction done at a second purchase price lower than the first purchase price (a transaction noted during subsequent monitoring of completed later transactions with multiple providers of that same product or service), the consumer who has opted for price guarantee protection (which may involve downloading of a price guarantee app according to the present invention to a computer or to a mobile device of the consumer, e.g., but not limited to, phone or smartphone)—without any later action on the part of the consumer—receives, in a consumer-designated account, a money deposit or credit amount equal to the price difference between the first and second purchase prices. In another aspect, the consumer determines that a second later price has been paid that is lower than a first price and the consumer enters information regarding the second lower price. The second lower price is validated by the app and/or by a server in communication with the consumer's computer or device and a consumer-selected account is credited with the price difference. In one aspect, the consumer pays for the computer app that effects such a refund at the time of the first purchase or at a later time before the time of the second purchase. In one aspect, the price of the app is a percentage of the price difference. In another aspect, the consumer pays a flat periodic, monthly, or annual or multi-annual fee. In one aspect, the consumer pays for such price guarantee protection for a chosen time period, for a chosen geographic area, and/or for a chosen number of and/or for specifically identified multiple entities who provide the product or service. In one aspect, the computer app sends a notice and/or an email to the consumer regarding the money deposit (or deposit to credit account) resulting from activation and implementation of the price guarantee method.

In certain embodiments, each of several multiple bidders makes an offer to fund an account of a consumer (e.g., funding done according to any method according to the present invention disclosed herein for any account disclosed herein). Either the consumer chooses the bidder offering the largest funding amount, the consumer has already chosen that the bidder offering the largest amount is automatically chosen, or the consumer reviews the offers and selects one. A computer app effects the chosen funding upon completion of a transaction. In another embodiment, multiple bidders offer to fund different accounts of the consumer and the consumer reviews each offer and then chooses a bidder. In certain aspects, one, some or all of these bidders is an electronic wallet provider.

In certain aspects, the present invention provides an online system that enables a customer to complete a purchase based on a product offer identifier, e.g., in a promotional campaign or in offers delivered by coupons. Each customer is associated with a customer device, which accesses the online system via a communications network. A database contains customer records, merchant records and product offer records with one or more merchant offers. A product offer identifier is sent from a customer device, and the online system retrieves corresponding merchant offers. A description of the product offer, along with details of the merchant offers is sent back to the customer device. A user of the device selects a merchant offer, and the selection is sent back to the online system. The system is configured to complete a transaction whereby funds are transferred from a customer account to a selected merchant account, and the merchant is notified of the transaction. Based on the transaction—any basis disclosed herein—an account of the customer is funded (any account disclosed herein). In another aspect, each of the merchants is provided the opportunity to provide a bid for the product (in any bidding method described herein according to the present invention).

The present invention provides improvements to the subject matter of U.S. Published Application Pub. No. 20120166279, U.S. Ser. No. 13/331,693, including any suitable account funding method according to the present invention and/or the use of any bidding method according to the present invention. Such improved methods are new and nonobvious as compared to the cited pending application's subject matter and to the combination of it with the subject matter of any other patent, patents, application or applications referred to herein.

In certain aspects, the present invention provides a method for funding an account (any method according to the present invention for funding any account disclosed herein) and/or such a method using bidding according to any method according to the present invention, the method including steps for operating a server computer system to facilitate transactions between a plurality of merchants and a plurality of customers, wherein each customer is associated with at least one customer device in communication with the server computer system via a communications network, the method comprising the steps of: providing at least one database configured to contain customer records, merchant records and product offer records, wherein each customer record includes a unique customer identifier, and information identifying a customer payment account, each merchant record includes information identifying a merchant deposit account, and each product offer record includes a unique product offer identifier and a product description, and wherein each product offer record is associated in the database with one or more corresponding merchant offers, each of which comprises a product price associated with a corresponding merchant record; the server receiving from a customer device a customer identifier and a product offer identifier; the server retrieving from the database a product offer record corresponding with the product offer identifier, and transmitting the product description stored in the product offer record to the customer device; the server retrieving from the database one or more merchant offers associated with the retrieved product offer record and transmitting corresponding merchant details and the product price in each merchant offer to the customer device; the server receiving from the customer device a selection of one of the retrieved merchant offers; the server executing a transaction, including transferring funds to the merchant deposit account from the customer payment account corresponding with the customer identifier; and the server transmitting a notification message to the merchant system, including details of the executed transaction; and then effecting funding an account of the customer using any method disclosed herein; and/or in effecting the transaction, using any bidding method according to the present invention. Such a method may include one, some or a combination of the following: wherein the unique customer identifier comprises one or more of a telephone number, an email address, or a user name; including a step of the server transmitting messages comprising one or more product offer identifiers to at least one customer device, whereby the product offer identifier received from the customer device is selected by the customer from the messages; wherein the product offer identifier received from the customer device has been distributed in an online or offline promotional campaign, and has been input by a customer to the customer device for transmission; wherein the product offer identifier has been distributed in the form of one or more of a text code, a bar code, or a QR code; wherein each customer record further comprises one or more of the following items of customer information: customer delivery details; customer billing address; customer personal details, including one or more of age, gender, educational background or professional background; customer interests; or records of past customer purchases; wherein the database also contains records of customer requests for product offer information, records of customer selections of merchant offers, and records of transactions, and further with an administrative interface enabling authorised parties to access detailed records relating to purchases or promotional campaigns; and/or wherein the administrative interface comprises a web server configured to serve pages including graphical and/or numerical campaign analytics.

The present invention provides a server computer system comprising: at least one processor; persistent storage accessible to the processor comprising at least one database configured to contain customer records, merchant records and product offer records, wherein each customer record includes a unique customer identifier, and information identifying a customer payment account, each merchant record includes information identifying a merchant deposit account, and each product offer record includes a unique product offer identifier and a product description, and wherein each product offer record is associated in the database with one or more corresponding merchant offers, each of which comprises a product price associated with a corresponding merchant record; at least one network interface operatively associated with the processor and configured to communicate with a plurality of customer devices; and a memory operatively associated with the processor, wherein the memory comprises data and executable program instructions configured to cause the processor to execute a method for funding an account (any method according to the present invention for funding any account disclosed herein) and/or such a method using bidding according to any method according to the present invention, the method also including steps including steps of: receiving from a customer device a customer identifier and a product offer identifier; retrieving from the database a product offer record corresponding with the product offer identifier, and transmitting the product description stored in the product offer record to the customer device; retrieving from the database one or more merchant offers associated with the retrieved product offer records, and transmitting corresponding merchant details and the product price in each merchant offer to the customer device; receiving from the customer device a selection of one of the retrieved merchant offers; executing a transaction, including transferring funds to the merchant deposit account from the customer payment account identified in the customer record associated with the customer identifier; and transmitting a notification message, to the merchant system, including details of the executed transaction.

The present invention provides, in certain aspects, a method of operating a customer device in communication with a server computer system which is configured to facilitate transactions between a plurality of merchants and a plurality of customers, wherein the server computer system is associated with at least one database configured to contain customer records, merchant records and product offer records, wherein each customer record includes a unique customer identifier, and information identifying a customer payment account, each merchant record includes information identifying a Merchant deposit account, and each product offer record includes a unique product offer identifier and a product description, and wherein each product offer record is associated in the database with one or more corresponding merchant offers, each of which comprises a product price associated with a corresponding merchant record; wherein the customer device operation and/or a computer server operation method includes: funding an account (any method according to the present invention for funding any account disclosed herein) and/or such a method using bidding according to any method according to the present invention, the method including steps for the customer device receiving an input including a product offer identifier; the customer device transmitting to the server computer system a customer identifier associated with a user of the customer device, and the product offer identifier; the customer device receiving from the server computer system a product description, and displaying the product description on a device display; the customer device receiving from the server computer system details of one or more merchants associated with the product offer, and corresponding product prices, and displaying merchant details and prices on the device display; the customer device receiving a selection of one of the displayed merchant offers, and transmitting the selection to the server computer system, whereby the server computer system is able to execute a transaction, including transferring funds to the merchant deposit account from the customer payment account associated with the customer identifier and to transmit a notification message to a corresponding merchant system including details of the executed transaction, and, in certain aspects, the server funding an account of the customer (any method according to the present invention for funding any account disclosed herein) and/or such a method using bidding according to any method according to the present invention, the method including steps for effecting such method.

The present invention provides a computer program product comprising a tangible computer-readable medium having stored thereon computer-executable instructions which, when executed on a customer device, cause the customer device to implement a method as described in either of the two preceding paragraphs; and, in one aspect, wherein the tangible computer-readable medium is operatively associated with a network-connected server, and the computer-executable instructions comprise one or more files available for download via the network, and configured to install the computer-executable instructions on the customer device.

In certain aspects, in such a method, the customer may simply enter a product offer identifier, such as a numeric or alphanumeric code, and will receive back in reply the relevant details of one or more merchants which are able to supply the selected product, along with corresponding prices, including any discount associated with a product offer. In certain aspects, from the customer's perspective, selection of a single preferred merchant enables a transaction to be completed via the server system, and notification provided to the merchant, such that the selected product will be purchased and delivered with substantially reduced effort on the part of the customer. In certain aspects, the system may be used for online promotions, in which messages containing product offers, with associated product offer identifiers, may be sent electronically to a customer device, for example via email, SMS message, MMS message, or other messaging protocol. The system may also be used to facilitate the implementation of offline promotional campaigns, in which the product offers are advertised via conventional means, such as in print advertisements, clippable coupon books, and the like. A product offer identifier, in the form of a short numeric or alphanumeric code, a barcode, or a two-dimensional QR code, may be included in the printed promotion. Machine-readable codes, such as barcodes or QR codes, may be scanned directly using a customer mobile device, such as a smart phone, or similar, equipped with a camera. Application software executing on a smart phone, or similar device, is able to decode such information, and pass the decoded identifiers to other applications, such as a web browser, or a dedicated e-commerce application, for use in transmitting a customer request to purchase the offer product.

In some embodiments, a dedicated application (e.g., but not limited to, computer application, CAMATTPI as in FIG. 1, or “app”) is developed and provided for execution on portable devices, such as those running Apple's iOS, or Google's Android operating systems, to facilitate customer interaction with the server computer system. Alternatively, product offer identifiers may be transmitted to the server computer system via SMS, or a simple web interface. For example, in a web-based implementation, suitable for use via a range of customer devices supporting browser software, the customer may be required only to log in and enter a product offer identifier in order to be guided simply through the remainder of the offer and purchase process.

In certain embodiments of the invention a single access point facilitates sending product offers to prospective customers via their mobile devices, and accepting and completing corresponding purchase transactions. Both merchants and prospective customers may register with a single service provider, and their details are stored in the database. Customer records may contain all of the information necessary to deliver product offers to customers, and in particular the unique customer device identification number may be a telephone number enabling offers to be sent via SMS or MMS messaging. For customers with smart phones or similar mobile devices, product offers may alternatively be delivered via specialised applications.

In certain aspects a system for facilitating transactions between merchants and customers, in accordance with an embodiment of the invention, employing an account-funding method according to the present invention and/or a bidding method according to the present invention includes a management platform and a messaging platform. In one implementation, the management platform may comprise a server cluster, while the messaging platform may comprise one or more additional server computers. Alternatively, the platforms may be implemented on a single local or distributed server system. The system may be implemented in a variety of different hardware environments, employing one or more server computers, each of which may comprise one or more microprocessors. In an embodiment, for example, the system may be implemented principally via a ‘cloud computing’ platform, which advantageously enables a high level of scalability, while enabling the operator to avoid purchasing the significant dedicated resources necessary to handle peak loads. As such, the specific embodiments described herein, are exemplary only, and not limiting of the scope of the invention. In some embodiments the messaging platform and the management platform may be wholly operated by a single service provider. However, in alternative embodiments, the messaging platform may communicate with a third party provider, different from the operators of the system. In particular, for SMS and MMS messaging, a number of existing providers offer messaging services accessible, for example, via a web based API.

In certain aspects, prospective customers are able to access the system using mobile devices, such as GSM cellular mobile telephones, or smart phones. Messages may be sent from the messaging platform to customer devices via the mobile telephony network, and in particular through any mobile service provider to which the customer happens to subscribe. Messages may be conveniently delivered to a wide range of devices via SMS or MMS, however it is also possible to deliver messages from the messaging platform via IP-based services over GPRS, WAP and 3G networks. These latter technologies are applicable in the case of smartphone handsets, and similar devices, which may be provided with specialised applications for receiving and displaying message content. IP-based access may also be via other Internet-connected devices, such as desktop or laptop computers.

Merchant systems are also able to access the management platform, for example via the internet. The management platform is also able to access electronic transaction services, including customer-nominated accounts, using the services of one or more financial institutions.

In certain aspects, the management platform 104 comprises one or more server computers, each of which includes at least one microprocessor. For simplicity, in much of the following description, it is assumed that the exemplary management platform 104 includes a single computer with a single microprocessor. However, as indicated above, in a large-scale implementation it is envisaged that the system will be implemented via a cloud computing platform, or other server farm. The microprocessor is interfaced to, or otherwise operably associated with, a non-volatile memory/storage device which may be a hard-disk drive, and/or may include a solid state non-volatile memory, such as read-only memory (ROM), flash memory, or the like. The microprocessor is also interfaced to volatile storage, such as random access memory (RAM), which contains program instructions and transient data relating to the operation of the platform. In a conventional configuration, the storage device maintains known program and data content relevant to the normal operation of the computer system. For example, the storage device may contain operating system programs and data, as well as other executable application software necessary to the intended functions of the management platform. In one embodiment shown, the storage device also contains program instructions which, when executed by the processor, enable the server computer to perform operations relating to the provision of a mobile marketing and purchasing system embodying the invention.

The microprocessor is also operably associated with a network interface, e.g. in a conventional manner. The network interface facilitates access to one or more data communications networks, such as the Internet, which may be used, for example, to communicate with merchant system and financial institutions.

A further communications interface enables the management platform to communicate with the messaging platform. Either a separate interface is used, or in an alternative embodiment the management platform may communicate with the messaging platform via the internet, for example by using the same network interface as is employed for other Internet communications. In still further embodiments, the management platform and the messaging platform may be implemented within a single server, communicating via internal system services, such as inter-process communications.

In one embodiment, the messaging platform is a separate server computer receiving requests from the management platform via a communications interface, which is operably associated with a microprocessor. The messaging platform includes its own volatile storage, containing program instructions and transient data relating to the operation of the messaging platform. The messaging platform may also include its own non-volatile storage, if required for long term storage of programs and data. A further communications interface is operably associated with the microprocessor, which provides access to public telecommunications networks for the delivery of messages to mobile customer devices.

In use, the volatile storage of the management and messaging platforms include corresponding bodies of program instructions, configured to perform processing and operations embodying methods and/or features of the present invention.

The present invention provides, in certain aspects, a computer-readable media storing a program for causing a computer to perform a method comprising: any method disclosed in the preceding paragraphs embodying and/or involving account funding, bidding by more than one, two, three, four, or more than four multiple bidders, and/or any price guarantee method of the present invention. The present invention provides, in certain aspects, a computer application or “app” for effecting the method according to the present invention; and, in one aspect, it is an app such as a CAMAATTPI as in FIGS. 1 and 2. above.

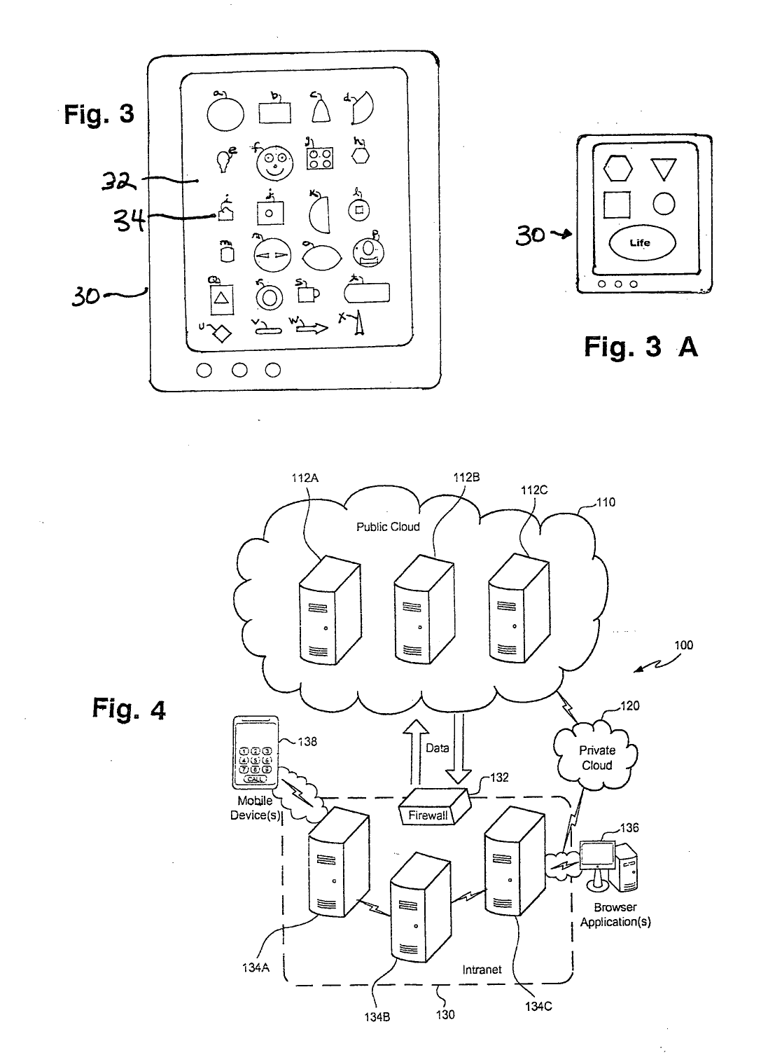

FIG. 3 shows a personal device 30 (e.g., any computerized personal device discussed herein) with a plurality of touch screen icons 34 (icons a-x) displayed on a screen 32. Each icon can be used to choose a method, sub-method, computer app, or choice of a method according to the present invention. FIG. 3A shows a personal device 31 (e.g., any computerized personal device discussed herein) with a plurality of touch screen icons (five icons, each with a different shape) displayed on a screen 33. Each icon can be used to choose a method, sub-method, computer app, or choice of a method according to the present invention.

The present invention provides new and nonobvious improvements to the subject matter of U.S. Applications Publication Nos. 2012/0297184; 2012/0297311; and 2012/0297406; including, but not limited to, employing a computer application according to the present invention, or applications, on any computer, personal device, server, computer system, and/or network in any of the systems, devices, and/or networks of these patent applications.

The provision of computing resources on an as-needed basis via publically accessible computer networks is often referred to as “cloud computing” in which resources are deployed, operated and maintained by third parties in a computer network or “cloud” and users can use these “cloud computing” resources without relying on locally installed computer applications.

In certain embodiments of the present invention any computer application according to the present invention or one step or some steps of such an application is in a pubic portion of a computer network and is used in a system that includes the computer network, the network having an on-premises portion, the system including a database storing information, and a user device connected with the computer network. The user device accesses a computer application (or part thereof) hosted in the public portion of the network. In response to the user device accessing the computer application, the application generates return information (e.g., any information provided by any method and by any computer application herein according to the present invention). In one aspect, the user device then receives the return information and generates a request for data (pubic or private) based on all or based on at least a portion of the returned information and then the request is transmitted to the database which generates a response including the requested data. Optionally, the response is transmitted in an encrypted form from the database via the computer network to the user device. Optionally, there is a firewall separating a public portion of the computer network from an on-premises portion of the computer network and the database is a database storing private data behind the firewall.

In certain embodiments, the present invention provides a method and corresponding computer application, the method of using a “cloud computing” version of the application within a computer network environment, said method including the steps of: storing data (private and/or public) in a database included in an on-premises portion of the computer network, wherein the on-premises portion is optionally behind a firewall separating the on-premises portion of the computer network from a public portion of the computer network; accessing with a user device (e.g., any personal device described or referred to herein) connected with the computer network a computer application (any disclosed herein) hosted by one or more computer hardware platforms included in the public portion of the computer network; receiving at the user device return information from the application; transmitting a request for data (private and/or public) from the user device through the public portion of the computer network to the database of the on-premises portion of the computer network, wherein the request for data is based on at least a portion of the returned information; retrieving the requested data from the database in response to the request; transmitting the retrieved data, optionally in an encrypted form, via the public portion of the computer network to the user device. Optionally in such a method the of accessing with a user device comprises operating a mobile handheld device connected to the computer network via at least one of a Wi-Fi network connection, a cellular telephone network connection and a satellite network connection. Optionally, is any such method, in the step of accessing with a user device, the user device is connected with a private portion or with a private portion of the computer network. Any such method may include any of the aspects, elements, and/or further steps as adjusted and/or modified for methods according to the present invention, as disclosed in U.S. Patent Application Pub. No. 2012/0297184, including, but not limited to, those aspects, features, and/or steps as defined in claims 2-10 of said application.

The present invention provides, in some embodiments, a computer network system integrating secure data with public “cloud computing” capability, the system including: a public portion of the network and a private portion of the network, an optional firewall separating a public portion of the computer network from an on-premises portion of the computer network; a database storing data, (public and/or private) wherein the database is included in the on-premises portion and. Optionally is behind the firewall; and a user device connected with the computer network, the user device being configured to access a public cloud application hosted by one or more computer hardware platforms included in the public portion of the computer network, the public cloud application being a computer application according to the present invention (any described herein) wherein the public cloud application is configured to generate return information after being accessed by the user device; the user device being further configured to receive the return information and generate a request based on all or on at least a portion of the returned information, wherein the request is transmitted through the public portion of the computer network to the database of the on-premises portion of the computer network; and the database being configured to generate a response including the requested data, wherein the response is transmitted, optionally in an encrypted form, from the database via the public portion of the computer network to the user device. Any such system may include any of the aspects, elements, and/or further features as adjusted and/or modified for methods according to the present invention, as disclosed in U.S. Patent Application Pub. No. 2012/0297184, including, but not limited to, those aspects, features, and/or steps as defined in claims 12-20 of the application.

In any system and method herein, a user device may, for example, be connected with a public portion of a network, or it may, for example, be connected with a private portion of a computer network. As used herein, ‘connected’ or ‘connection’ does not necessarily imply that a first element (e.g., the user device) is physically connected (e.g. by a cable or the like) with a second element (e.g., the computer network), but rather that data and/or signals may be transmitted between the first and second elements. Such connection may be facilitated by a cable, a wireless transceiver, or any other suitable means.

As illustrated in FIG. 4, a computer network system 100 according to the present includes a public cloud portion 110 of the network, a private cloud portion 120 of the network, and, optionally, an on-premises portion 130 of the network. The public cloud portion 110, the private cloud portion 120 and the on-premises portion 130 may be in communication with one another via a publicly available computer network such as, for example, the Internet. Any cloud portion may include, provide for downloading and installation on a personal device, and/or provide access to, a computer app (any disclosed herein) according to the present invention.

The public cloud 110 includes various applications provided by one or more computer hardware platforms such as, for example, but not limited to, a computer hardware platform 112A providing Windows Azure, a computer hardware platform 112B providing Amazon Web Services, and a computer hardware platform 112C providing the Google App Engine and/or one, two, three, four or more computer applications according to the present invention. Although FIG. 4 shows three public cloud 110 computer hardware platforms 112A-12C, there may be fewer or more computer hardware platforms in the public cloud 110 providing various public cloud applications and/or application(s) according to the present invention that are included in the system 100. The private cloud 120 may be interconnected for communication with the public cloud 110 and the on-premises portion 130. The private cloud 120 may also include one or more applications provided by one or more computer hardware platforms (not shown) and/or a computer application or applications according to the present invention. Private cloud 120 applications may only be accessible to authorized users via password requirements and/or other user authentication processes.

The on-premises portion 130 may include an optional firewall 132 and one or more computer hardware platforms 134A-134C. The computer hardware platforms 134A-134C of the on-premises portion 130 may be in communication with one another and with an optional firewall 132 via a private computer network such as an intranet. One or more of the computer hardware platforms 134A-134C of the on-premises portion 130 may also be in communication with one or more user computing devices 136 (e.g. any personal device disclosed herein, e.g., a smartphone or desktop and laptop computers and the like) and one or more user mobile devices 138 (e.g., any personal device disclosed herein, e.g., smartphone, cellular phone, tablet computer, netbook, notebook, laptop, pad computing devices, personal digital assistants, and the like). In this regard, a service-oriented architecture (SOA) integration framework may be used to leverage Wi-Fi and Wi-Fi networks, e.g. 3 and 4 G networks, to extend cloud application reach to mobile and wireless devices.

Also, the various processes, devices, components and the like disclosed herein may be in the form of any appropriate combination of hardware, software, middleware, firmware and/or the like operable to carry out the various functionalities disclosed herein. For instance, such software, middleware and/or firmware may be implemented as one or more computer program products, i.e., one or more modules of computer program instructions encoded on a computer-readable medium for execution by one or more processors or processing modules, or to control the operation of, one or more data processing apparatuses. For example, an on-premises database, and an application fabric service bus, may be provided in such computer-readable medium and executed by a processor or the like. The computer-readable medium can be a machine-readable storage device (e.g., a memory module), a machine-readable storage substrate, a memory device, a composition of matter affecting a machine-readable propagated signal, or a combination of one or more of them. In addition to hardware, code that creates an execution environment for the computer program in question, e.g., code that constitutes processor firmware, a protocol stack, a database management system, an operating system, or a combination of one or more of them may be involved.

A computer program (also known as a program, software, software application, app, script, or code) used according to the present invention, e.g. to provide functionality described herein, may be written in any form of programming language, including compiled or interpreted languages, and may be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules sub-programs, or portions of code). A computer program can be deployed to be executed on one computer or on multiple computers that are located at one site or distributed across multiple sites and interconnected by an information flow network.

Block diagrams, processes, protocols and logic flows described in this specification can be performed by one or more programmable processors executing one or more computer programs to perform functions by operating on input data and generating output. The processes and logic flows can also be performed by, and apparatuses can also be implemented as, special purpose logic circuitry, e.g., an FPGA (field programmable gate array) or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Generally, the elements of a computer are a processor for performing instructions and one or more memory devices for storing instructions and data. The techniques described herein may be implemented by a computer system configured to provide the functionality described.

In some embodiments, the network system 100 (or any system herein according to the present invention) may include one or more of various types of devices, including, but not limited to a personal computer system, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, or, in general, any type of computing or electronic device. Often typically, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, Global Positioning System (GPS) receiver, a digital camera, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry. To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

In certain aspects, the present invention provides systems and methods for providing a user with virtual computing services using computer applications(s) according to the present invention. In one embodiment, a method according to the present invention for providing virtual computing services to a specific user, may include: detecting a request generated from a user device of the specific user to access information and/or data; in which the information and/or data is not accessible by applications installed on the user device; identifying a file type of the information and/or data; and providing the specific user access to a remote application (e.g., one according to the present invention) or a virtual desktop, in which the remote application or the virtual desktop is configured to allow the specific user to open, execute, edit, and/or access the information and/or data.

The present invention provides new and nonobvious improvements to the subject matter disclosed in U.S. Patent Application Pub. No. 2012/0297311, incorporated fully herein for all purposes. In certain aspects, in such a method, the present invention provides a computer-implemented method of providing virtual computing services to a specific user, the method including: detecting a request generated from a user device to access information and/or data; wherein, optionally, the information and/or data is not accessible by application(s) installed on the user device, or it is; identifying a file type of the information and/or data; providing the specific user access to a virtual desktop, wherein the virtual desktop includes a plurality of running sessions; and when the specific user logs onto the system, assigning the specific user a specific running session of the plurality of running sessions; wherein the specific running session is configured to provide options for the specific user to open, execute, edit, and/or access the information and/or data. Optionally, in any such method, the user device is a device having a browser and/or internet connect, the device including a personal digital assistant, a smart phone, a tablet, a Mac/Window laptop, a Linux machine, a netbook, and/or a cloudbook. Optionally, in any such computer-implemented method the specific running session is configured to be accessed via the browser or a locally installed application on the user device.

Embodiments of the present disclosure include systems and methods for providing a remote application and/or a virtual computing service that streams a desktop over the Internet to a remote user's internet connected device. The system enables users to run and on demand use software applications (including any according to the present invention) through the remote application and/or the virtual computing service. The system enables users to create, store, access, and/or edit information and/or data at any computing device using the remote application and/or the virtual computing service. Network-based (e.g., Internet based) computing, such as the systems and methods described herein, transfers information and/or data, applications, and processing power to a central grid of servers, often accessed via the Internet. In some embodiments, the central grid of servers may provide a remote application to a user's computing device over the Internet, such as via a streamed application presented to the user's computing device. In some embodiments, the central grid of servers creates a remote virtual computing service that streams information and/or data to user computing devices over the Internet, such as via a streamed desktop presented to a user's computing device. The central servers store user data created with streamed desktops and supplies processing power for user computing devices. In some cases, the system manages operations of the user computing devices via a central virtual computing service. The user computing devices may not require high performance hardware, they may be old hardware, “thin-clients” or “dumb terminals” that have sufficient power and resources required to simply connect to the internet to access the virtual computing service (such as from a grid environment).

The virtual computing service may receive numerous data requests and undergo large processing demands. Thus, the virtual computing service may include several servers that are interconnected and optionally load balanced to form a “grid” of computing devices capable of handling such processing demands. These servers may be placed at various locations and controlled by a central grid that determines when and where to retrieve aspects of the virtual computing service when requested by a user device.

In some examples of the technology (i.e., in some embodiments of the present invention), the system provides some or all of the functionality described herein via simple web hosting. For example, the system establishes an account for a user and provides a unique URL to the user. The system creates a web publishing folder on a virtual desktop related to the user and located within the virtual computing service and links the web publishing folder with the unique URL. The system stores files or content received from the user into the web publishing folder. The user may access the files and content using the unique URL, and may also permit others to access the folder via the unique URL. Thus, the system provides a virtual desktop that may be accessed and/or shared by multiple users.

In some embodiments, the system enables a user to access/open/read/edit a file stored on the user's computing devices via a central grid of servers by right-clicking the file. The file may be streamed or transferred from the user's computing devices to the central grid of servers. The central grid of servers is configured to allow the user to access/open/read/edit the file. The changes to the file or the entire updated file may be streamed or transferred back to the user's computing devices. In some implementations, the changes are synchronized automatically between the user's computing device and the central grid of servers. In some implementations, the user may initiate file synchronization by performing a drag-and-drop action of the file between the user's computing device and the central grid of servers.

In some embodiments, the system enables a user to access/open/read/edit a file stored on one or more remote storages via a central grid of servers by right-clicking the file. The file may be streamed or transferred from the one or more remote storages to the central grid of servers. The central grid of servers is configured to allow the user to access/open/read/edit the file. The changes to the file or the entire updated file may be streamed or transferred back to the one or more remote storages. In some implementations, the central grid of servers may be an online application provider.

In some embodiments, the system enables a user to access/open/read/edit information and/or data stored on the user's computing devices via a central grid of servers, in which the data is not openable, executable, editable, or accessible by applications installed on the user's computing devices. The central grid of servers may be configured to identify a remote application (e.g., one according to the present invention) to open, execute, edit, and/or access the information and/or data, and determine whether to provide the remote application for use by the computing devices when the computing device is offline. When offline usage is not provided to the computing devices, portions of the remote application may be streamed to the user's computing devices used to open, execute, edit, and/or access the information and/or data. When offline usage is provided to the computing devices, the remote application in whole may be streamed to the user's computing devices used to open, execute, edit, and/or access the information and/or data.

In some examples of the technology, the system is configured to provide users a virtual desktop. The virtual desktop may comprise a plurality of existing running sessions. In some implementations, the running sessions are generic sessions of Windows running in the virtual desktop. When a user logs into the virtual desktop, the system may be configured to assign the user an existing running session in the virtual desktop. The user may open, execute, edit, and/or access the information and/or data in the assigned running session of the virtual desktop as if the running session originated from the user's devices. In some implementations, the changes to the information and/or data may be synchronized automatically between the virtual desktop, the user's devices, and/or one or more remote storages of the user. In some implementations, the user may initiate data synchronization by performing a drag-and-drop action of the data between the virtual desktop, the user's devices, and/or one or more remote storages.

In some examples of the technology (and in this sense “technology” herein is subject matter according to the present invention and particular “technology” is a particular embodiment of the present invention, including any “technology” referred to above or below), the system may be configured to provide a virtual desktop to a user through a browser (e.g., a browser using HTML5 or Flash) or a remote application installed on the user's devices. In some implementations, the user may open information and/or data through the web interface of the browser. The data may be stored in the user's devices and/or one or more remote storages. In some implementations, the one or more remote storages include, but not limited to, a third party storage, such as Dropbox and Google Drive, etc.

In some implementations, the user may open information and/or data through a virtual desktop by launching a remote application (e.g., one according to the present invention) installed on the user's devices. The virtual desktop may be configured to allow the user to access/open/read/edit data, in which the data is not openable, executable, editable, or accessible by applications installed on the user's devices.

In some examples of the technology, the system enables users to access virtual computing services via small or hand-held computing devices, such as personal digital assistants, smart phones, tablets, etc., Mac/Window laptops, Linux machines, netbooks, cloudbooks, or any device having a browser and/or internet connection. In some cases, these devices act as simple connection or access devices and may contain ports that receive peripheral devices, such as power supply devices, monitors or other display devices, mice, keyboards, modems and other devices that provide a network such as the Internet. These devices may automatically connect the user to the virtual computing service, or may connect to the virtual computing service upon receiving a request from a user.

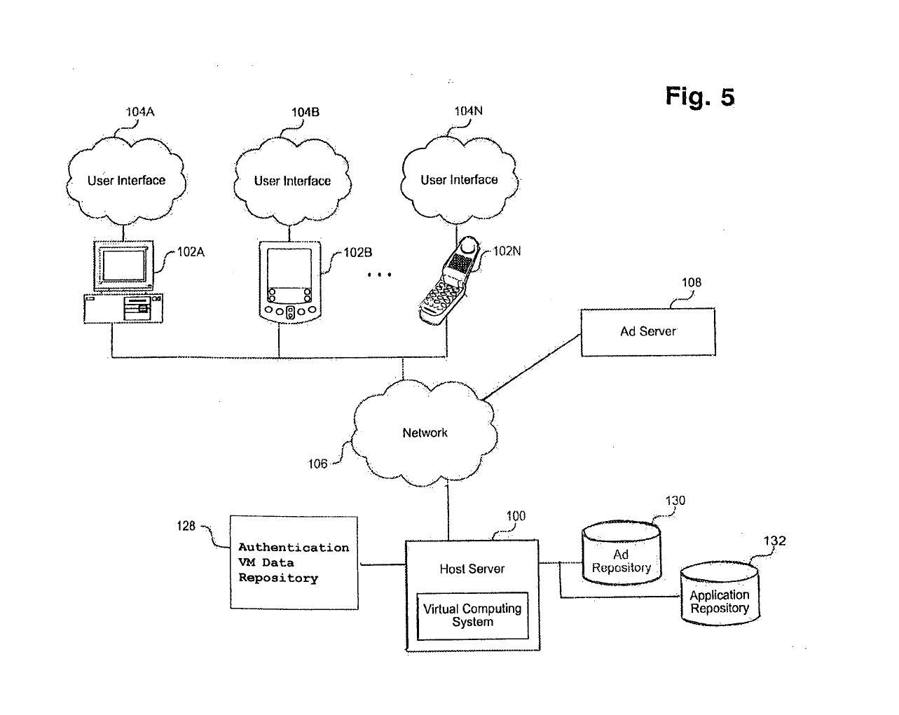

FIG. 5 illustrates a block diagram of personal devices (or client devices) 102A-N and a server 108 coupled to an example of a host server 100 (remote server) that provides virtual computing to the personal devices 102A-N through a network 106. The personal devices 102A-N can be any system and/or device, and/or any combination of devices/systems that is able to establish a connection with another device, a server and/or other systems. The devices 102A-N typically include display or other output functionalities to present data exchanged between the devices to a user. For example, the devices and content providers can be, but are not limited to, a server desktop, a desktop computer, a thin-client device, an Internet kiosk, a computer cluster, a mobile computing device such as a notebook, a laptop computer, a handheld computer, a mobile phone, a smart phone, a PDA, a Blackberry device, a Treo, an iPhone, etc. (as is true for any embodiment of the present invention). In one embodiment, the devices 102A-N are coupled to the network 106. In some embodiments, the devices may be directly connected to one another.

In one embodiment, the devices 102 can interact with a virtual computing environment (e.g., a virtual computing environment provided by the virtual computing system hosted by the server 100). The virtual computing system in the server 100 can include one or more computing systems that host one or more virtual computing environments.

Different user devices 102 may be assigned to different virtual environments. Access to the virtual environments may be user-specific and/or device specific. In some instances, users or devices use accounts to access a virtual computing environment which may be user-customized or device-customized.

The user devices 102 can interact with a virtual computing environment that is hosted remotely to access computing services including but not limited to, remote storage, backup, and/or synchronization services. In addition, user devices 102 can access software/applications (including, but not limited to, those according to the present invention) available in the virtual computing environment. For example, a user device 102 may use software/applications (e.g. any app according to the present invention) installed remotely in the virtual computing environment on a remote host to access/open/read/edit content (e.g., streamed content) or files locally stored. The locally stored content/files can be sent in part or in whole to the virtual computing environment for access by the remote application. Alternatively, the remote application can be streamed and/or cached in part and/or downloaded in whole by the user device 102 such that the content/file can be executed or otherwise accessed on the user device 102.

The network 106, over which the devices 102A-N may be a telephonic network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the personal device(s), host server, and may appear as one or more networks to the serviced systems and devices. In one embodiment, communications to and from the devices 102A-N can be achieved by, an open network, such as the Internet, or a private network, such as an intranet and/or the extranet. In one embodiment, communications can be achieved by a secure communications protocol, such as secure sockets layer (SSL), or transport layer security (TLS).

The term “Internet” refers to a network of networks that uses certain protocols, such as the TCP/IP protocol and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art. For illustrative purposes, it is assumed the network 106 broadly includes anything from a minimalist coupling of the components illustrated in the example of FIG. 5, to every component of the Internet and networks coupled to the Internet.

In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols (as is true for any embodiment of the present invention).

The devices 102A-N can be coupled to the network (e.g., Internet) via a dial up connection, a digital subscriber loop (DSL, ADSL), cable modem, and/or other types of connection. Thus, the devices 102A-N can communicate with remote servers (e.g., web server, host server, mail server, and instant messaging server) that provide access to user interfaces of the World Wide Web via a web browser, for example.

An authentication/VM data repository 128, a repository 130, and an application repository 132 can store software (including computer applications or application according to the present invention), descriptive data, images, system information, drivers, and/or any other data item utilized by parts of the host server 100 for operation. The repositories may also store user information and user content, such as, user profile information, user preferences, content information, network information, etc. The repositories may be managed by a database management system (DBMS), for example but not limited to, Oracle, DB2, Microsoft Access, Microsoft SQL Server, PostgreSQL, MySQL, FileMaker, etc. The ad repository 130 may additionally store information and/or advertisements and the application repository 132 may store software programs/applications executable by the host server 100 in one or more virtual computing environments or remotely accessible by a user device 102. In some implementations, the ad repository 130 may be, not limited to, a third party service provided by an established information provider or advertisement network.

The repositories can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (OODBMS) (e.g., Informix, OpenLink Virtuoso, VMDS, etc.), a file system, and/or any other convenient or known database management package. In addition, the host server 100 is able to retrieve data from the authentication/VM data repository 128, ad repository 130, and/or application repository 132.

The host server 100 can be implemented on a known or convenient computer system. The host server 200 can provide a personal device with computing services, e.g., but not limited to, as in U.S. Patent Application Pub. No. 2012/0297311.

As used herein an “engine” or “system” can include a dedicated or shared processor and, typically, firmware or software modules that are executed by the processor. Depending upon implementation-specific or other considerations, an engine or system can be centralized or its functionality distributed. An engine or system can include special purpose hardware, firmware, or software embodied in a computer-readable medium for execution by the processor. Limited to the U.S. and to any other jurisdiction that has similar restrictions and/or legal limitations, a “computer-readable medium+ can include all mediums that are statutory (e.g., in the United States, under 35 U.S.C. 101), and to specifically exclude all mediums that are non-statutory in nature to the extent that the exclusion is necessary for a claim that includes the computer-readable medium to be patentable. Known statutory computer-readable mediums include hardware (e.g., registers, random access memory (RAM), non-volatile (NV) storage, to name a few), but may or may not be limited to hardware.

In general, if a user uses multiple devices (e.g., a laptop, a smart phone, a desktop), content on each of the multiple devices can be synchronized on a remote storage, e.g., on a host server such that the user can access content stored on different devices through a single device when connected to the host server.

Software (e.g., computer apps) useful in implementing the present invention is typically stored in the non-volatile memory and/or the drive unit. For large programs, it may not even be possible to store the entire program in the memory. Nevertheless, it should be understood that for software to run, if necessary, it is moved to a computer readable location appropriate for processing, and for illustrative purposes, that location is referred to as the memory. Even when software is moved to the memory for execution, the processor can typically make use of hardware registers to store values associated with the software, and local cache that, ideally, serves to speed up execution. As used herein, a software program or app is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

While the machine-readable medium or machine-readable storage medium may be in an exemplary embodiment a single medium, the terms “machine-readable medium” and “machine-readable storage medium” should be taken to include a single medium or multiple media (e.g., a centralized or distributed database, and/or associated caches and servers) that store the one or more sets of instructions. The terms “machine-readable medium” and “machine-readable storage medium” shall also be taken to include any medium that is capable of storing, encoding, or carrying a set of instructions for execution by the machine, and that cause the machine to perform any one or more of the methodologies of the presently disclosed methods, step(s), technique and/or innovation.

In general, the routines executed to implement the embodiments of the disclosure may be implemented as part of an operating system or a specific application or app, component, program, object, module, or sequence of instructions referred to as “computer programs.” The computer programs typically are one or more instructions set at various times in various memory and storage devices in a computer, and that, when read and executed by one or more processing units or processors in a computer, cause the computer to perform operations to execute elements involving the various aspects of the disclosure.

Any patents and patent applications and other references referred to or noted herein, are incorporated fully herein by reference. Aspects of the disclosure can be modified, if necessary, to employ the systems, functions, and concepts of the various references described above to provide yet further embodiments of the present invention.

The present invention provides systems, methods, and corresponding computer applications for delivering requested information (“information” including: any information provided by any method or app herein according to the present invention regarding pregnancy, abortion, a business entity, or a particular person; information about personalized services, targeted services, and/or personalized targeted advertisements), such a system in at least some aspects including: a central server providing a one or more services to a user's device and/or premises over a communication network with a gateway, e.g., a gateway, receiving the information and/or one or more services from a central server and accessing information and/or one or more targeted advertisements thereby delivering the information and/or one or more services, optionally with one or more targeted advertisements, to a user's device and/or premises device or appliance. Such a method may use, and such a system may include a computer application according to the present invention, or applications, on the user's device supplied by a primary service provider that executes on the user device interacting with the central server and/or home gateway. A user device and/or appliance can be selected printers, smartphones, tablet computers, desktop computers, laptop computers, televisions, media players, gaming systems, security cameras, energy management devices, home appliances, and combinations thereof—as is true for any personal device in any method and computer app according to the present invention.

Within the embodiments described herein, above and below, one exemplary system for providing information, delivering personalized targeted services, and/or personalized targeted advertisements (collectively “information”) is disclosed below. The system includes central server providing one or more services to a user premises over a communication network. Further, the system includes a user gateway receiving the one or more services from a central server and accessing information thereby delivering the information to a user premises device or appliance. Optionally, the system includes one or more set-top boxes receiving information and delivered to a user premises device or appliance, and, optionally, having one or more set-top box software applications supplied by a primary service provider that execute on each set-top box interacting with the central server and gateway. A set-top box can be either an IP set-top box or a legacy set-top box.

Embodiments of the present disclosure, using a method and/or computer application according to the present invention, can allow primary service providers (e.g., service providers that own, deploy and maintain the equipment) to provide different information, data, services, and/or sets of services to users by using devices such as a central server, gateway, and/or set-top box embodiments, e.g., as described in the present disclosure. The information and/or different sets of services are provided either by the primary service provider (e.g. primary services) itself or by secondary service providers (e.g. secondary services that use the primary service provider's network to access a user's premises). In the case of providing secondary services, a primary service provider can relay or facilitate a secondary service from its provider to the user through a central server. Both primary services and secondary services can be provided to a gateway on a user device and/or at user premises. The gateway may then relay or facilitate information and/or services to one or more devices and/or set-tops deployed in different locations within the user premises and/or remote therefrom.

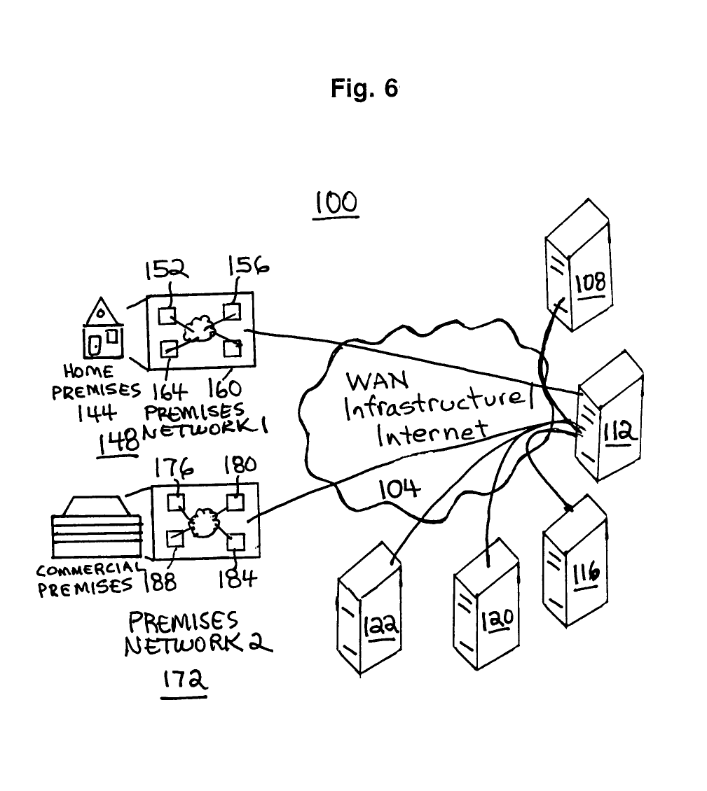

FIG. 6 shows exemplary network architecture 100 providing multiple services to premises over communication networks for use with methods and/or computer apps according to the present invention. The network architecture 100 may include a wide area network (WAN) infrastructure 104 that provides network connectivity over the Internet using communications links between a primary service provider's server (e.g. primary server) 112 and one or more secondary service provider servers (e.g. secondary servers) (108, 116, 120, and 122). A wide area network may be network of nodes or computers whose communication links spans a broad area including crossing metropolitan, regional, national, and continental, political and geographic boundaries. Examples of wide area networks may include the Internet, wireless wide area communication networks, metropolitan area network, cellular networks, and WiMAX networks. The Wide Area Network Infrastructure 104 may include network elements or nodes that facilitate network connectivity between terminal network devices and servers (e.g. primary server, secondary servers, etc.) as shown by the network architecture 100 in FIG. 6. Examples of such network elements or nodes include routers, switches, multiplexers, servers, etc. Communication links between network elements and nodes that are part of the WAN infrastructure such as the communication links between the secondary servers (108, 116, 120, and 122) and the primary server 112 may incorporate packet switching technology, circuit switching technology, or a combination of both. Each of the servers (108, 112, 116, 120, and 122) may be a called a central Server or central server as described in the present disclosure. In addition to providing network connectivity between the primary server 112 and the secondary servers (108, 116, 120, and 122), the WAN infrastructure 104 can provide network connectivity between the primary server and one or more gateways (160 and 184), premises gateways or home gateways.

Although FIG. 6 shows the primary server 112 connected to two home gateways (160 and 184), persons of ordinary skill in the art would recognize that the primary server may be connected to additional (home or user premises) gateways. As with the other communication in FIG. 6, the communication links between the gateways (160 and 184) and the primary server 112 may incorporate packet switching technology, circuit switching technology, or a combination of both. Further, the exemplary network 100 shows that secondary servers may communicate to end point devices (152, 156, 164, 176, 180, and 188) (e.g. terminal devices) through the WAN infrastructure 104, the primary server 112, one or more gateways (160 and 184) and one or more premises networks (148 and 172). Each of the gateways (160 and 184) reside on user premises. One gateway 160 resides in a premises 144 and another gateway 184 resides in a business user premises 168. The user premises 144 may include a premises communication network 148 connecting the gateway 160 to multiple terminal network or end point devices (152, 156, and 164). Alternatively, the business user premises 168 may include a premises communication network 172 connecting the gateway 184 to multiple terminal network or end point devices (176, 180, and 188). The devices 164 and 188 may be any personal computer device disclosed herein. Further, each of the gateways may have multiple communication interfaces supporting different protocols (e.g. USB, Ethernet, Firewire, Bluetooth, WiFi, etc.). One communication interface on each of the gateways (160 and 184) may be connected to the WAN Infrastructure 104. Another communication interface may be connected to their respective premises networks (148 and 172).

In one particular embodiment of a method according to the present invention, multiple entities bid for a consumer to choose a particular electronic wallet from a plurality of possible electronic wallets that can be used for a transaction. The multiple entities may be electronic wallet providers or entities that have a relationship with an electronic wallet provider. Once each potential transaction-winning entity has bid, each entity then has the chance to review all the bids and then to re-bid. Any or all entities can provide a second bid better than a first bid and/or better than another entity's first bid. The new bids are then presented to the consumer for choice of a particular electronic wallet of a particular entity for finalizing the transaction. In one aspect, the re-bid procedure may be used as many times as desired and/or as many times as any entity is willing to re-bid (i.e., more than only a second bid stage). Corresponding computer applications are provided for each such method described in this paragraph (as they are for every method according to the present invention). As in other methods according to the present invention in which multiple entities bid in an effort to be the chosen entity for effecting and finalizing a transaction (or in which multiple entities seek business), any entity in this method may bid based on price and/or incentives (incentives including, e.g., but not limited to, cash paid now, cash paid immediately at a point of transaction or at a point of sale, reward points, free or reduced shipping, favored country or government jurisdiction (e.g., re taxation, duties, fees, tariffs, etc.) for doing a transaction, award points, frequent flyer miles, doing a transaction with favored and/or best digital money, future discounts and/or rebates, present discounts and/or rebates, present payment to an account such as a pension account or an insurance policy account, warranty or extended warranty, free merchandise and or services, free hotel room nite, free rental car, preferred booking and/or reservation status, service upgrade, flight class upgrade, payment of an applicable tax, payment of sales tax, payment of value added tax, price guarantee, price guarantee for a stated geographic area, check sent to consumer, price guarantee for a stated period of time, price guarantee for a specific item or service, price guarantee for similar items or services, price guarantee based on multiple entities who offer the same or similar item or service, credit to an account, and/or a promise of future incentive or incentives).

In any method herein, the incentive or incentives offered by an entity in any situation may be, e.g., one or some of those listed in the previous sentence—e.g., inter alia, cash paid now, cash paid immediately at a point of transaction or at a point of sale, reward points, favored country or government jurisdiction (e.g., re taxation, duties, fees, tariffs, etc.) for doing a transaction, reduced or free shipping, award points, frequent flyer miles, future discounts and/or rebates, present discounts and/or rebates, present payment to an account such as a pension account or an insurance policy account, warranty or extended warranty, free merchandise and or services, doing a transaction with favored and/or best digital money, free hotel room nite, free rental car, preferred booking and/or reservation status, service upgrade, flight class upgrade, payment of an applicable tax, payment of sales tax, check sent to consumer, payment of value added tax, price guarantee, price guarantee for a stated geographic area, price guarantee for a stated period of time, price guarantee for a specific item or service, price guarantee for similar items or services, price guarantee based on multiple entities who offer the same or similar item or service, credit to an account, and/or a promise of future incentive or incentives.

Optionally, a consumer pre-selects an entity or entities, and only a selected entity (or only selected entities) are allowed to re-bid. Optionally, a consumer has pre-chosen an entity or several entities that are allowed to re-bid. For example, in a first bid step, five different entities provide bids; but prior to this step the consumer has already designated XYZABCeWallet as the only entity that, upon receipt of the bids from the five entities, is allowed to re-bid. XYZABCeWallet may or may not re-bid. In another embodiment, XYZABCeWallet, PDQBank, SevenEightWallet, OnlineshopCom, and EFGCellphone (these are simply fictitious names used for this example) are the only pre-chosen entities that can re-bid. Eight different eWallet bids are received, but only these four entities may have the option of re-bidding. Optionally, all bidding entities receive all bids. Optionally, only a pre-chosen entity or pre-chosen entities receive the information regarding all initial bids and/or subsequent bids. Corresponding computer applications are provided for each such method described in this paragraph (as they are for every method according to the present invention).

In certain embodiments of methods according to the present invention, multiple entities provide particular electronic wallets for use for a transaction. The multiple entities may be electronic wallet providers or entities that have a relationship with an electronic wallet provider. Corresponding computer applications are provided for each such electronic wallet. Each entity's Ewallet or Ewallet associated with an entity may have a corresponding computer application installed on a consumer's personal device, accessible via a server on which the app(s) are installed, and/or available via access to the cloud. In one particular such method according to the present invention, via a personal device a consumer is provided information regarding offers, bids, and/or availability of each particular Ewallet, whether or not each Ewallet's corresponding computer application is installed on the consumer's device. One, some, or all of the Ewallets may be installed on the personal device, or not. Via a method according to the present invention (and using a corresponding computer application installed on a personal device) a consumer may finalize a transaction without having a chosen Ewallet application installed on the personal device. In other aspects in methods according to the present invention, no EWallet is involved, but entities present offers as described for the various possible Ewallet bids to a consumer—either remote from or at a point of sale or at a point of transaction—e.g., via a personal device and/or e.g., a public device; and the consumer chooses an entity to do business with.

It is within the scope of the present invention for a consumer to use a computer device (e.g., but not limited to a smartphone which has computer applications) for initiating, processing, and/or finalizing a transaction with respect to which each of multiple eWallet providers provides an offer with incentive(s) in an effort to be the consumer's eWallet of choice for the transaction. It is within the scope of the present invention for the computer device to have a computer application according to the present invention which initiates connection to and communication with possible eWallet providers who may have an interest in bidding to secure the business for the transaction—e.g., via a network, e.g., via the Internet—and to receive, process, and display the bid of each eWallet provider to the consumer, e.g., on the screen of a smartphone or tablet computer.

The eWallet chosen by the consumer may have a corresponding eWallet computer application on the computer device and/or the consumer can have already set up an eWallet account with the eWallet provider so that, once the consumer indicates the choice of this particular eWallet, the transaction is finalized with that particular eWallet provider.

In another aspect, the consumer does not have a computer application corresponding to the chosen eWallet provider on the computer device and/or the consumer does not have an account in existence with the chosen eWallet provider when the consumer chooses that chosen eWallet provider. In this situation, the consumer, according to the present invention, has several choices. In one aspect, the consumer indicates, using the computer device, that the consumer wishes to set up an eWallet account with the chosen eWallet provider. The consumer then enters the appropriate information and does the things required of the eWallet provider to create the necessary account with the chosen eWallet provider. The transaction is then finalized using the chosen eWallet provider.

In one aspect, the present invention provides a computer application that—inter alia—contains the information necessary for a person to create an eWallet account. The application provides this information to the chosen eWallet provider and the account is created with little or minimal input from the consumer at the actual time of the transaction when the consumer chooses an eWallet provider with which the consumer does not yet have an eWallet account.

In another aspect, the present invention provides a method in which, although the consumer does not have open existing eWallet accounts with each and every eWallet provider that makes an offer for the consumer to choose as the eWallet provider for finalizing a transaction, the consumer has a general account in existence from which the eWallet provider can receive payment for finalizing a particular transaction. The method according to the present invention provides for communication between the consumer's computer device, the master account, and the potential eWallet provider(s). Either the consumer can provide a list of pre-approved eWallet providers (with whom the consumer does not yet have an existing account) which remains resident in the consumer's computer application for access and use in transactions; or the consumer can, via the method according to the present invention, wait until various offers are made for a particular transaction before authorizing a chosen eWallet provider (one not previously authorized) access to the master account. In another aspect, a consumer can require authorization to access the master account each time there is a transaction—whether or not the consumer has an existing account with an eWallet provider. The master account can be any suitable computer-accessible account provided by any suitable institution, e.g., but not limited to, banks, savings and loans, and credit unions, and entities such as PayPal.

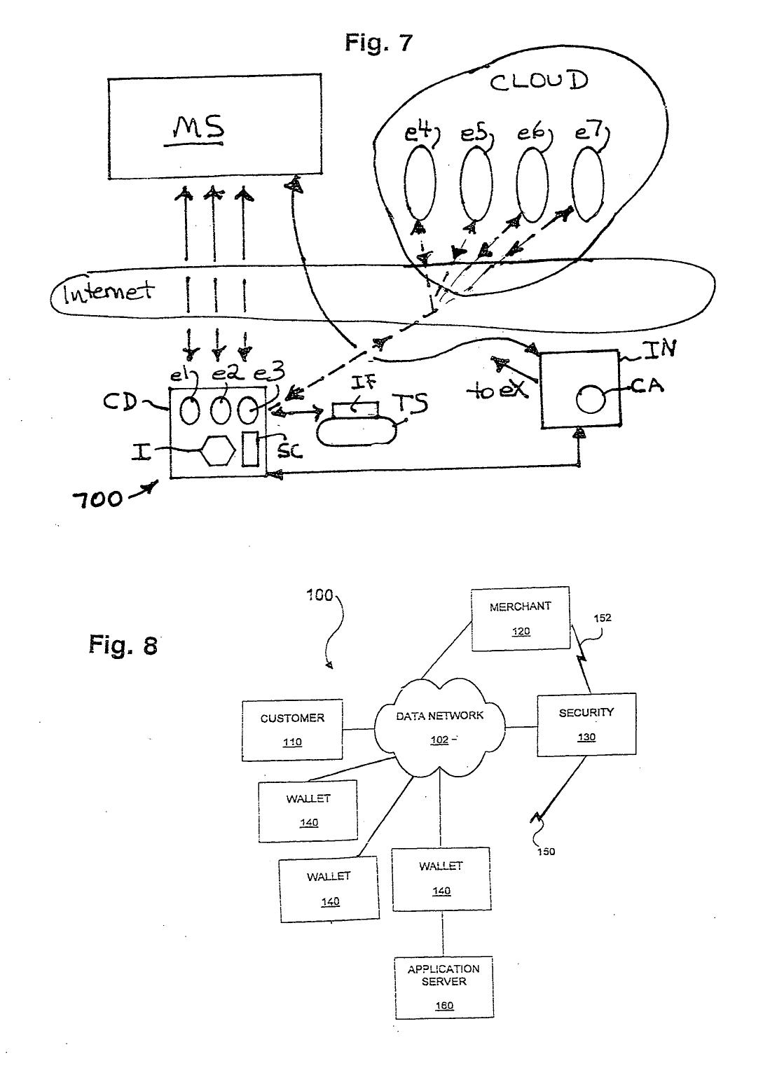

FIG. 7 illustrates a system 700 according to the present invention useful in certain methods according to the present invention. A consumer has a consumer device CD—any suitable computer device or phone disclosed herein—with a screen SC and a plurality of electronic wallet computer applications e1-e3 installed thereon for three existing computerized eWallet accounts of the consumer with three different eWallet providers. The device CD has installed therein a computer application I is a computer application for a method according to the present invention which allows, facilitates and provides for the provision to the consumer of multiple bids and offers from each of a plurality of eWallet providers seeking to win the business of the consumer regarding the consumer's transaction for a thing or service TS. The thing or service TS is associated with an identifier IF (any suitable known identifier, e.g., code or tag) which can be input to the consumer device CD in any known way or method—e.g., by manual input, video input, code scanning input, or audio identifier input. The identifier IF is input to the device CD and then, with the application I via the Internet, each of the eWallet providers e1-e3 are alerted that the consumer wants to do a transaction regarding the service or thing TS.

Optionally, other eWallet providers e4-e7 are also alerted about the possible transaction. The consumer does not yet have an existing account with the eWallet providers e4-37 and apps for communication with and transaction using the eWallet providers e4-e7 are in the Cloud CL and not yet installed on the device CD. The device CD can communicate with the eWallet providers e4-e7 via the Internet and the Cloud. Optionally, each of the eWallet providers e4-e7 can access—with appropriate authorization and connection via and from the consumer device CD—a master Account MS of the consumer in the event the consumer chooses one of the eWallet providers e4-e7 for finalizing the transaction for the thing or service TS and for receiving funds from the consumer's Master Account MS for the transaction.

Optionally, if the incentive offered by the winning eWallet provider is the funding of an account CA of the consumer with an entity IN (e.g., company, bank) which holds the account (e.g., but not limited to a pension plan, retirement account, insurance account, wedding account, gift account, checking account savings account GIFTSURANCE policy, or education account), the computer device CD communicates with the chosen eWallet provider—e.g., via the Internet—and with the entity IN. The entity IN may communicate with the chosen eWallet provider via any suitable communication system or network as needed (see line “eX,” FIG. 7). Optionally, the consumer may transfer funds from the account CA to the Master Account MS and vice versa. For any particular transaction or any type of transaction, this transfer may be set up automatically. The Cloud may be the Internet and vice versa.

Optionally, the account CA is used as the Master Account MS, is an alternative a consumer may choose for a transaction other than the Master Account MS, or is used to replenish the Master Account MS.

It is within the scope of the present invention for any of the giftinsurance policy methods discussed above that an insurance company itself provides an amount for funding a gift policy. This amount can be solely at the discretion of the insurance company at any point during a period in which money commitments are being accumulated for an eventual gift of a policy; or the insurance company's monetary input can be at the beginning, middle or end of the time set for amount accumulations. Optionally, the insurance company can commit to providing a certain amount of funding if the pledged amounts reach a certain level or levels before the final amount is determined.

It is within the scope of the present invention for multiple insurance companies to bid with each other so that a consumer gets multiple offers before finalizing a transaction for a particular insurance policy. The bidding process will proceed and be effected as any of the bidding procedures described above for a transaction or for a purchase of a thing, item, or service; including but not limited to, procedures for bidding by multiple eWallet providers (with insurance companies bidding instead of eWallet providers). The policy which is the subject of the transaction may be any type of policy, e.g., any of those mentioned above and any known policy, e.g., but not limited to life (whole or term), travel, home, auto, accident, and flight insurance.

In any bidding method according to the present invention in which multiple entities (e.g., but not limited to multiple insurance companies or multiple eWallet providers) bid, one incentive a bidder can offer is an insurance policy paid up for a person's life or an insurance policy paid up for a certain time period.

It is within the scope of the present invention for any of the methods according to the present invention involving multiple bidding entities, multiple eWallet providers, and/or multiple insurance companies to be methods for multiple credit card companies to bid to be the credit card chosen for a particular transaction or purchase. In any of the methods described above, instead of having multiple eWallet bidders or multiple insurance company bidders, there are multiple credit card companies bidding and the transaction or purchase is finalized using a chosen credit card. This can be done according to the present invention with or without final payment being effected with an eWallet.

It is within the scope of the present invention for any of the methods according to the present invention involving multiple bidding entities, multiple eWallet providers, multiple credit card companies, and/or multiple insurance companies to be methods for multiple financial institutions to bid to be the entity chosen for a particular transaction or purchase. In any of the methods described above, instead of having multiple eWallet bidders multiple credit card company bidders, or multiple insurance company bidders, there are multiple financial institution bidders bidding and the transaction or purchase is finalized using a chosen financial institution (e.g., bank, savings and loan, brokerage house, or mutual fund entity). This can be done according to the present invention with or without final payment being effected with an eWallet.

In certain aspects, the present invention discloses a method for conducting a transaction, the method including: a. receiving, at a first server, a transaction request from a user for a transaction at a merchant server or online via a network, e.g., but not limited to the Internet; b. issuing a challenge to a second server and forwarding the challenge from the second server to the user, wherein the challenge is passed to a token or to an intelligent token for processing the challenge, wherein the token or the intelligent token generates a response to the challenge; c. receiving the response at the second server from the user based upon the challenge; d. processing the response at the second server and verifying the token or the intelligent token; e. assembling credentials for the transaction at the first server, the credentials being at least one key; f. providing at least a portion of the assembled credentials to the user; g. receiving, at the second server, a second request from the user, the second request including the portion of the assembled credentials provided to the user; and h. validating, at the second server, the portion of the assembled credentials provided to the user with the key of the assembled credentials providing access to a transaction service; wherein, in certain aspects the transaction is an electronic purchase transaction and/or wherein the electronic purchase transaction is conducted using a digital wallet and/or the transaction is conducted using multiple eWallets and then one eWallet chosen from a plurality of possible eWallets usable for the transaction and/or wherein the user conducts the transaction using a smartcard and/or wherein the transaction is a web-based transaction, e.g., but not limited to, an Internet-based purchase transaction.

A digital wallet or eWallet useful in such a method as described in the previous paragraph (or in any method described herein) may provide a means for customers to utilize transaction card products (e.g., credit, charge, debit, smart cards, account numbers and the like) to pay for products and services on-line. Such a digital wallet may be a tool which stores personal information (e.g., name, address, chargecard number(s), credit card number(s), etc.) in order to facilitate electronic commerce or other network interactions. The personal information can be stored on a general server or at a client location (on a client computer device, PC, smartphone, or Smartcard) or on a hybrid of both a general server and a client device. The digital wallet general server may include a Web server and a database server which centrally houses the customer's personal and credit card information, accounts information, shopping preferences and profiles of on-line merchants. Such an eWallet may perform functions such as single sign on/one password, automatic form filling of check out pages, one- or two-click purchasing, personalization of Websites, on-line order and delivery tracking, itemized electronic receipts, and customized offers and promotions based upon spending patterns and opt-ins. In certain aspects, a one-click purchase can activate an eWallet and confirm a transaction finalization and/or the purchase at the same time; or a two-click check out can first activate the eWallet, then a second click can confirm transaction finalization and/or the purchase. Multiple such eWallets are accessible to the customer for various embodiments of the present invention.

In one embodiment of the invention, a user is provided with an intelligent token, such as a smartcard, which can be used in conducting electronic transactions. The intelligent token contains a digital certificate and suitably authenticates with a server on the network that conducts all or portions of the transaction on behalf of the user. The user is a person conducting a transaction, e.g. a purchase, and the server is or is on an eWallet server that interacts with a security server to provide enhanced reliability and confidence in the transaction.

Certain embodiments of methods of the present invention may be described herein in terms of functional block components and various processing steps. It should be appreciated that such functional blocks may be realized by any number of hardware and/or software components configured to perform the specified functions. For example, the present invention may employ various integrated circuit (I.C.) components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, or the like, with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a scripting language such as JavaScript, VBScript or the like. Also, connecting lines shown in the various figures contained herein are intended to represent exemplary functional relationships and/or physical couplings between the various elements. It should be noted that many alternative or additional functional relationships or physical connections may be present in a practical electronic transaction system. A customer and a merchant may represent individual people, entities, or business while an institution or a bank may represent other types of card issuing institutions, such as credit card companies, card sponsoring companies, or third party issuers under contract with financial institutions. The payment network can include existing proprietary networks that presently accommodate transactions for credit cards, debit cards, and other types of financial/banking cards. The payment network may be a closed network that is assumed to be secure from eavesdroppers such as the American Express network, VisaNet network or Veriphone.

Referring now to FIG. 8, a transaction system 100 suitably includes at least one user computer device 110, a transaction authorizer computer 120, a security server 130 and a plurality of transaction tool servers 140. The transaction system 100 may be used in electronic commerce to conduct transactions, e.g., purchase transactions. The user computer device 110 may be a purchaser or customer computer, the transaction authorizer computer 120 may be a merchant computer and the transaction tool servers 140 may be eWallet servers. The various computers, systems and servers are interconnected as appropriate by a data network 102, which is any data network such as the Internet or another public data network. Other suitable networks 102 include the public switched telephone network (PSTN), corporate or university intranets, and the like.

In various embodiments, a merchant computer 120 may be electronically coupled to a security server 130 through a data connection 152 separate from network 102. Similarly, various embodiments may include a connection 150 separate from network 102 connecting the eWallet servers 140 and security server 130. Exemplary data connections suitable for use with connections 150 and 152 include telephone connections, ISDN connections, dedicated T1 or other data connections, wireless connections and the like. It will be appreciated that connection 150 and connection 152 may be identical connections, or each may be an entirely different form of connection in various embodiments of the invention.

Certain embodiments may also include an application server 160 which may have any computer application disclosed herein. In various embodiments, databases (not shown) and/or profile servers (not shown) may be connected to the application server 160 and/or to one or some or all of the eWallet servers 140. It is within the scope of this invention for components (e.g., customer 110, merchant 120, security server 130, wallet server(s) 140 and application server 160) may be individual computers, computer devices, or networked groups of computers acting with similar purpose to fulfill the functions described herein. Functionality attributed to a single component may be distributed among one or more individual computers in order to fulfill the described functionality. For example, an eWallet server 140 may be a collection of Web servers, application servers, database servers and other types of servers.

An eWallet wallet server 140 may include a network interface, an optional applet server and a wallet computer application. A network interface may be any program that facilitates communications on the network 102, such as a Web server. An optional applet server may provide server functionality for distributed programs such as Java programs or ActiveX controls. The applet server and the network interface provide support functionality for eWallet applications, which may handle login functionality, retrieve wallet data from an eWallet database, and/or administer transactions as described herein.

In one aspect of a method according to the present invention, a customer initiates a transaction with respect to a chosen thing or service and is then logged into the eWallet servers 140. In one aspect this is done using a smartcard. To log in to the eWallet servers 140, the customer 110 first may connect to the security server 130 via a web browser. The user may select a particular uniform resource locator (URL) for the login page through a bookmark, an internet shortcut, a hyperlink, or any other suitable technique. Security server 130 may then return a login page via a network interface. In various embodiments, a form entry and submission button for user/password login and a hypertext link for smartcard login are provided as part of the login page. The user selects smartcard login, and the browser suitably responds by forwarding a log on request message.

Each eWallet—provided with details of the potential transaction—then declines to make an offer or makes an offer to the user for being the eWallet provider to be chosen to finalize the transaction. The user chooses one of the bidding multiple eWallets and the transaction is then finalized. In certain aspects, the various components of the system 100 function as described in U.S. Pat. No. 7,343,351, incorporated fully herein for all purposes.

It is within the scope of the present invention for any bidder or entity making an offer in any method according to the present invention to take into account a variety of factors that may contribute to a consumer's choice of an entity for finalizing a transaction and in making a determination of an optimum price for good(s) and/or service(s) and/or to a determination of a most desired price (e.g., wherein lowest price is not necessarily a consumer's most desired price). In certain aspects, the optimum price is the lowest price. In certain aspects, the optimum price or the desired price is a lowest “total price.”

For example, such a price may take into account shipping and processing fees; taxes, tariffs, import fees, duties, and other government fees; and/or a variety of different digital monies, current value of digital monies, and/or a currently most valuable digital money. Any of these factors may be presented to a consumer by a bidder or other entity when the consumer is considering buying good(s) or service(s). Any of these factors may be included in a bid or offer as part thereof. Any eWallet provider making a bid for a transaction may include these factors as part of a bid and, in certain aspects, as part of a “total price” for a bid and/or as an incentive for choosing that particular eWallet provider. Any digital money provider may also be an eWallet provider.

Any computer program or app for effecting a method, a method step, or method steps according to the present invention may include instructions in a tangible medium which, when implemented and executed result in the determination of a value, price or level of, based on, taking into account, or associated with the factor(s) and/or in a presentation to the consumer and/or in a display to the consumer of a value, incentive, level, or price associated with the factor or factors. In certain aspects, the determination, presentation, and/or display includes a “total price” which includes an amount for one, some or all of these factors or which includes an amount based on one of these factors.

Optionally, in any method according to the present invention, a consumer may, before any bid or offers are made, choose a particular digital money to be used for finalizing transactions and/or a particular digital money provider and such a choice can include allowing an app or software access to a digital money account of the consumer with a digital money provider (entity) and, optionally, putting an eWallet provider in communication with a digital money provider or an account with digital money. Optionally, in any method according to the present invention, a consumer may, before any bid or offers are made, choose a particular shipping entity to be used for shipments of goods which are the subject of a finalized transaction and such a choice can include allowing an app or software access to an account of the consumer (including, but not limited to, a digital money account) with a shipment entity. Optionally, in any method according to the present invention, a consumer may, before any bid or offers are made, choose a particular country or taxing jurisdiction in which and/or according to whose laws and/or regulations a transaction is to be, negotiated, contracted, transacted and/or finalized and such a choice can include providing an app or software for effecting such choice.

The present invention provides new and nonobvious improvements to the subject matter disclosed in U.S. Patent Application Pub. No. 2009/0313147, incorporated fully herein for all purposes. In certain aspects, there is provided according to the present invention a method of processing a transaction between a merchant (or other business entity) and a buyer (or consumer) over a communication network in which the transaction is processed using one of a plurality of digital monies provided by one of a plurality of digital money provider entities (“DMPEs”), each of which provides digital money services and implementation of payment in a particular digital money. Such a method may include: obtaining transaction information from the merchant; returning a redirection URL and an order identifier to the merchant; obtaining a transaction message from the merchant, where the transaction message specifies the type of operation; providing information for each of a plurality of DMPEs and the current value of the digital money of each DMPE; performing the operation type specified in the transaction message with a DMPE chosen by the buyer; and returning a processing message to the merchant containing the results from performing the operation type specified in the transaction message.

In one such m method of processing a transaction between a merchant and a consumer over a communications network, wherein the transaction uses a chosen DMPE, wherein a consumer chooses a DMPE from a plurality of DMPEs, each DMPE having its own payment implementation, the method further including the steps of: the consumer choosing a DMPE; obtaining transaction information from the merchant, wherein the transaction information identifies the chosen DMPE being used; returning a redirection URL and a payment network routable order identifier to the merchant, wherein the redirection URL is dependent upon the identified DMPE; obtaining a transaction message from the merchant, wherein the transaction message is formatted with a unified message format and includes an operation type; performing the operation type specified in the transaction message with the DMPE corresponding to the identified DMPE; and returning a processing message to the merchant containing results from performing the operation type specified in the transaction message, wherein the processing message is formatted with the unified message format.

To effect such methods, in certain aspects a system is provided for supporting the processing of transactions between merchants and consumers over a communications network, wherein the consumers are each using a chosen one of a plurality of DMPEs, wherein each of the DMPEs have different payment implementations, the system including: a merchant layer for exchanging communications with the merchants, the merchant layer receiving transaction information and a operation type for each transaction, wherein the transaction information includes payment information and identifies the one of the DMPEs being used for each transaction; a plug-in layer including a plurality of plug-in components, wherein each of the plurality of plug-in component administers a different one of the plurality of DMPEs in accordance with the respective alternative payment implementation; and a logic layer residing between the merchant layer and the plug-in layer, wherein the logic layer is adapted to route communications between the merchant layer and selected plug-in components in the plug-in layer, wherein the operation type and the transaction information for each transaction are routed to the plug-in component responsible for administering the DMPE payment option associated with the transaction information, and wherein the logic layer is adapted to return a redirection URL and a payment network routable order identifier to the merchants for each transaction. Optionally, such a system may: have a data layer, wherein the data layer stores the transaction information for each transaction; have a logic layer is operative to communicate transactions to at least one processor; and/or have a web layer, where the web layer receives additional payment information from the consumer, and where the redirection URL points to the system wherein the plug-in layer is extensible so as to allow selected plug-in components to be added, removed and modified without disrupting other plug-in components residing in the plug-in layer.

In methods above, with appropriate changes, a plurality of possible shipping entities are substituted for the DMPEs and and a chosen shipping entity is substituted for a chosen DMPE. In certain aspects, there is provided according to the present invention a method of processing a transaction between a merchant (or other business entity) and a buyer (or consumer) over a communication network in which the transaction is processed using one of a plurality of possible shipping methods provided by one of a plurality of shipping entities, each of which provides shipping services and implementation of the provision of such service. Such a method may include: obtaining transaction information from the merchant; returning a redirection URL and an order identifier to the merchant; obtaining a transaction message from the merchant, where the transaction message specifies the type of operation; providing information for each of a plurality of shipping entities and the current prices and fees for shipping of each shipping entity; performing the operation type specified in the transaction message and effecting shipping using a shipping entity chosen by the buyer; and returning a processing message to the merchant containing the results from performing the operation type specified in the transaction message.

In any method herein, a consumer (or buyer) may choose to negotiate, contract for finalize, and/or effect a transaction in a country and/or according to the laws and regulations of a country after considering information regarding taxes, government fees, etc. for a plurality of countries and/or jurisdictions. In certain aspects, there is provided according to the present invention a method of processing a transaction between a merchant (or other business entity) and a buyer (or consumer) over a communication network in which the transaction is negotiated, contracted for, finalized, processed and/or effected in and/or according to the laws, etc. of one of a plurality of countries and/or government jurisdictions. In such processes a consumer may have and may take into account the amounts and levels of taxes etc. in determining in which country or jurisdiction to proceed and/or which bid, offer, and/or “total price” to accept. In one such method one of a plurality of countries (or government jurisdictions) is chosen by a consumer monies. Such a method may include: obtaining transaction information from the merchant; returning a redirection URL and an order identifier to the merchant; obtaining a transaction message from the merchant, where the transaction message specifies the type of operation; providing information for each of a plurality of countries (or government jurisdictions) and the current amount and/or level of taxes, fees, etc. of each country; performing the operation type specified in the transaction message with a country chosen by the buyer; and returning a processing message to the merchant containing the results from performing the operation type specified in the transaction message.

Certain embodiments of the present invention are directed to performing a transaction using a chosen one of a plurality of third party mobile wallets, performing a transaction using a point of sale (POS) system and to making a purchase from a chosen third party mobile wallet provided by a chosen third party mobile wallet provider. In one aspect, a cloud-based transaction platform is provided, which receives communication from an agent terminal over a communication channel connected to the cloud-based transaction platform. The agent communication indicates that a customer desires to perform a mobile wallet transaction using a chosen third party mobile wallet. The cloud-based transaction platform sends the agent communication to a plurality of third party mobile wallet platforms, receives communication from each third party mobile wallet platform which is to make a bid or offer to the consumer to influence the consumer to choose a particular wallet, the consumer then making a choice and, then a chosen platform confirming processing of the transaction, and sends communication to the agent terminal over a communication channel connected to the cloud-based transaction platform, where the communication indicates confirmation of chosen wallet and confirmation of the processing of the transaction. In certain aspects, the present invention provides a cloud-based transaction platform including: one or more processors; system memory; one or more computer-readable storage media having stored thereon computer-executable instructions that, when executed by the one or more processors, cause the computing system to perform a method according to the present invention; optionally, including an app downloadable to a personal computing apparatus or phone.

The present invention provides new and nonobvious improvements to the subject matter disclosed in U.S. Patent Application Pub. No. 20130132219, incorporated fully herein for all purposes. In certain aspects, the present invention provides a cloud-based transaction platform or platforms including: one or more processors; system memory; one or more computer-readable storage media having stored thereon computer-executable instructions that, when executed by the one or more processors, cause the computing system to perform a method for performing a transaction using a third party mobile wallet chosen by a consumer from a plurality of third party mobile wallets and/or the consumer presented with multiple bids by multiple bidding entities (which may or may not be one or more of the entities that provide a mobile wallet), and/or the bids including an amount which takes into account a current value of a particular digital money, a current amount for applicable government taxes or fees or tariffs or duties, and/or an amount for shipping goods subject of the transaction, the method including the following: a consumer choosing one of a plurality of third party mobile wallets; an act of receiving communication from an agent terminal over one of a plurality of communication channels connected to the cloud-based transaction platform or platforms, the agent communication indicating that a customer desires to perform a mobile wallet transaction using a chosen third party mobile wallet; an act of sending the agent communication to a chosen third party mobile wallet platform; an act of receiving communication from the third party mobile wallet platform confirming processing of the transaction; and an act of sending communication to the agent terminal over one of a plurality of communication channels connected to the cloud-based transaction platform or platforms, the communication indicating confirmation of the processing of the transaction. In such a method, optionally, each third party mobile wallet provider has their own point of sale (POS) processing system.

The present invention provides, in certain aspects, systems, methods, and computer mediums for effecting a user's choice, from a plurality of possible electronic (virtual) wallet providers, a selected wallet for use in a transaction. Each prospective wallet provider presents a bid to the user in an attempt to have the user select that particular wallet to do the transaction. Once the various bids have been presented to the user and the user has chosen a selected wallet from a selected electronic wallet provider, then the system, computer medium and method may be as in A, B. and C. below, respectively:
A. System: a virtual wallet selection system, including: a computing processor; a network communication device disposed in communication with the computing processor; and a memory disposed in communication with the computing processor, and storing computing processor-executable instructions, the processor-executable instructions executable by the computing processor to: obtain, via the network communication device operatively connected to a payment network server, a user authentication request for the transaction; extract, via the computing processor operatively connected to the payment network server, a universal account number based on parsing the user authentication request; determine, based on querying a database memory operatively connected to the payment network server, using the universal account number, that the user is authorized to access the chosen virtual wallet; maintain, based on querying a database memory using the universal account number, privacy of user payment data away from a merchant involved in the purchase transaction by utilizing a secure network communication with a user mobile device to provide payment data to the payment network server to process the transaction; maintaining the privacy of the user payment data from the merchant involved in the purchase transaction; provide via the network communication device, upon determining that the user is authorized to access the chosen virtual wallet, a secure user virtual wallet selection request to the user mobile device via an encrypted, bandwidth and network latency reducing, out-of-band network communication, via an electronic payment communication network; obtain, via the network communication device at a payment network server, information of the user selection of a virtual wallet from the plurality of possible wallets, from the user mobile device via the network communication device; and provide, via the network communication device, an encrypted purchase transaction request message for transaction processing, using the user selection of the virtual wallet.
B. Computer Medium: A non-transitory computer-readable medium storing processor-executable virtual wallet selection instructions, said virtual wallet selection instructions executable by a processor to: obtain, via a network communication device operatively connected to a payment network server, a user authentication request for a transaction; extract, via a computing processor operatively connected to the payment network server, a universal account number based on parsing the user authentication request; determine, based on querying a database memory operatively connected to the payment network server, using the universal account number, that the user is authorized to access a chosen virtual wallet; maintain, based on querying a database memory using the universal account number, privacy of user payment data away from a merchant involved in the transaction by utilizing a secure network communication with a user mobile device to provide payment data to the payment network server to process the transaction; identify, via the computing processor of the payment network server, a plurality of virtual wallets options to provide securely to the user mobile device of the user via the network communication device, while maintaining the privacy of the user payment data from the merchant involved in the transaction; provide via the network communication device, upon determining that the user is authorized to access the chosen virtual wallet, a secure user virtual wallet request via an encrypted, bandwidth and network latency reducing, out-of-band network communication, via an electronic payment communication network; obtain, via the network communication device at a payment network server, user selection of a virtual wallet from a plurality of securely provided selection options, from the user mobile device via the network communication device; and provide, via the network communication device, an encrypted transaction request message for transaction processing, using the user selection of the virtual wallet.
C. A virtual wallet selection processor-implemented method, including: obtaining, via a network communication device operatively connected to a payment network server, a user authentication request for a purchase transaction; extracting, via a computing processor operatively connected to the payment network server, a universal account number based on parsing the user authentication request; determining, based on querying a database memory operatively connected to the payment network server, using the universal account number, that the user is authorized to access a plurality of virtual wallets; maintaining, based on querying a database memory using the universal account number, privacy of user payment data away from a merchant involved in the purchase transaction by utilizing a secure network communication with a user mobile device to provide payment data to the payment network server to process the transaction; identifying, via the computing processor of the payment network server, a plurality of virtual wallet selection options to provide securely to the user mobile device of the user via the network communication device, while maintaining the privacy of the user payment data from the merchant involved in the transaction; providing via the network communication device, upon determining that the user is authorized to access the virtual wallets, a secure user virtual wallet selection request including a list of user wallets for selection to the user mobile device via an encrypted, bandwidth and network latency reducing, out-of-band network communication, via an electronic payment communication network; obtaining, via the network communication device at a payment network server, user selection of a virtual wallet from the plurality of securely provided selection options, from the user mobile device via the network communication device; and providing, via the network communication device, an encrypted purchase transaction request message for transaction processing, using the user selection of the virtual wallet.

The present invention provides new and nonobvious improvements to the subject matter disclosed in U.S. Patent Application Pub. No. 20130132219, incorporated fully herein for all purposes, which, in one aspect, is a virtual wallet selection system, including: a computing processor; a network communication device disposed in communication with the computing processor; and a memory disposed in communication with the computing processor, and storing computing processor-executable instructions, the processor-executable instructions executable by the computing processor to: obtain, via the network communication device operatively connected to a payment network server, a user authentication request for a purchase transaction; extract, via the computing processor operatively connected to the payment network server, a universal account number based on parsing the user authentication request; determine, based on querying a database memory operatively connected to the payment network server, using the universal account number, that the user is authorized to access a plurality of virtual wallets; maintain, based on querying a database memory using the universal account number, privacy of user payment data away from a merchant involved in the purchase transaction by utilizing a secure network communication with a user mobile device to provide payment data to the payment network server to process the purchase transaction; identify, via the computing processor of the payment network server, a plurality of virtual wallet selection options to provide securely to the user mobile device of the user via the network communication device, while maintaining the privacy of the user payment data from the merchant involved in the purchase transaction; provide via the network communication device, upon determining that the user is authorized to access the virtual wallets, a secure user virtual wallet selection request including a list of user virtual wallets for selection to the user mobile device via an encrypted, bandwidth and network latency reducing, out-of-band network communication, via an electronic payment communication network; obtain, via the network communication device at a payment network server, user selection of a virtual wallet from the plurality of securely provided selection options, from the user mobile device via the network communication device; and provide, via the network communication device, an encrypted purchase transaction request message for transaction processing, using the user selection of the virtual wallet.

The present invention provides new and nonobvious improvements to the subject matter disclosed in U.S. Patent Application Pub. No. 20130132219, incorporated fully herein for all purposes, which, in one aspect, is a non-transitory computer-readable medium storing processor-executable virtual wallet selection instructions, the virtual wallet selection instructions executable by a processor to: obtain, via a network communication device operatively connected to a payment network server, a user authentication request for a purchase transaction; extract, via a computing processor operatively connected to the payment network server, a universal account number based on parsing the user authentication request; determine, based on querying a database memory operatively connected to the payment network server, using the universal card account number, that the user is authorized to access the virtual wallets; maintain, based on querying a database memory using the universal card account number, privacy of user payment data away from a merchant involved in the purchase transaction by utilizing a secure network communication with a user mobile device to provide payment data to the payment network server to process the purchase transaction; identify, via the computing processor of the payment network server, a plurality of virtual wallet selection options to provide securely to the user mobile device of the user via the network communication device, while maintaining the privacy of the user payment data from the merchant involved in the purchase transaction; provide via the network communication device, upon determining that the user is authorized to access the virtual wallets, a secure user virtual wallet selection request including a list of user virtual wallets for selection to the user mobile device via an encrypted, bandwidth and network latency reducing, out-of-band network communication, via an electronic payment communication network; obtain, via the network communication device at a payment network server, user selection of a virtual wallet from the plurality of securely provided selection options, from the user mobile device via the network communication device; and provide, via the network communication device, an encrypted purchase transaction request message for transaction processing, using the user selection of the virtual wallet. Herein a universal account may be, but is not limited to, a universal card account.

In the systems, mediums and methods of the three previous paragraphs, a virtual wallet provider bidding in an effort to have a user select that particular wallet, may include in a bid an indication of a particular digital money in which to effect the transaction; selection of a particular country or jurisdiction in which to effect the transaction due to favorable tax considerations or other government fee considerations; and/or provision of a favorable charge for shipment of goods. Any bid in any method according to the present invention may also take into account these factors or include an amount in a bid related to one, two or three of these factors.

In any method herein, a digital money provider may be a wallet provider.

In certain aspects, the present invention provides methods in which the consumer chooses from a plurality of the consumer's digital monies. This choice may be made by the consumer (and there is according to the present invention an app for this choice) in addition to bids by multiple bidding entities and the choice communicated to all bidding entities before an entity is chosen so that the transaction is done using the particular digital money chosen by the consumer. Optionally, the consumer may provide to each bidding entity the identity of one or multiple digital money providers with whom the consumer has an account and the bidders may take this into account, base bids on this, base bids on the use of a particular digital money, and/or base incentive(s) in whole or in part of payments, presently or later, of digital money to the consumer. Future incentives may be based on a consumer's use of a particular digital money for a preset number of transactions and/or on a preset total value of transaction, one or more, that meets the preset threshold. Payment into and/or funding of any account described herein may be based on or dependent on the use of a particular digital money. Optionally, instead of the choice being made for already-existing digital money accounts of the consumer, a bid includes the agreement that a consumer will open a digital money account with the bidder (or an entity designated by the bidder) and then the transaction will be done with that digital money. The opening of this account and the transfer of money to it so that the account then reflects an amount of this accounts digital money can be done before the transaction is finalized so that the transaction can be done with this particular digital money. Alternatively, the consumer agrees—no matter what currency or digital money or account is used for a present transaction—to open a new digital money account with a digital money provider designated by a bidder, and/or at a level of funding which is agreed to by the bidder and the consumer after (or while) the transaction is finalized.

In any method herein, a consumer can preselect which digital money of a plurality of digital monies of the consumer is used for a transaction; e.g., the consumer can designate that the most-recently acquired digital money is used, that the least appreciated digital money for a previous time-period is used, or the most appreciated, or the account which presently has the highest total value or the lowest total value.

In one method according to the present invention, a consumer determines that the consumer wants to do a transaction with respect to an object which is the object of the transaction—e.g. a good or goods, a service or services, a thing or things—and then the method includes these steps:
identify the object;
communicate in a first communication a desire to do a transaction with respect to the object so that potential bidders for effecting the transaction can be or are informed regarding the transaction and the object; if this first communication step does not include communication with each potential bidder, then communicate in a second communication step with each potential bidder informing each of the identity of the object and, optionally, the identity of the consumer or information that indicates the consumer with or without revealing the identity of the consumer;
communicate in a third communication bids of any bidder who bids for the transaction;
communicate in a fourth communication the consumer's choice of winning bid and bidder, the fourth communication transmitted to the winning bidder only, or to all bidders; or the fourth communication including the consumer's choice of bidders invited to re-bid, with or without revealing to the re-bidder candidates the bids of each re-bidder candidate;
in the event or a re-bid, communicate in a fifth communication the consumer's choice of winning bid and bidder, such fifth communication transmitted to each bidder, to each re-bidder, or to the winning bidder only; and
following a choice by the consumer of the winning bidder and bid, finalizing the transaction, including payment by the consumer for the object of the transaction.

In one aspect such a method as just described is done using a network, including, but not limited to, the Internet; and a consumer computer or computerized device or apparatus is used by the consumer, including, but not limited to a computerized phone; and, in certain aspects, computer apps, e.g. apps downloadable to a computerized phone, do or facilitate the doing of each step. In certain aspects, the identification of the object of the transaction includes the consumer conveying identifying information to an intermediary entity which then communicates with each possible bidder, or a computer app conveys the information to each possible bidder directly. In other aspects, the consumer scans an identifier on or associated with the object of the transaction, and identifying information from such scan is then conveyed to an intermediary entity or directly to possible bidders. Finalizing the transaction can include and/or result in: the consumer at a site of an object of a transaction taking possession of the object and leaving with it; shipping of the object being arranged and initiated; the scheduling of a service which is the object; or the beginning of a service which is the object of the transaction.

Optionally in a method as just described, or in any suitable method according to the present invention, a consumer may include in the information provided to the possible bidders the choice of the consumer for an eWallet to be used for the transaction or eWallet candidates one of which will be used for the transaction, e.g., when possible bidders include credit card providers, various retailers, and/or digital money providers. Optionally in a method as just described, or in any suitable method according to the present invention, a consumer may include in the information provided to the possible bidders the choice of the consumer for a digital money to be used for the transaction or multiple digital money candidates one of which will be used for the transaction, e.g., when possible bidders include credit card providers, eWallet providers, and/or various retailers. Optionally, the consumer can include in the information provided to potential bidders the identity of a shipment entity that will be used to ship the object of the transaction, or the identity of multiple shipment entities. Optionally, the consumer can include in the information provided to potential bidders the identity of an account or of multiple accounts to be funded based on the finalizing of the transaction, e.g., but not limited to, any of the pension accounts, event accounts, insurance accounts, wedding accounts, funeral accounts, college accounts, etc. disclosed herein. In certain aspects, despite the exercise of any of these options, a bidder may bid contrary to the stated wishes or directions of a consumer. Optionally, no potential bidder is permitted to bid contrary to stated chosen options of a consumer. Optionally, any method described above may include a step, steps, or a method for guaranteeing a price of a finalized transaction, including, but not limited to, any price guarantee method as disclosed or referred to herein. Optionally, for a transaction done using digital money, a bidder may include a guarantee for a set time period in which if the value of the digital money goes up, the transaction will be re-done at the new value for the digital money; or if the value of the digital money goes up or goes up a pre-set percentage, then the cost or price of the transaction is refigured and re-finalized at a cost or price reduced by a pre-set percentage of the increase in value of the digital money.

It is within the scope of the present invention for a consumer to use any desired actual known currency for a transaction (e.g., but not limited to dollar, euro, yen, etc.); and it is within the scope of the present invention for actual currency to be substituted above in any method or step in which digital money is used, referred to, or considered; and for an actual currency provider to be substituted for a digital money provider.

It is within the present invention to provide a method (or to add to any method disclosed or claimed herein) which provides to a consumer an interest in, a money sum (actual money or digital money) and/or an award based on, or a part of an award or money sum (actual money or digital money) made to an entity or person who facilitates (combines or aggregates transactions, makes possible, effects, organizes, provides the system for) a number of transactions done with a selected specific entity, e.g. a credit card provider, account provider, eWallet provider, or digital (virtual) currency provider. This is a new and nonobvious improvement to certain known methods in which a person or entity receives something for facilitating a certain number of transactions with a selected entity and/or for facilitating an aggregate number of transactions and/or for facilitating an aggregate value for a multiple number of transactions. In one particular aspect, this method provides to each consumer who uses Bitcoins for a transaction a share in or an award based on what is realized by a “Bitcoin miner” who is rewarded by Bitcoin for “mining” transactions. In certain aspect, each consumer related to a particular successful “mining” is given part of the Bitcoins awarded to the successful “miner,” or each consumer is given an award of Bitcoins and/or other award (other money and/or other thing of value) which is separate from the Bitcoins received by the successful “miner.”

In such a method wherein each of multiple consumers receive part of or an award based on an award to a entity facilitating multiple transactions, what each consumer receives can be based on: the money value of each consumer's transaction; simply the fact that the consumer finalized the transaction, with each of a plurality of consumers receiving the same award, no matter how much money each consumer spent; time precedence of transactions—e.g. with a consumer's whose transaction was first in time receiving more than a consumer whose transaction was later in time; actual number of transactions of a particular consumer—either (a) transactions which serve as part of a basis for a single specific award to a facilitator or (b) all transactions by a particular consumer which used that particular entity (virtual currency, credit card, account) over time (e.g. over a preset time period or for all time); or actual value of transaction(s) of a particular consumer—either (a) for only the transaction(s) which serve as part of a basis for a single specific award to a facilitator or (b) the value of all transactions by a particular consumer which used that particular entity (virtual currency, credit card, account) over time (e.g. over a preset time period or for all time).

Any such step, steps, or methods may be facilitated and/or effected, in whole or in part, by computer systems, computer software, and/or computer app(s), using a network, as described above for other steps and methods according to the present invention; using, e.g., a personal computerized device such as a laptop computer, cell phone, smartphone, or tablet computer.

In certain aspects, the present invention provides a system and a method using the system, the system including a memory storing user (also called “consumer”) account information, wherein the information includes funding sources including multiple non-cash, non-credit based funding options, including but not limited to virtual currency funding options and/or virtual currency providers; and one or more processors for communicating the multiple non-cash, non-credit based funding options to a personal computerized device and/or on a merchant site; receiving a selection of a first option of the multiple non-cash, non-credit based funding options made by a user (or consumer) from the merchant site; and processing a payment using the selected first option; and each of the funding sources providing a bid to influence the user (consumer) to select that particular funding source and, optionally, re-bids by at least one, by two, or by more than two of the funding sources. In certain aspects, such a method may include any step, any of the steps, or any method described above in which digital money may possibly be used to finalize a transaction and/or in which a digital money provider may bid and/or effect a transaction. Such a system may include one or some, in any possible combination, of the following: wherein the funding options include reward points, loyalty points, and virtual currency; wherein the funding options are part of a user wallet with the payment provider; wherein the funding options include a mobile carrier account for the user; wherein the processing includes debiting an account of a vendor with a payment provider, wherein the account is associated with the selection, crediting an account of the user with the payment provider, debiting the account of the user, and crediting an account of the merchant with the payment provider; and/or wherein funds from a bank account of the vendor are transferred to the account of the vendor with the payment provider. Such a system may include a non-transitory machine-readable medium including a plurality of machine-readable instructions which when executed by one or more processors of a server are adapted to cause the server to perform a method including: communicating the multiple non-cash, non-credit based funding options to a personal computerized device and/or on a merchant site; receiving a selection of a first option of the multiple non-cash, non-credit based funding options made by a user (consumer) from the personal computerized device and/or from the merchant site; and processing a payment using the selected first option; and/or with any bidding step or any bidding steps according to the present invention by any of the disclosed or described entities for bidding. Such a non-transitory machine-readable medium may include one or some, in any possible combination, of the following: wherein the funding options includes reward points, loyalty points, and virtual currency; wherein the funding options are part of a user wallet with the payment provider; wherein the funding options include a mobile carrier account for the user; wherein the processing includes debiting an account of a vendor with the payment provider, wherein the account is associated with the selection, crediting an account of the user with the payment provider, debiting the account of the user, and crediting an account of the merchant with the payment provider; wherein funds from a bank account of the vendor are transferred to the account of the vendor with the payment provider. Such a method as described above may be a method including: communicating the multiple non-cash, non-credit based funding options to a consumer's personal computerized device and/or on a merchant site; receiving a selection of a first option of the multiple non-cash, non-credit based funding options made by a user (consumer) from the device and/or from the merchant site; and processing a payment using the selected first option. Such a method may include one or some of the following, in any possible combination: wherein the funding options include reward points, loyalty points, and virtual currency; wherein the funding options are part of a user wallet with the payment provider; wherein the funding options include a mobile carrier account for the user; wherein the processing includes: debiting an account of a vendor with the payment provider, wherein the account is associated with the selection, crediting an account of the user with the payment provider, debiting the account of the user, and crediting an account of the merchant with the payment provider; wherein funds from a bank account of the vendor are transferred to the account of the vendor with the payment provider; wherein the merchant site comprises a Point of Sale (POS) terminal at a physical store; and/or wherein the merchant site includes an e-commerce network site.

According to the various aspects of the present disclosure, a method, system, and computer program product are disclosed that allow for payment with non-traditional sources of value, e.g. virtual currency (“digital money”) and for bidding with virtual currency and/or bids by virtual currency providers. Additionally, methods according to the present invention include awards or incentives to those doing transactions in virtual currency. The present invention provides new and nonobvious improvements to the subject matter disclosed in U.S. Patent Application Pub. No. 20130262213, incorporated fully herein for all purposes. Various embodiments include an interface exposed to third party funding sources allowing those third party funding sources to integrate with a payment service provider. Some of the third party funding sources may offer payment using non-cash and/or non-credit funding options and/or may be virtual currency providers or provide for transactions using virtual currency. In certain aspects online or at a merchant integrated with a payment service provider, a customer may choose to pay using non-cash and/or non-credit funding options. The payment service provider and the third party funding source can, in certain aspects, communicate to transfer value from the consumer to the merchant.

Various embodiments include a generic, scalable framework for offering new payment methods to the merchant community outside of traditional electronic wallets, enabling consumers to store new payment methods inside an electronic wallet, and/or to make possible bids from multiple entities for finalizing a transaction, in certain aspects using virtual currency. In one example, the framework enables a merchant to offer an enhanced brick and mortar or e-commerce experience via integration payment service provider(s).

In an example use case, online or at a merchant site, a consumer indicates a desire to make a purchase. The merchant—or other entity or facilitator—then displays a variety of payment methods available to the consumer for making the purchase. Examples of such payment methods may include, but are not limited to: credit card; gift card; virtual currency; electronic wallet; wireless carrier billing; points (e.g. video game, travel rewards airline loyalty, retailer loyalty, financial institution loyalty); and/or market offer-based payment systems (e.g., services that pay a user to try a product or service from an advertiser). Any such entity can then provide an offer (bid) to the consumer so that the consumer finalizes the transaction with that particular entity. Re-bids may be done as described herein after a round of first bids are presented. If the consumer decides to choose a non-traditional funding method (e.g. virtual currency or loyalty points), after choosing the funding method, the consumer authenticates with that particular third party funding source through an interface, e.g. one provided by a virtual currency provider, by an eWallet provider, or one hosted by a payment service provider, authorizing the payment, and receives confirmation that the payment has completed.

In certain aspects, if the consumer decides to pay using a wallet associated with a payment service provider, the consumer then picks from the funding sources that he or she has linked to the electronic wallet (some of which may also be displayed by the merchant as stand-alone choices in the example above). Thus, a consumer who has an electronic wallet through the same payment service provider may access the funding the sources either within the wallet or simply through the merchant's interface separate from the wallet. A user who does not have an electronic wallet through the payment service provider is still able to access the variety of funding sources by virtue of shopping with the merchant.

In one aspect, a virtual currency provider that is the winner of a bidding method, and/or of a re-bid procedure, finalizes the transaction using virtual currency that passes from an account of the consumer to an account of the merchant. Optionally, in the financial services backend a third party funding source (virtual currency provider or otherwise) deposits funds directly into an account of the merchant's (in one aspect in this option there is no need for the merchant to have a separate merchant account with each third party funding source, though such relationships are not prohibited either). Any appropriate settlement model may be used, including pre-paid accounts, as described in U.S. patent application Ser. No. 13/308,248, filed Nov. 30, 2011, which is incorporated by reference in its entirety. In some embodiments, the payment services provider offers a common set of APIs to the various third party funding sources, which allows those third parties to integrate into the electronic wallets of the payment service provider as well as to integrate into merchant payment options at those merchants who use the same payment services provider.

In certain aspects in various embodiments a consumer is allowed to buy good(s) and/or service(s), e.g. but not limited to a latest version of an item, e.g. but not limited to a latest CD of a singer or the latest pair of brand-name shoes (or other goods/services) from a particular merchant using his or her credit card, electronic wallet, virtual currency, video game console points, unused loyalty points, unused credit card loyalty points, by applying the charge to his carrier bill, by completing a marketing offer from a marketing group, or some combination of a number of options, all via a single merchant integration with a virtual currency provider or a payment service provider.

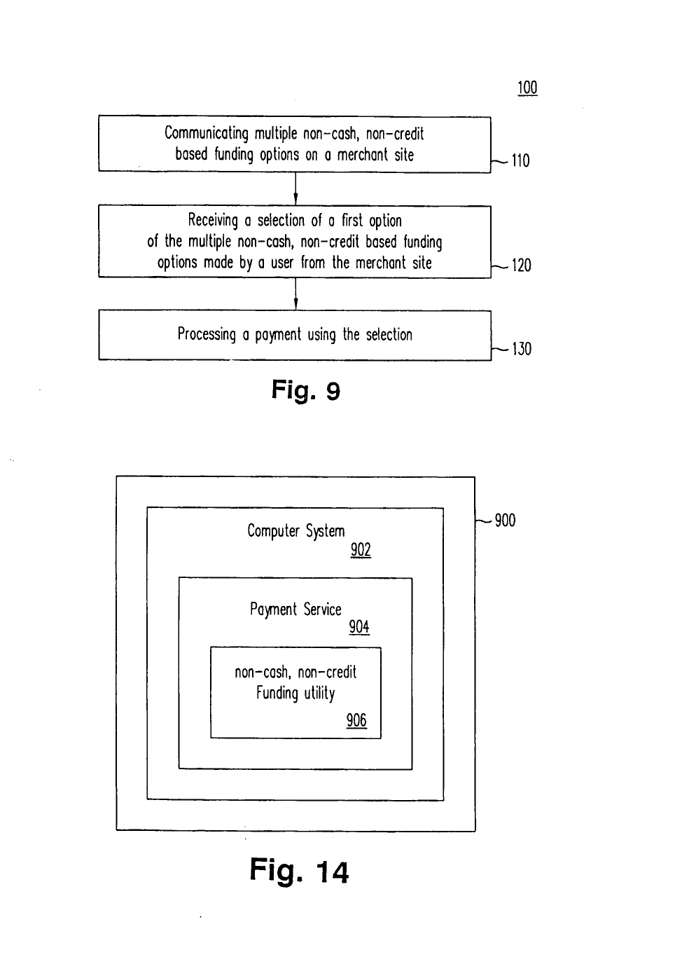

FIG. 9 is a block diagram illustrating an example process 100 adapted according to one embodiment. The actions of FIG. 9 may involve one or more of a variety of payment service providers (e.g., an entity providing an electronic payment services, such as PayPal Inc., a bank, a virtual currency entity, and/or the like). In some embodiments, the various actions are carried out by one or more computer processors executing computer code to provide the described functionality. For instance, the actions may be performed by one or more server computers that are associated with a payment service provider and/or with a virtual currency provider, provided by one or more servers or other computing devices that communicate with multiple devices via networked communication means, such as Internet, a private network, cellular communications, or other networked communications.

At block 110, the service provider communicates multiple non-cash, non-credit based funding options on a merchant site (and/or online), including multiple virtual currency options. The merchant site may include a Point of Sale (POS) or other payment computer at a physical site of a merchant or may be on an electronic commerce site accessible over the Internet or other network. Furthermore, the action of block 110 does not exclude the possibility that other, more traditional sources of value may be provided as funding options as well. For instance, in addition to non-cash, non-credit based funding options (e.g., virtual currency, loyalty points, video game console points), the service provider may also communicate options to pay by credit card, debit card, gift certificate, digital money, and the like. The communication is performed electronically over a network.

The action of block 110 assumes that the various funding sources have already been integrated with the service provider and are ready to be used to make payment by a consumer. Thus, the funding source options communicated by the payment service provider are real options for payment.

In one example, a user at a physical store is at a POS terminal and is ready to pay for a purchase. The service provider communicates the funding options to a computer system of the merchant, which displays the funding options. In certain aspects, this includes the display of various bids by various bidding entities making offers to the user so that the user will use a particular entity for the transaction (either to effect it, to use particular digital money, or both). The user sees a screen upon which the various funding options are presented. In another example, the service provider may communicate the funding options to the user via the user's mobile device before or during the transaction to make the payment selection.

In another example, the user makes a purchase online via an application, a web page, or other utility to facilitate shopping. The payment screen of the merchant presents the funding options for the user.

At block 120, the service provider receives a selection of a first option from the multiple non-cash, non-credit based funding options. For example, the user, whether at a physical store or online, selects at least one of the options to make payment for the purchase and to finalize the transaction. The user may select a non-traditional source of value (virtual currency, digital money) as a funding option in some scenarios or may choose a more traditional source of value. In some scenarios the user may make payment using two or more of the funding options. The user's selection of an option is transmitted electronically over a network. Optionally, there is a re-bid procedure for all bidders or for some bidders, as described above.

At block 130, the service provider processes the payment using the selection from block 120. In some embodiments, the service provider makes a payment to the merchant on behalf of the user and then receives a payment from the funding source. In some cases, the service provide is a virtual currency provider with whom the user has an account and the merchant is paid by this provider, either in the virtual currency or in actual money.

The scope of embodiments is not limited to the particular flow shown in FIG. 9. Rather, other embodiments may add, omit, rearrange, or modify one or more actions in accordance with a given design. For instance, other embodiments may also include allowing the user to link one or more sources of payment to an electronic wallet, where the electronic wallet is presented as a funding option in block 110, with or without the wallet using virtual currency, with or without the wallet in communication with a virtual currency provider (e.g., one with whom the user has an account). As mentioned above, various embodiments are not limited to any transaction paradigm, but rather may be used with online transactions, transactions at a merchant's POS, or transactions elsewhere.

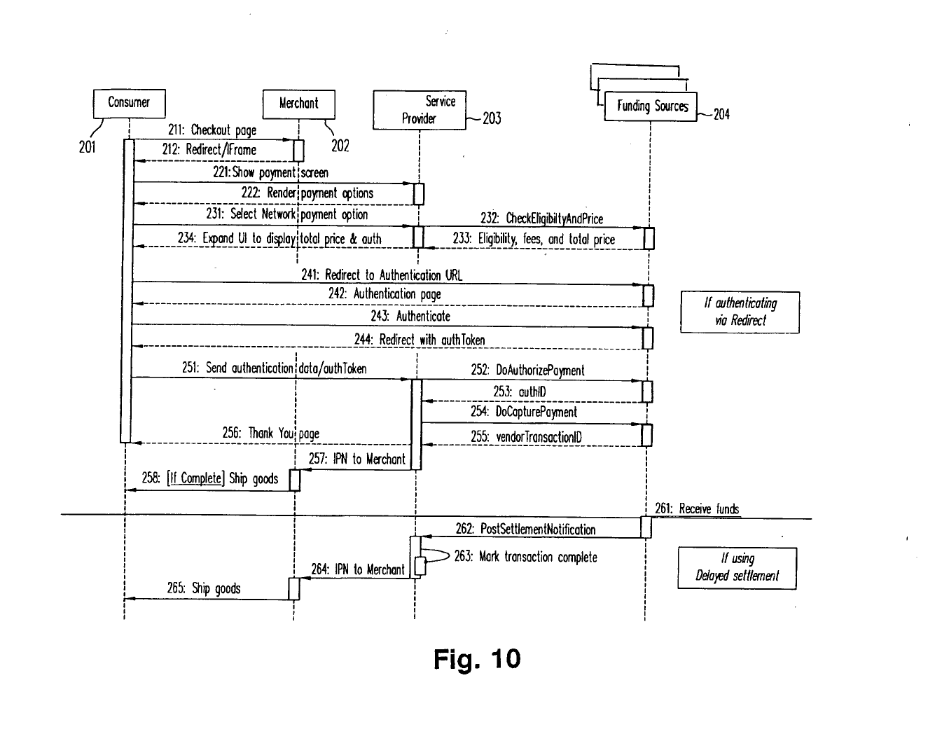

FIG. 10 is a signal diagram illustrating an example process in which a customer 201 at a merchant 202 pays for goods using a non-traditional funding source (e.g. a virtual currency from a virtual currency provider) according to one embodiment. In one aspect, the merchant 202, the services provider 203, and the funding sources 204 are in communication over one or more electronic networks, such as the Internet. Also, FIG. 10 assumes that merchant 202 is integrated with service provider 203, such that the check-out procedure is at least partially controlled by service provider 203. The customer 201 may be located at a physical store of the merchant 202 (e.g., at a POS terminal in a store) or may be using an electronic device to visit an on-line shopping site. The various signals in represent data among the various parties, where the parties represent processor-based devices of the parties. For instance, funding sources 204 and service provider 203 may have respective server computers, merchant 202 may have server computers or a POS system, and customer 201 may use a consumer electronic device or may interface directly with a POS system at a physical store of merchant 202. A funding source may be the provider 203.

At action 211, customer 201 comes to the payment page of the merchant 202. For instance, the customer 201 may see the payment page at a POS terminal in a physical store or may see the payment page at an e-commerce website. At action 212, the merchant 202 returns either a redirect to service provider 203 or a page containing a frame hosted by service provider 203. At action 221, the electronic device serving the customer 201 requests the payment screen from service provider 203. Service provider 203 determines which payment options should be offered to the customer 201, including an account provided by service provider 203, an electronic wallet, a credit card, a gift card, various non-traditional funding sources, virtual currency entities, and the like. The various options themselves may be determined based on which payment methods the merchant 202 has chosen (in a prior set up flow between the merchant 202 and payment service provider 203), as well as whether the purchase meets the criteria for each individual payment option. Each different payment option may correspond to a funding source. Thus, other examples may include more than one funding source, or as many as appropriate, depending on the number and types of payment options.

At action 222, service provider 203 returns the payment page with the list of payment options to the electronic device serving customer (consumer) 201. The page is rendered upon a screen for selection by the customer 201. The screen then displays any and all bids from any funding source, including bids from virtual currency providers, the bids including anything disclosed herein which may be part of a bid. At action 231, the customer 201 selects a payment option from the rendered screen. Optionally, a re-bid procedure ensues. In one aspect, the selected payment option is a virtual currency option that corresponds to a funding source 204.

At action 232, service provider 203 calls or communicates with the selected funding source (e.g., by a messaging protocol established by an API) to determine whether this transaction is indeed eligible for the selected payment method. Action 232 may also include the service provider 203 querying how much the transaction will cost in whichever non-traditional units (e.g., altcoins, Bitcoins, points, airline miles) are used by funding source 204. At action 233, funding source 204 returns a flag indicating whether the transaction is eligible, and if so, how many non-traditional units the funding source will charge for the payment, including any fees. Funding source 204 can provide the specific number of virtual currency units or can provide a service by converting the non-traditional source of value units into an equivalent cash value. Funding source 204 may use any appropriate criteria when converting into a cash equivalent. It is within the scope of the present invention for one status of consumers or of members to receive a better conversion rate than another status of members. In another example, purchases at particular stores or purchases of particular goods may receive a better (or worse) conversion rate. The conversation rate may be static or dynamic and may be based on terms of service with customer 201 and/or merchant 202. In one aspect, at action 233, selected funding source 204 performs a conversion from a non-traditional source of value to cash and then commits to provide a cash equivalent value in the transaction.

At action 234, the service provider 203 dynamically shows the price of the transaction in the non-traditional units. In an example in which funding source 204 uses inline authentication, payment service provider 203 displays fields that the customer 201 enters to proceed with the payment (e.g., to authorize/identify the customer 201). In an example in which funding source 204 uses authentication via redirect, then payment service provider 203 may show a login button instead of authentication fields and then follow actions 241-244. Continuing with an example in which funding source 204 uses authentication via redirect, at action 241, service provider 203 opens a screen or other interface on the electronic device to redirect the customer 201 to an authentication screen of funding source 204. At action 242, the funding source 204 shows the customer 201 an authentication screen. At action 243, the customer attempts to authenticate. For instance, a customer may enter a login/password or other authentication credential. If successful, funding source 240 redirects the customer 201 back to service provider 203, passing an authentication token to payment service provider 203. If unsuccessful, funding source 204 may let the customer 201 try again, or if authentication fails or the customer 201 cancels, funding source 204 may redirect back to service provider 203 with an appropriate code for failure/cancellation.

In an example in which funding source 204 uses inline authentication, at action 251, the customer 201 sends the authentication data (e.g., authentication fields or an authentication token) to service provider 203. If the funding source 204 supports Auth/Capture, payment service provider 203 calls funding source 204 to authorize the payment at action 252. Generally speaking, Authorization & Capture (abbreviated Auth/Capture) is a settlement solution that provides merchants increased flexibility in obtaining payments from their buyers. The solution splits a simple payment into two stages: the authorization of funds, which confirms that the consumer 201 has funds available and places a hold on the funds for some period of time (called the honor period), and the capture of funds, which moves funds from the customer's account to the merchant's account. Alternatively, another solution that may be used in some embodiments includes moving the funds soon after (or during) the transaction rather than placing a hold on the funds.

Assuming the authorization succeeds, funding source 204 sends an authorization ID back to service provider 203 at action 253. At action 254, service provider 203 calls funding source 204 to capture the funds for the payment, including the authorization ID returned previously at action 253. Funding source 204 moves the funds and creates a transaction for this payment and begins the process of collecting the funds/value from customer 201. If the payment method uses instant settlement, funding source 204 may begin the settlement process for this payment at action 254. At action 255, funding source 204 returns the transaction ID from its system so that service provider 203 can store the transaction ID for later reference. Service provider 203 then marks the transaction either [1] complete if using instant settlement, or [2] pending if using delayed settlement. At action 256, service provider 203 shows customer 201 a “Thank You” page indicating that the payment is complete.

At action 257, service provider 203 sends an Instant Payment Notification (IPN) to the merchant 202 that includes the status of the new payment. If the payment is complete (i.e. if the payment is using instant settlement), the merchant 202 then ships the goods to the customer 201. If the funding source 204 uses a delayed settlement method, then the process proceeds to actions 261-265. At action 261, funding source 204 receives funds from the customer 201, or some other event occurs such that funding source 204 is comfortable settling the transaction with service provider 203. Thus, at action 264, funding source 204 notifies service provider 203 that it wishes to settle the transaction (and then transfers funds to settle the transaction). Service provider 203 marks the transaction as complete at action 263. Service provider 203 then sends a new IPN to the merchant 202, this time showing the payment as complete at action 264. Then, merchant 202 ships goods to the customer 201.

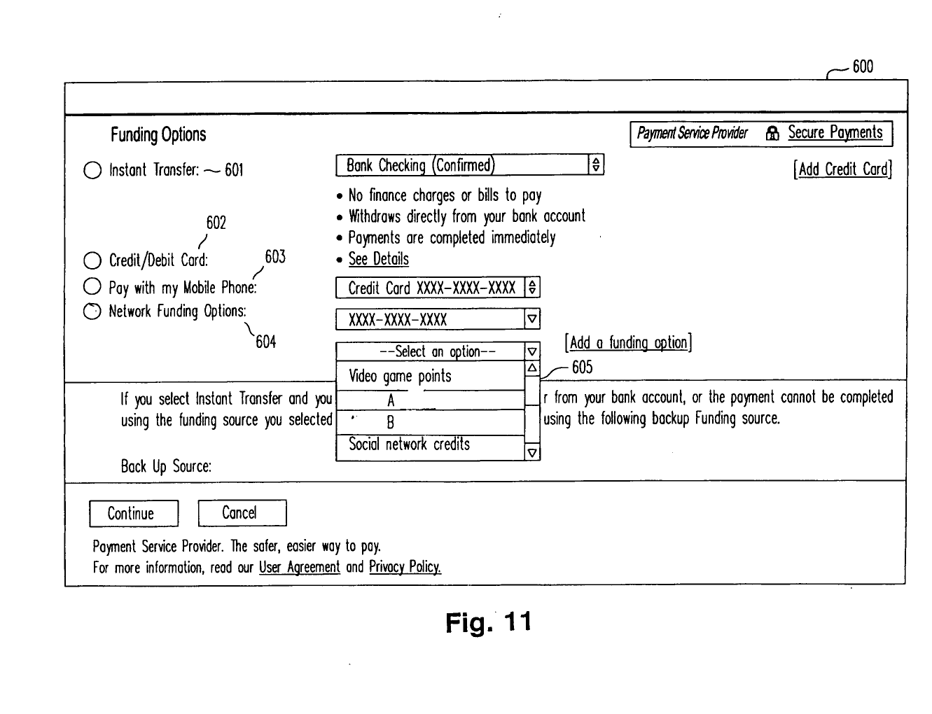

FIG. 11 is an illustration of example interface 600, adapted according to an online transaction embodiment. The interface 600 may be presented on a computing device of the consumer, and it may be presented to the consumer by a merchant as the consumer finishes an online transaction.

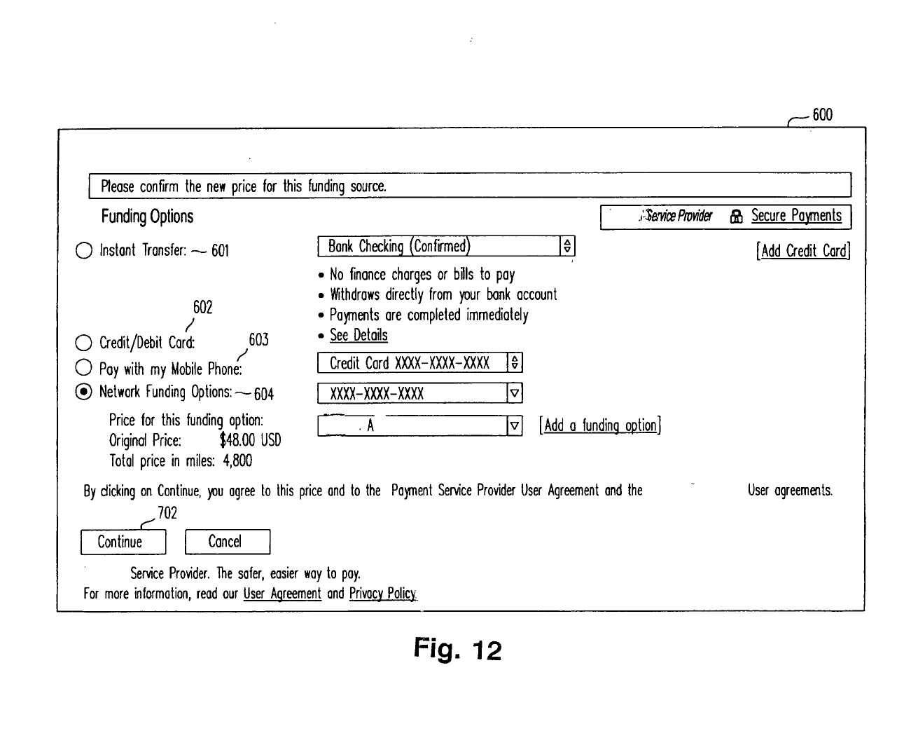

In an example as in FIGS. 11 and 12, the consumer has selected an item and now desires to receive bids from prospective transaction finalization entities and then make payment and complete the transaction. Interface 600 presents options 601-604 (options 604 including virtual currency providers), which in one aspect is for payment from the or one of the consumer's electronic wallet(s) and/or for payment with virtual currency. The first option 601 allows the consumer to pay by bank transfer; option 602 allows the consumer to make a conventional credit card payment, where the consumer submits his or her credit card information to the merchant; option 603 allows the consumer to pay by mobile phone. Option 604 allows the consumer to select one or more non-cash, non-credit funding sources (including but not limited to, by virtual currency) from the pull-down menu 605. Once options 604 are made available, each entity represented by an option is contacted and asked whether or not it is interested in bidding for this business. Each prospective bidder then presents a bid to the consumer and the consumer then selects one of the bids. (Optionally, this bidding procedure may be any bidding and/or bidding/re-bid procedure disclosed herein). In this example, the consumer has selected to use virtual currency A of the selected virtual currency provider from options 604. In this example, video game points, virtual currency B, and social network credits are also available funding options that could have been selected by the consumer.

In the background, in one aspect, the service provider, funding source, and merchant interact by APIs as described in more detail above. The service provider and funding source interact so that the funding source can finalize the transaction in the selected virtual currency or so that the source can convert its virtual currency (non-traditional source of value) into dollar equivalents or other cash equivalents. FIG. 12 is an illustration of interface 600 after the funding source has made the conversion and presented the data to be displayed to the consumer. In this example, the $48 purchase price converts to a 4800 altcoin debit from the consumer's account at virtual currency provider A. The consumer may then select “continue” button 702 to proceed to final checkout and pay. Payment is settled among the merchant, service provider, and funding source as described in more detail above.

The example of FIGS. 11 and 12 is, in one aspect, an on-line transaction; however, the scope of embodiments is not so limited. An interface similar to that shown may be presented to a customer at a physical store POS to allow the customer to pay using his or her electronic wallet and/or virtual currency. Furthermore, other embodiments may allow for a consumer to pay with various non-cash, non-credit virtual currency funding sources without using an electronic wallet. For instance, a merchant that is integrated with the service provider may provide a payment screen on a POS or on a website that displays a variety of payment options in a manner similar to that of FIG. 11. Even if the consumer does not log into an electronic wallet or virtual currency provider associated with the service provider, the consumer may still select one of the virtual currency providers and/or non-cash, non-credit funding sources as long as the consumer has an account with the selected funding source. In one example, the consumer does not have an electronic wallet but does have an account with provider A. During checkout, the merchant shows a log-in window; after log in the service provider and funding source interact to convert the non-traditional funding source (e.g. virtual currency) into cash equivalents and to communicate that conversion to the customer. The consumer can then proceed to pay using the non-traditional funding source.

FIGS. 11 and 12 are shown as illustrative examples, and other embodiments may provide different screens or different fields in order to facilitate a payment. The scope of the disclosure provides for any appropriate interface that allows for bidding, re-bidding, and/or for selection of a non-traditional source of funding.

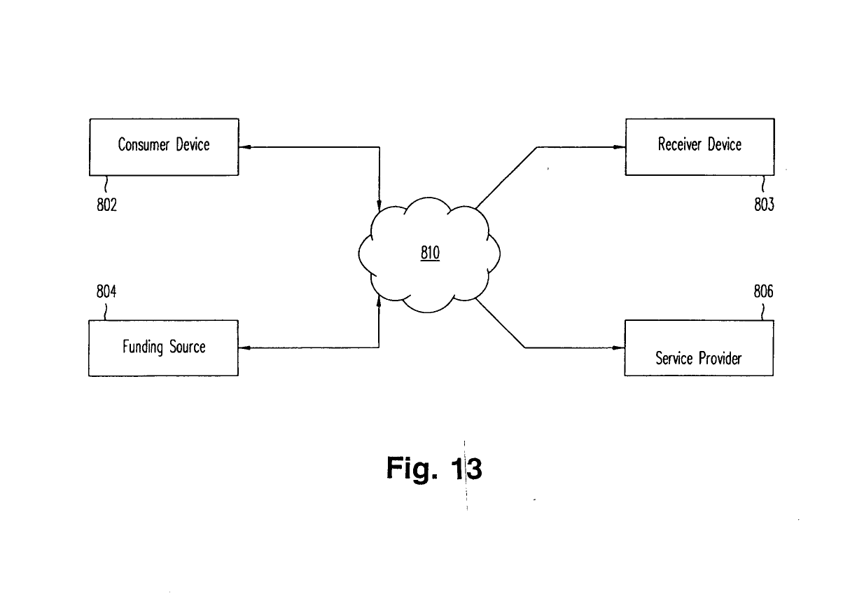

FIG. 13 is an illustration of example relationship among the various components mentioned in the descriptions of FIG. 10. In this example, device 802 corresponds to the consumer's electronic device (e.g., such as a smartphone, laptop, tablet computer, etc.). Device 803 corresponds to various computing resources associated with the payee or merchant (e.g., a POS or server computer). Service provider 806 is an electronic system(s) that maintains the merchant's financial account and includes an electronic system for communicating with electronic systems used by other financial service providers. Service provider 806 may be a virtual currency provider and/or may also provide an electronic wallet for use by the consumer. Funding source 804 is an electronic system(s) that maintains accounts for consumers and has capability for communication with electronic systems used by other funding sources and financial service providers. The various components 802, 803, 804, 806 communicate with each other over communication network 810, which may include one or more networks, such as a cellular network, the Internet, and the like.

FIG. 14 is a simplified block diagram of an example service provider 900 according to various aspects of the present disclosure. The service provider, as explained above may be an organization that processes payments on behalf of the payee and allows for payment with non-traditional sources of value. A service provider may also provide an electronic wallet or electronic wallets for use by consumers.

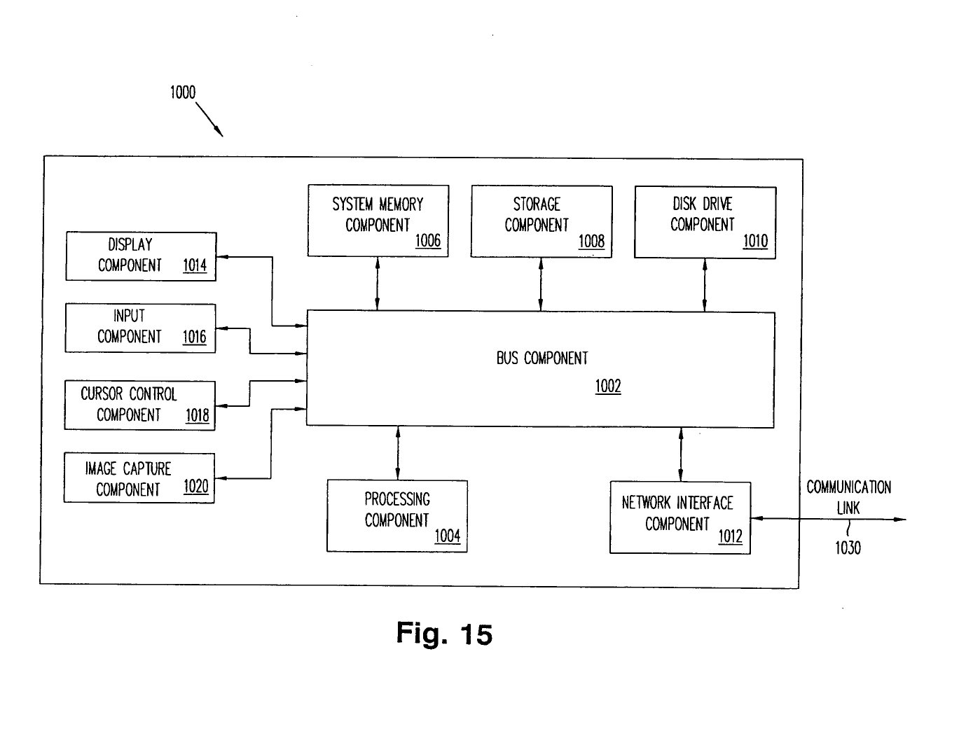

Service provider 900 includes computer system 902, which may be configured according to the example of FIG. 15 (described below), where one or more such computers may be programmed to receive instructions and/or payment instructions and to process selections and/or payments accordingly. Computer system 902 has processors that execute computer-readable code to provide the functionality of payment service program 904. Payment service program 904 includes functionality to present bids, make selections, and/or make payments, using traditional and/or non-traditional sources of value as described above. For instance, payment service program 904 can include non-cash, non-credit funding utility program 906, which communicates with non-traditional funding source(s) and with merchants to allow bids, to allow a user to select a non-traditional funding source to make a payment and/or to allow the settlement of and/or finalization of the transaction.

FIG. 15 is a block diagram of a computer system 1000 suitable for implementing various methods and devices described herein, for example, but not limited to, the various method blocks of the methods of FIGS. 9 and 10. For example, the computer system 1000 may represent a computer upon which the consumer sees interface 600. In another example, the computer system 1000 may represent a server computer or other type of computer that can be used as part of an account management or payment processing infrastructure at a financial entity (e.g., a service provider and/or a funding source) or may be implemented by a merchant. Accordingly, it should be appreciated that each of the devices may be implemented as the computer system 1000 for communication with a network in a manner as follows. In accordance with various embodiments of the present disclosure, the computer system 1000, such as a mobile communications device and/or a network server, includes a bus component 1002 or other communication mechanisms for communicating information, which interconnects subsystems and components, such as processing component 1004 (e.g., processor, micro-controller, digital signal processor (DSP), etc.), system memory component 1006 (e.g., RAM), static storage component 1008 (e.g., ROM), disk drive component 1010 (e.g., magnetic or optical), network interface component 1012 (e.g., modem or Ethernet card), display component 1014 (e.g., screens, touch-screens, cathode ray tube (CRT) displays, or liquid crystal display (LCD)), input component 1016 (e.g., keyboard or touch-sensitive components operable to detect a touch by a human body), cursor control component 1018 (e.g., mouse or trackball), and image capture component 1020 (e.g., analog or digital camera). In one implementation, disk drive component 1010 may comprise a database having one or more disk drive components.

In accordance with embodiments of the present disclosure, computer system 1000 performs specific operations by processor 1004 executing one or more sequences of one or more instructions contained in system memory component 1006. Such instructions may be read into system memory component 1006 from another computer readable medium, such as static storage component 1008 or disk drive component 1010. In other embodiments, hard-wired circuitry may be used in place of (or in combination with) software instructions to implement the present disclosure.

Logic may be encoded in a computer readable, non-transitory medium, which may refer to any medium that participates in providing instructions to processor 1004 for execution. Such a medium may take many forms, including but not limited to, non-volatile media and volatile media. In various implementations, non-volatile media includes optical or magnetic disks or flash memory, such as disk drive component 1010, and volatile media includes dynamic memory, such as system memory component 1006. Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 1000. In various other embodiments of the present disclosure, a plurality of computer systems 1000 coupled by communication link 1030 (e.g., a communications network, such as a LAN, WLAN, PTSN, and/or various other wired or wireless networks, including telecommunications, mobile, and cellular phone networks) may perform instruction sequences to practice the present disclosure in coordination with one another. Computer system 1000 may transmit and receive messages, data, information and instructions, including one or more programs (i.e., application code) through communication link 1030 and communication interface 1012. Received program code may be executed by processor 1004 as received and/or stored in disk drive component 1010 or some other storage component for execution.

It is within the scope of the present invention to provide a thing which has therein or thereon a list of potential bidders for a consumer's transactions. The thing may be accessed, scanned, interrogated, swiped, and/or communicated with so that a consumer makes known to a system and/or to potential bidders the nature and fact of a potential transaction. The thing can be an item with a tag, chip, memory, or medium with electronic data and/or computer instructions for: identifying bidders and potential bidders, conveying the data and information to intermediary system(s) between the consumer and the potential bidders; querying potential bidders regarding interest or not in the particular transaction; receiving bid(s); relaying bids to the consumer, e.g. to a computer or to a computerized device, e.g. s smartphone or cell phone; and/or relaying bids to a POS apparatus. The thing may be an electronic card, computerized device, credit card, modified COIN (trademark) card) flash drive, portable drive, or portable memory (interactive or not; collectively below called “card,” “multi-card,” or “cards”) and/or a computer app on a computer, computerized device, or phone, for a consumer which contains therein the information for all potential bidders for transactions into which the consumer wishes to enter and/or other instructions for effecting bidding and bidder choice. In one aspect the card is like a typical electronic card or credit card, but it contains information for multiple entities, e.g., but not limited to, credit card entities, eWallet providers, virtual currency providers, debit card entities, banks, and financial institutions with accounts of the consumer. If the card is an interactive card, the consumer can enter and delete data and/or information and/or instructions and, for any particular transaction, choose potential bidders for the transaction prior to communication with potential bidders (instead of each entity on the card being contacted), e.g., less than all the entities represented on the card. In certain aspects, a known card such as a COIN (trademark) card modified according to the present invention is used; or an interactive card according to the present invention is used to which the consumer can enter information about particular entities and then choose which entities are to be contacted and given the opportunity to bid for a transaction. The thing or card can contain information and programming such that when it is accessed, scanned, and/or swiped, etc., the system receiving the information communicates with each potential bidder, puts the bidders in communication with a system or systems handling the transaction, requests bids, and/or relays bids to the consumer (e.g., to a computer, phone, or POS apparatus). Optionally some or all the information and/or instructions referred to in this paragraph can be conveyed, in whole or in part, by conveying a code from the consumer, e.g. but not limited to a barcode, bokode, or any type of code, e.g., a code that includes symbols, words, letters, numerals, icons, designs, or patterns. A code on a screen of a consumer's device may be accessed to convey the code's information.

Any such step, steps, or methods may be facilitated and/or effected, in whole or in part, by computer systems, computer software, and/or computer app(s), using a network, as described above for other steps and methods according to the present invention; using, e.g., a personal computerized device such as a laptop computer, cell phone, smartphone, or tablet computer.

In certain embodiments, the present invention discloses apparatus, computer-readable storage media, and methods for allowing mobile device users to use and/or discover applications for a device or mobile device using context information describing the current environment of a device or mobile device, including, e.g. location, time, and user data (e.g., user calendar information) and transmitting computer-readable instructions for the selected application(s) to the remote device, wherein the computer-readable instructions, when executed, cause the remote device to perform a method associated with the selected applications, e.g., but not limited to, a method according to the present invention for providing bids and/or offers of multiple entities seeking to be chosen by a prospective purchaser to finalize a transaction, said entities including in certain aspects, multiple eWallet providers, and/or a method according to the present invention for providing bids and/or offers by multiple virtual money providers to be chosen for finalizing a transaction; the context information including, but not limited to, information regarding an entity unknown to a prospective purchaser which entity can be chosen to finalize a transaction, information regarding an entity unknown to a prospective purchaser which entity can be chosen to bid for finalizing a transaction, and/or an entity which will bid or offer once a first round, second round, third round, or more of bid(s) and or offer(s) has taken place. In certain aspects, such apparatus, media and methods are new and nonobvious improvements to the subject matter of U.S. Application Pub. No. 2012/0042036, incorporated fully herein for all purposes.

In some examples, the method further includes transmitting Multiple context data, e.g. second, third, fourth, etc., context data representing the second etc. device or current mobile device environment after moving the device or mobile device to a second, etc., environment, automatically receiving computer-readable instructions for a second, etc., different, application that are executable on the device or mobile device, where the second, etc., application is selected based on the transmitted second, etc. context data.

In some examples, the method further includes transmitting computer-readable instructions for the selected application(s) to the remote device, wherein the computer-readable instructions, when executed, cause the remote device to perform a method associated with the selected application(s). In some examples, the application metadata includes data based on previous usage of at least one of the applications on a device or mobile device while the device or mobile device was in or near the current location. In some examples, the data for the selected applications includes one or more network addresses associated with the selected applications. In some examples, the data for the one or more selected applications includes audio data, video data, or audio data and video data.

The following ten paragraphs apply to all apparatuses, systems, and methods according to the present invention disclosed herein.

In some examples, the method further includes selecting one of the applications, e.g. but not limited to an application of an eWallet and/or of a virtual currency provider, transmitting the selected application to a device or mobile device, e.g. but not limited to a mobile phone, and executing the selected application on the device, etc., e.g. a mobile phone. In some examples, the application is an executable program. In some examples, the metadata includes criteria, which if satisfied, result in determining the application of interest. In some examples the application is an application for an eWallet and/or virtual currency chosen by a prospective purchaser. In some examples, the method further includes automatically installing the determined and/or chosen applications, and automatically removing one or more of the determined applications if they are not accepted by a prospective purchaser, e.g. by a user of a mobile phone. In other exemplary embodiments, computer-readable storage media or device or mobile device apparatus or mobile phone store computer-readable instructions that when executed by a computer, cause the computer to perform some or all of the methods described herein. The disclosed technology can be implemented using various mobile computing platforms coupled with a network server or computing cloud providing access to applications for various mobile device platforms, including, but not limited to, cellphones, smartphones, PDAs, handheld devices, handheld computers, PDAs, netbooks, notebooks, smartphones, touch screen tablet devices, tablet computers, and laptop computers.

This disclosure is set forth in the context of representative embodiments that are not intended to be limiting in any way. As used in this application and in the claims, the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items.

The described things and methods described herein should not be construed as being limiting in any way. Instead, this disclosure is directed toward all novel and non-obvious features and aspects of the various disclosed embodiments, alone and in various combinations and sub-combinations with one another, to include all possible subcombinations and combinations. The disclosed systems, methods, and apparatus are not limited to any specific aspect or feature or combinations thereof, nor do the disclosed things and methods require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged, omitted, or performed concurrently. Moreover, for the sake of simplicity, the attached figures may not show the various ways in which the disclosed things and methods can be used in conjunction with other things and methods. Additionally, the description sometimes uses terms like “produce,” “generate,” “select,” “capture,” and “provide” to describe the disclosed methods. These terms are high-level abstractions of the actual operations that are performed. The actual operations that correspond to these terms can vary depending on the particular implementation and are readily discernible by one of ordinary skill in the art.

Any of the disclosed methods can be implemented as computer-executable instructions stored on one or more computer-readable storage media (e.g., non-transitory computer-readable media, such as one or more volatile memory components (such as DRAM or SRAM), or nonvolatile memory components (such as hard drives)) and executed on a computer (e.g., any commercially available computer, including smartphones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details (of any system or of any method herein) that are well known in the art are omitted. For example, it should be understood that the disclosed technology is not limited to any specific computer language or program. For instance, the disclosed technology can be implemented by software written in C++, Java, Perl, JavaScript, HTML5, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Theories of operation, scientific principles or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

In the following description, certain terms may be used such as “up,” “down,” “upper,” “lower,” “horizontal,” “vertical,” “left,” “right,” “over,” “on,” “near,” and the like. These terms are used, where applicable, to provide some clarity of description when dealing with relative relationships. But, these terms are not intended to imply absolute relationships, positions, and/or orientations.

As used in this disclosure, “automatically” means that an act can occur after a previous act without the need to receive additional user input before initiating performance of the act. As used in the disclosure, “application” includes programs implemented with computer-executable instructions executable by a mobile device, as well as programs where some or all of the application functionality is accessed over a network, for example, network applications or web applications. In certain embodiments, the present invention discloses apparatus, computer-readable storage media, and methods for allowing mobile device users to use and/or discover applications for a device or mobile device using context information describing the current environment of a device or mobile device, including, e.g. location, time, and user data (e.g., user calendar information) and transmitting computer-readable instructions for the selected application(s) to the remote device, wherein the computer-readable instructions, when executed, cause the remote device to perform a method associated with the selected applications, e.g., but not limited to, a method according to the present invention for providing bids and/or offers of multiple entities seeking to be chosen by a prospective purchaser to finalize a transaction, said entities including in certain aspects, multiple eWallet providers, and/or a method according to the present invention for providing bids and/or offers by multiple virtual money providers to be chosen for finalizing a transaction; the context information including, but not limited to, information regarding an entity unknown to a prospective purchaser which entity can be chosen to finalize a transaction, information regarding an entity unknown to a prospective purchaser which entity can be chosen to bid for finalizing a transaction, and/or an entity which will bid or offer once a first round, second round, third round, or more of bid(s) and or offer(s) has taken place. In certain aspects, such apparatus, media and methods are new and nonobvious improvements to the subject matter of U.S. Application Pub. No. 2012/0042036, incorporated fully herein for all purposes.

In some examples, the method further includes transmitting Multiple context data, e.g. second, third, fourth, etc., context data representing the second etc. device or current mobile device environment after moving the device or mobile device to a second, etc., environment, automatically receiving computer-readable instructions for a second, etc., different, application that are executable on the device or mobile device, where the second, etc., application is selected based on the transmitted second, etc. context data.

In some examples, the method further includes transmitting computer-readable instructions for the selected application(s) to the remote device, wherein the computer-readable instructions, when executed, cause the remote device to perform a method associated with the selected application(s). In some examples, the application metadata includes data based on previous usage of at least one of the applications on a device or mobile device while the device or mobile device was in or near the current location. In some examples, the data for the selected applications includes one or more network addresses associated with the selected applications. In some examples, the data for the one or more selected applications includes audio data, video data, or audio data and video data.

The following ten paragraphs apply to all apparatuses, systems, and methods according to the present invention disclosed herein.

In some examples, the method further includes selecting one of the applications, e.g. but not limited to an application of an eWallet and/or of a virtual currency provider, transmitting the selected application to a device or mobile device, e.g. but not limited to a mobile phone, and executing the selected application on the device, etc., e.g. a mobile phone. In some examples, the application is an executable program. In some examples, the metadata includes criteria, which if satisfied, result in determining the application of interest. In some examples the application is an application for an eWallet and/or virtual currency chosen by a prospective purchaser. In some examples, the method further includes automatically installing the determined and/or chosen applications, and automatically removing one or more of the determined applications if they are not accepted by a prospective purchaser, e.g. by a user of a mobile phone. In other exemplary embodiments, computer-readable storage media or device or mobile device apparatus or mobile phone store computer-readable instructions that when executed by a computer, cause the computer to perform some or all of the methods described herein. The disclosed technology can be implemented using various mobile computing platforms coupled with a network server or computing cloud providing access to applications for various mobile device platforms, including, but not limited to, cellphones, smartphones, PDAs, handheld devices, handheld computers, PDAs, netbooks, notebooks, smartphones, touch screen tablet devices, tablet computers, and laptop computers.

This disclosure is set forth in the context of representative embodiments that are not intended to be limiting in any way. As used in this application and in the claims, the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items.

The described things and methods described herein should not be construed as being limiting in any way. Instead, this disclosure is directed toward all novel and non-obvious features and aspects of the various disclosed embodiments, alone and in various combinations and sub-combinations with one another, to include all possible subcombinations and combinations. The disclosed systems, methods, and apparatus are not limited to any specific aspect or feature or combinations thereof, nor do the disclosed things and methods require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged, omitted, or performed concurrently. Moreover, for the sake of simplicity, the attached figures may not show the various ways in which the disclosed things and methods can be used in conjunction with other things and methods. Additionally, the description sometimes uses terms like “produce,” “generate,” “select,” “capture,” and “provide” to describe the disclosed methods. These terms are high-level abstractions of the actual operations that are performed. The actual operations that correspond to these terms can vary depending on the particular implementation and are readily discernible by one of ordinary skill in the art.

Any of the disclosed methods can be implemented as computer-executable instructions stored on one or more computer-readable storage media (e.g., non-transitory computer-readable media, such as one or more volatile memory components (such as DRAM or SRAM), or nonvolatile memory components (such as hard drives)) and executed on a computer (e.g., any commercially available computer, including smartphones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details (of any system or of any method herein) that are well known in the art are omitted. For example, it should be understood that the disclosed technology is not limited to any specific computer language or program. For instance, the disclosed technology can be implemented by software written in C++, Java, Perl, JavaScript, HTML5, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Theories of operation, scientific principles or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

In the descriptions herein, certain terms may be used such as “up,” “down,” “upper,” “lower,” “horizontal,” “vertical,” “left,” “right,” “over,” “on,” “near,” and the like. These terms are used, where applicable, to provide some clarity of description when dealing with relative relationships. But, these terms are not intended to imply absolute relationships, positions, and/or orientations.

As used in this disclosure, “automatically” means that an act can occur after a previous act without the need to receive additional user input before initiating performance of the act. As used in the disclosure, “application” includes programs implemented with computer-executable instructions executable by a mobile device, as well as programs where some or all of the application functionality is accessed over a network, for example, network applications or web applications.

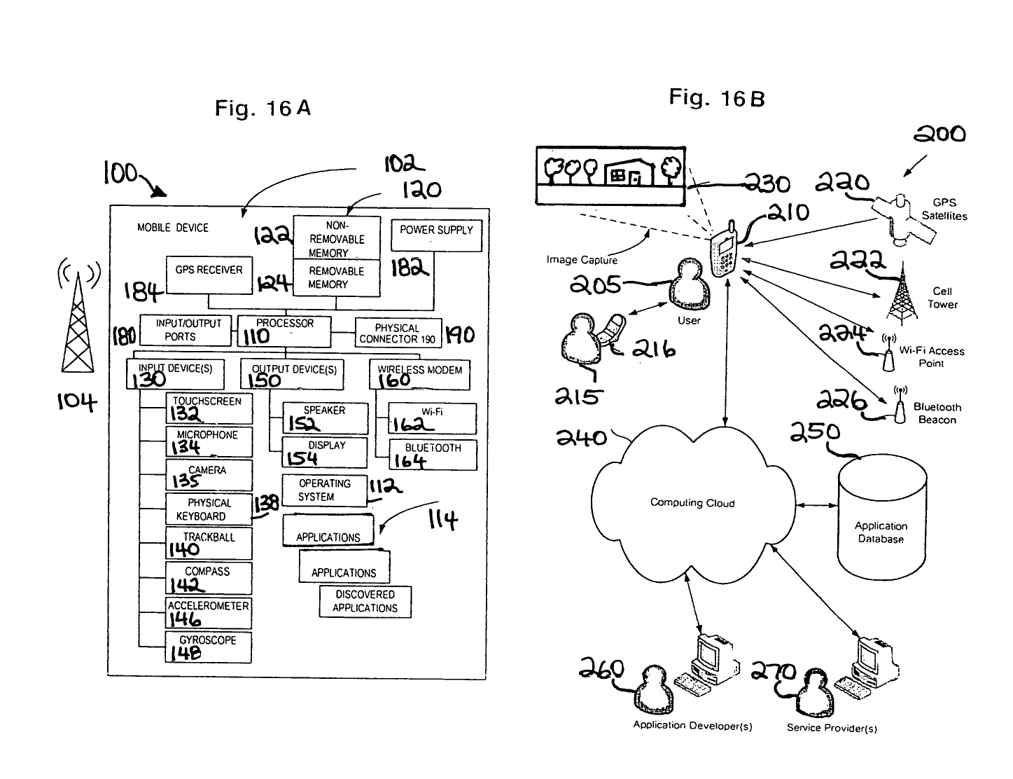

FIG. 16A is a system diagram depicting an exemplary mobile device 100 including a variety of optional hardware and software components, shown generally at 102. Any components 102 in the mobile device can communicate with any other component, although not all connections are shown, for ease of illustration. The mobile device can be any of a variety of computing devices (e.g., a cell phone, smartphone, handheld computer, or Personal Digital Assistant (PDA)) and can allow wireless two-way communications with one or more mobile communications networks 104, such as a cellular or satellite network.

The illustrated mobile device 100 can include a controller or processor 110 (e.g., a signal processor, microprocessor, ASIC, or other control and processing logic circuitry) for performing such tasks as signal coding, data processing, input/output processing, power control, and/or other functions. An operating system 112 can control the allocation and usage of the components 102, and provide support for one or more application programs 114. The discovered application programs 114 can be discovered using techniques and apparatus described herein, and automatically downloaded and installed on the mobile device 100, or accessed using a computer network. The discovered application programs 114 can include common mobile computing applications (e.g., image-capture applications, email applications, calendars, contact managers, web browsers, messaging applications), or any other computing application, including, but not limited to, applications for any or some electronic wallets, any or some methods for using virtual currency, any method for presenting multiple electronic wallet bids and/or offers, any method for choosing an electronic wallet from a plurality of electronic wallet candidates, any method for presenting multiple virtual currency bids and/or offers, and/or any method for choosing a virtual currency from a plurality of multiple virtual currency candidates

The illustrated mobile device 100 can include memory 120. Memory 120 can include non-removable memory 122 and/or removable memory 124. The non-removable memory 122 can include RAM, ROM, flash memory, a hard disk, or other well-known memory storage technologies. The removable memory 124 can include flash memory or a Subscriber Identity Module (SIM) card, which is well known in GSM communication systems, or other well-known memory storage technologies, such as “smart cards.” The memory 120 can be used for storing data and/or code for running the operating system 112 and the discovered applications 114 (which can include applications for any step or any method herein). Example data can include web pages, text, images, sound files, video data, or other data sets to be sent to and/or received from one or more network servers or other devices via one or more wired or wireless networks. The memory 120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 100 can support one or more input devices 130, such as a touch screen 132, microphone 134, camera 136, physical keyboard 138, trackball 140, compass 142, accelerometer 146, and/or gyroscope 148, and one or more output devices 150, such as a speaker 152 and one or more displays 154. Other possible output devices (not shown), can include piezoelectric or haptic output devices. Some devices can serve more than one input/output function. For example, touchscreen 132 and display 154 can be combined in a single input/output device.

A wireless modem 160 can be coupled to an antenna (not shown) and can support two-way communications between the processor 110 and external devices, as is well understood in the art. The modem 160 is shown generically and can include a cellular modem for communicating with the mobile communication network 104 and/or other radio-based modems (e.g., Bluetooth 164 or Wi-Fi 162). The wireless modem 160 is typically configured for communication with one or more cellular networks, such as a GSM network for data and voice communications within a single cellular network, between cellular networks, or between the mobile device and a public switched telephone network (PSTN).

The mobile device 100 can further include at least one input/output port 180, a power supply 182, a satellite navigation system receiver 184, such as a Global Positioning System (GPS) receiver, and/or a physical connector 190, which can be a USB port, IEEE 1394 (FireWire) port, and/or RS-232 port. The illustrated components 102 are not required or all-inclusive, as any components can be deleted and other components can be added.

The mobile device 100 can use multiple input sources for determining geospatial position, velocity, or orientation of the mobile device. For example, GPS receiver 184 can be used to determine geospatial coordinates by receiving signals transmitted from global positioning satellites. Alternatively, signals received from one or more mobile communications networks 104 (e.g., terrestrial communication networks) can be used to determine geospatial coordinates. In some examples, data received using GPS receiver 184 and one or more mobile communications networks 104 can be combined to provide more accurate geospatial position or orientation, and in a faster manner. In addition, the mobile device 100 can use data from one or more compasses 142, accelerometers 146 and/or gyroscopes 148 to calculate the orientation, velocity, and/or heading of the mobile device. In some examples, an image capture device, such as a camera 136, can be used with image recognition software to determine current context data for the mobile device 100. For example, images of famous landmarks (e.g., the Eiffel Tower, the Space Needle, or the Taj Mahal), billboards, or merchant logos (e.g., logos displayed outside a Starbucks store or McDonald's restaurant) can be used to determine the location or context of the mobile device.

FIG. 16B depicts an example computing environment 200 suitable for implementing described embodiments, techniques, and technologies disclosed herein. As shown, a user 205 is carrying a smartphone 210. In some examples, other platforms can be used, including but not limited to, cellphones, smartphones, PDAs, handheld devices, handheld computers, PDAs, touch screen tablet devices, tablet computers, and laptop computers.

As shown, the smartphone 210 can receive global positioning data signals from one or more satellites 220. Other location data can also be received or determined from one or more cell phone towers 222, a Wi-Fi access point 224 (e.g., an 802.11b or 802.11n access point), or a Bluetooth beacon 226. This location data can include, for example, a Service Set Identifier (SSID), Media Access Control (MAC) address, Bluetooth Device Address, or other data that can be used to determine location data for a Wi-Fi or Bluetooth access point. Cell phone technologies than can be used to determine location data include Cell Identification, Enhanced Cell Identification, U-TDOA, TOA, AOA, E-OTD, or Assisted-GPS, and in some examples the smartphone 210 can use two or more of the location-determining technologies in combination with each other to determine or enhance location data. Location data can also be received or determined from other mobile device users, for example, a user 215 with a Bluetooth-enabled cellphone 216.

The smartphone 210 can also acquire an image 230 (e.g. but not limited to an image of an item or thing to be purchased or rented), using, e.g., a camera, and submit the captured image to an image-recognition service. The image-recognition service can use the image to transmit information about an item or thing to another server or remote device; and/or to determine the identity of the item or thing; and/or to determine the location of the smartphone 210. For example, the smartphone 210 can capture an image of a landmark, billboard, logo, or bar code in proximity with the mobile device, and submit the image to a service provider 270 (described below), which can then estimate the user's current location. The smartphone 210 is depicted capturing an image of the Louvre museum (but it could be, e.g., an image of anything for sale in the museum's gift shop). Based on determining what the captured image is, e.g. that the captured image is relevant to the Louvre museum, applications associated with purchasing the item of thing or with the Louvre (providing images, background information, and locations on a map for exhibits) can be automatically downloaded and executed using the smartphone 210.

The smartphone 210 can also communicate with one or more servers located in a computing cloud 240. The computing cloud 240 can store and read data by accessing an application database 250, which stores application metadata, including computer-readable instructions and/or addresses for application programs, audio data, and video data that can be executed or played back by the smartphone 210, as well as context data for determining the relevance of the application metadata given a current context of the mobile device. Any application of any method herein can be stored in the database and/or can be downloaded to the mobile device. Location data can be also be stored in the application database 250. The mobile device environment and context are “current” in that they include dynamically-updated data reflecting the state of the object and nearby surrounds. For example, an application for providing information about animals can be associated with application metadata describing locations within the boundaries of a zoo. The computing cloud 240 can communicate with the mobile device 210, application developers 260, and/or service providers 270 using the Internet, cellular networks, or other suitable communication networks.

The computing cloud 240 can receive application metadata from one or more application developers 260 for describing the relevancy of mobile device applications in a given mobile device environment. For examples, developers of specific applications, such as a museum guide for the Louvre museum or a zoo guide for the Woodland Park Zoo can generate application metadata describing geographical locations where a specific application is more relevant, and then upload the application metadata, along with the application itself, to an application store or other application discovery service. The application metadata can also describe other relevant data for a current mobile device environment. For example, application metadata for a mountain resort location can describe skiing-related applications as more relevant during winter months and mountain biking-related applications as more relevant during summer months. The metadata may be for any application herein according to the present invention.

As shown, the computing environment 200 can include one or more service providers 270; which can be any service provider for providing electronic wallet service, any service provider for providing virtual currency (virtual currency includes digital money) service, and/or that provide service components for generating application metadata. For example, a first service component gathers data based on location-based information and associates the location data with applications or other content. A second service component operates with a mobile device to provide content to a mobile device user based upon their current geographical location as well as other context data describing their current environment, including traffic conditions, weather, season, time, or events (e.g., promotions, concerts, or festivals). A third service component can be used to aggregate geographical data based on known points of interest (e.g., retailer locations such as Starbucks stores or McDonald's restaurants) to provide more colloquial forms of location information.

Context data is transmitted (e.g., to a remote server or computing cloud). Application data describing the one or more applications selected, including but not limited to those based on the transmitted context data, is received using, for example, a computer network. In some examples, the application data includes computer-readable instructions executable by a device or a mobile device for executing one or more of the selected applications. In some examples, the application metadata includes references (e.g., a network address or web address associated with an application) that describe network locations for accessing an application from a remote location. In some examples, the application metadata includes data such as audio, video, or image data that is determined to be relevant for the given context data. In some examples, the application data can refer to applications that have already been installed on a mobile device. In some examples, the application data is deleted from the device if the application is not used or selected by the user based on certain criteria, such as a period of time, while in other examples the application data for an unused application remains on the device for an indeterminate period of time.

The present invention provides new and nonobvious improvements to the subject matter of U.S. Pat. No. 8,788,333, including but not limited to, the addition of choosing one electronic wallet from a plurality of electronic wallets to finalize a transaction and/or choosing one virtual money from a plurality of virtual money providers; said patent incorporated fully herein for all purposes and said addition(s) improving any and all methods in said patent.

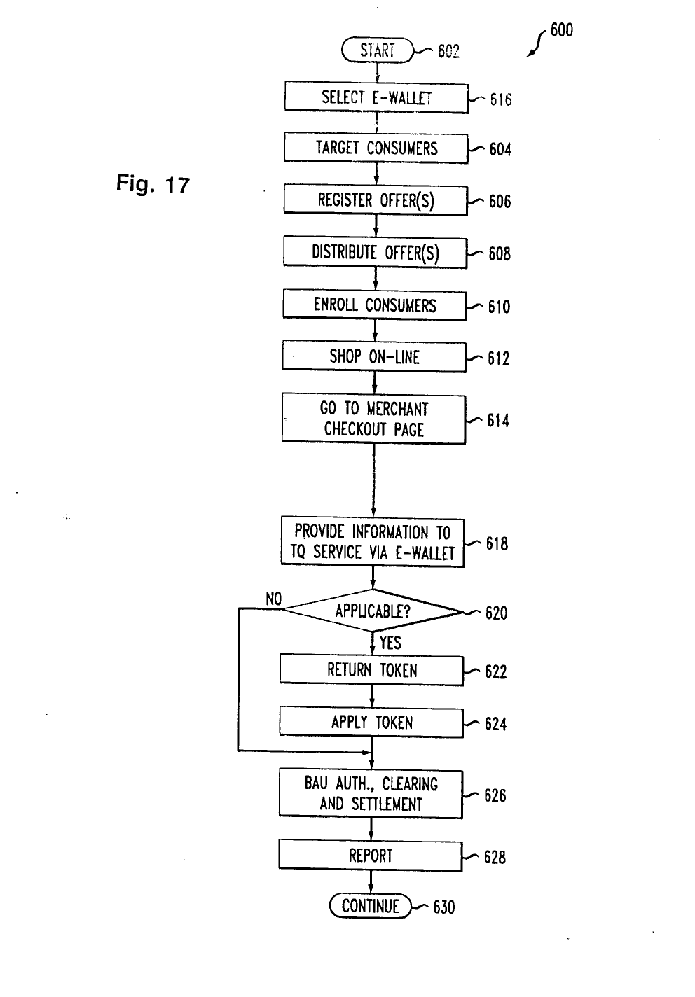

Particular individual elements, items, devices, tokens, warehouse, web pages, network, service, identifiers, reports and platforms are, e.g., as disclosed in U.S. Pat. No. 8,788,33. FIG. 17 shows steps in a method according to the present invention in which, in the step labeled SELECT E-WALLET multiple possible eWallets are presented to a consumer along with any bids or offers from each eWallet. The consumer then proceeds with eWallet selection—which may be any eWallet selection method according to the present invention—and/or in the SELECT EWALLET step multiple virtual currency (e.g. digital money) providers) make bid(s) and/or (offers(s) and the consumer proceeds with any method according to the present invention for selecting a virtual money provider to finalize the transaction.

The flow chart 600 of FIG. 17 begins in block 602 at START and then in step 616 one of a plurality of possible entities—eWallet and/or virtual currency provider—is chosen. This exemplary method then proceeds with the step of obtaining, from the chosen eWallet platform, e.g. directly from the provider or from a check-out web page of a merchant: (i) a unique identification of a given consumer, and/or of a plurality of consumers, who is/are purchasing at least one item from the merchant in an on-line transaction, and (ii) associated transaction data. The method also includes the step of supplying, by the electronic wallet platform, to a transaction qualification service, the unique identification of the given consumer (step 618).

In some instances, the consumer's PAN (primary account number; credit or debit card number) may be used as the unique identification. In other instances, an alternate unique identifier could be generated and used. Furthermore, the associated transaction data could include, by way of a non-limiting example, merchant name, merchant return link, session ID, eWallet provider name, virtual money provider name, and the like. In some instances, the associated transaction data may include an identifying indicia of the at least one item (for example, a stock-keeping unit or SKU; a universal product code or UPC, or some other code such a as a special code for prescription drugs or the like).

A further step includes retrieving, by a transaction qualification service, from a consumer enrollment database, a record wherein at least one useful token is stored in association with the unique identification of the given consumer. A still further step includes determining, by the transaction qualification service, based on rules from an offers registry database, whether the at least one useful token is applicable to the on-line transaction. These two steps are generally depicted in FIG. 17 as decision block 620. The rules are stored in the offers registry database in association with the at least one useful token, the rules take into account the unique identification of the given consumer and/or the associated transaction data, in determining the applicability.

As per the “YES” branch of block 620, if, based on the determining step, the at least one useful token is applicable to the on-line transaction, provide the at least one useful token to the merchant, as per block 622, using the transaction qualification service and the chosen electronic wallet platform. The at least one useful token is provided to the merchant prior to payment card authorization, clearing, and settlement for the on-line transaction (see below with respect to optional step 626).

Optionally, a promotion code (such as an online merchant discount code) is a non-limiting example of the at least one useful token. In one aspect, a token is a previously acquired token from an eWallet provider or from a virtual currency provider. As will be discussed in greater detail below, it could be another type of code or string of data of use to the merchant; a representation of points; some other type of identifier (to gauge response to a targeted advertisement), and the like. The token is not necessarily limited to an offer or discount; it can be a name of a bidder or entity making an offer or it might just include information that the given consumer had been part of an earlier communication.

In an optional additional step 624, subsequent to receiving the promotion code, the merchant revises a monetary amount associated with the on-line transaction (i.e., in accordance with the code, for example, by applying the discount or the like). In an optional additional step 626, subsequent to the merchant revising the monetary amount associated with the on-line transaction, the merchant initiates the payment card authorization, clearing, and settlement for the on-line transaction, based on the revised monetary amount, typically in a “business as usual” manner.

In step 620, in some cases, the rules may take into account, for example, the associated transaction data; the associated transaction data can include an identifying indicia, as discussed above, of the at least one item. In step 620, in some cases, the rules may take into account the unique identification of the given consumer; for example, by accessing the given consumer's transaction history based on the unique identification of the given consumer. Information pertaining to the consumer's transaction history can be stored, for example, in a data warehouse operated by an operator of a payment network; or the transaction history may already be available on one or more platforms and accessed by the operator of a payment network; e.g., on an issuer platform operated by an issuer or an issuer processor; within an existing e-wallet, and so on. Other possible locations will also be apparent to the skilled artisan, given the teachings herein.

In an optional additional step 628, the merchant can report the outcome of the on-line transaction to the chosen electronic wallet platform and/or chosen virtual currency provider and/or the transaction qualification service.

In the event that block 620 returns “NO,” the return and application of the token may be bypassed and processing may proceed, for example, to step 626. In at least some instances, it may be desirable to provide report 628 even when a “NO” is returned in block 620—for example, where several purchases are needed to become eligible.

Optionally in an optional additional step 616, the consumer can affirmatively confirm selection of the chosen eWallet; for example, in response to a prompt which prompts the given consumer to select the electronic wallet platform from the check-out web page (perhaps as simple as a button or selectable link to the e-wallet). Of course, it will be appreciated that prior to such point, the given consumer may shop on-line, as per step 612, and then navigate to the merchant check-out page as per step 614.

An optional additional step 604 includes the operator of the payment card network targeting the plurality of consumers in connection with an offer associated with the promotion code. A further optional additional step 606 includes populating the offers registry database. A still further optional additional step 610 includes enrolling the consumers. In some cases, this step includes automatically enrolling the plurality of consumers in the consumer enrollment database. In another aspect, an additional optional step 608 includes distributing an offer associated with the promotion code to at least the plurality of consumers. Step 610 then involves accepting enrollment of the plurality of consumers, in the consumer enrollment database, in response to the offer. Offers may of course be distributed to a larger group of consumers than those who ultimately choose to register.

Any one, some, or all of the following steps—604, 606, 608, 610, 616, 618, 620, can be carried out or facilitated by a payment network which may be, for example, of the kind wherein the operator is a single operator which facilitates transactions between multiple issuers and multiple acquirers.

Another optional step includes providing a system, wherein the system includes distinct software modules, each embodied on at least one tangible computer readable recordable storage medium, including an electronic wallet platform module to implement wallet choice, and a transaction qualification service module, a consumer enrollment database module, and an offers registry database module to implement or facilitate the various steps. The blocks may be implemented by the software modules together with corresponding memories and one or more processors. In a preferred but non-limiting approach, elements for these steps are each separate software modules and each runs on its own server with its own processor(s) and memory(ies).

In any method according to the present invention disclosed herein, an entity (e.g. eWallet provider or virtual currency provider) may have a relationship with a thing-provider (product provider, service provider) such that if a prospective purchaser chooses an item or a service for possible purchase, either that entity becomes and is one of the entities that bids and/or offers to be chosen to finalize the transaction or that entity makes (or increases) an offer or a bid that reflects the relationship. In one aspect, any and/or all such relationships are publicized and/or made known to a prospective purchaser prior to item choice or service choice, optionally along with how that relationship may result in some better price, future advantage, bid, bid increase, offer, offer increase, future reward, reward, discount, future coupon, points, or award for the prospective purchaser (collectively referred to as “price, etc.”). Such a relationship and any reward, bid and/or offer etc. is effected by a computer app and, in one aspect, this app or another app effects presentation of the reward, etc. so that it appears on a screen of a device, e.g. a computer screen or a phone screen, when the prospective purchaser first chooses the item or thing. Any method herein can include the triggering—when a total amount is reached—of a price, etc. The price etc. can be triggered when the total is simply the price of a single item or service which exceeds a present threshold for one transaction; the total for that consumer using a particular eWallet and/or virtual currency of combined past purchases; and/or the total for that consumer using a particular payment method and/or purchasing from a particular entity that sells (or leases).

The present invention provides an optional Universal Total function for any provider—including payment provider, ISP provider, webpage provider, search engine provider, eWallet provider or virtual currency provider. The provider publicizes a total of business done for a stated preselected time period, e.g. but not limited to money amount for all transactions, or total number of transactions, publicized on any suitable media, e.g. active public billboards, email provider homepages, website homepages, main pages such as e.g. the main home page of MSN, Yahoo, Google, Amazon, Mozilla; and/or on a screen when the consumer initiates shopping, initiates item or service selection, or selects a particular item or service. The consumer sees a displayed total and a “target total” which, if reached, results in everyone who uses that provider following reaching of the target total receiving a price, etc. In one aspect, any consumer who contributes to reaching the target total receives, retroactively, the benefit of the price, etc. or some specified price, etc.

What is claimed is:

1.-100. (canceled)

101. A method, the method comprising
using a thing to facilitate a transaction, the thing comprising a body having accessible electronic information, the accessible electronic information including identifying information, the identifying information including information identifying a plurality of entities each of whom a consumer desires to bid to be a chosen entity for a transaction into which the consumer desires to enter, the thing having a display, the thing having interaction apparatus for interaction with the consumer,
using the thing displaying on the display to the consumer each entity for bidding for the transaction, and
by interaction with the thing, the consumer choosing an entity to be the entity for the transaction.

102. The method of claim 101 further comprising
the consumer interacting with the thing following the display of each entity for bidding to eliminate at least one of said entities so that no bid is received from said entity.

103. The method of claim 101 further comprising
the consumer interacting with the thing following the display of each entity for bidding to select a plurality of said entities to be allowed to bid for the transaction.

104. The method of claim 101 wherein the thing is one of a multi-card, electronic card, smartcard, computerized device, and COIN (trademark) card.

105. The method of claim 101 wherein the thing has computer apparatus for providing the display and for facilitating consumer interaction with the display for entity selection, the computer apparatus with computer media programmable for effecting the providing of the display and facilitating the consumer interaction with the display for the entity selection.

106. The method of claim 101 further comprising adding a new entity to the plurality of entities by adding identifying information to the accessible electronic information for the new entity, the thing having apparatus for such adding.

107. The method of claim 106 wherein the thing has computer apparatus for facilitating adding the new entity, the computer apparatus with computer media programmable to facilitate said adding.

108. The method of claim 101 further comprising
the thing having computer apparatus with computer media programmed so that upon accessing of the accessible identifying information the accessible identifying information is provided to a reception system which in turn communicates with each entity and requests a bid from each entity, the method further comprising
requesting a bid from each entity.

109. The method of claim 108 wherein said accessing is done by one of swiping of the thing, scanning the thing, downloading information from the thing, offloading information from the thing, and code recognition/viewing of the information.

110. The method of claim 101 wherein the entities include one or a combination of credit card issuers, debit card issuers, eWallet providers, digital money providers, banks, and financial institutions.

111. The method of claim 110 wherein the consumer has a master account and each of the entities is able to access the master account.

112. The method of claim 111 further comprising
payment of a money amount into the master account by an entity chosen for the transaction.

113. A method, the method comprising
using a thing to facilitate a transaction, the thing comprising a body having accessible electronic information, the accessible electronic information including identifying information, the identifying information including information identifying a plurality of entities each of whom a consumer desires to bid to be a chosen entity for a transaction into which the consumer desires to enter, the thing having a display, the thing having interaction apparatus for interaction with the consumer,
using the thing displaying on the display to the consumer each entity for bidding for the transaction, and
by interaction with the thing, the consumer choosing an entity to be the entity for the transaction,
the consumer interacting with the thing following the display of each entity for bidding to select selected entities comprising a plurality of said entities to be allowed to bid for the transaction,
the thing having computer apparatus with computer media programmed so that upon accessing of the accessible identifying information the accessible identifying information is provided to a reception system which in turn communicates with each of the selected entities and requests a bid from each of the selected entities,
the method further comprising requesting a bid from each of the selected entities,
wherein said accessing is done by one of swiping of the thing, scanning of the thing, downloading information from the thing, offloading information from the thing, and code recognition/viewing of the information,
wherein the entities include one or a combination of credit card issuers, debit card issuers, eWallet providers, digital money providers, banks, and financial institutions.

114. A thing, the thing for facilitating a transaction for a consumer, the thing comprising
a body having accessible electronic information, the accessible electronic information including identifying information, the identifying information including information identifying a plurality of entities each of whom a consumer desires to bid to be a chosen entity for a transaction into which the consumer desires to enter,
a display connected to the body for displaying to the consumer each entity for bidding for the transaction,
interaction apparatus associated with the body providing consumer interaction for the consumer to choose an entity to be the entity for the transaction.

115. The thing of claim 114 further comprising
the interaction apparatus permitting the consumer to eliminate one of the entities so that no bid is received from said eliminated entity.

116. The thing of claim 114 further comprising
the interaction apparatus permitting the consumer to select less than all of the entities to be allowed to bid for the transaction.

117. The thing of claim 114 wherein the thing is one of a multi-card, electronic card, smartcard, computerized device, and COIN (trademark) card.

118. The thing of claim 114 the thing further comprising
computer apparatus for control of, interaction with, and communication with the display, and for facilitating adding a new entity for consideration as a bidder,
the computer apparatus having computer media programmed for effecting provision of the display, facilitating the consumer interaction with the display for entity selection, and for adding a new entity to the plurality of entities and adding identifying information to the accessible electronic information for the new entity.

119. The thing of claim 114 further comprising
the computer apparatus for communication with a reception system, in said communication the computer apparatus for providing the accessible identifying information to the reception system which in turn is able to communicate with each entity and able to request a bid from each entity.

120. The thing of claim 114 wherein information of the thing is accessing by one of swiping of the thing, scanning the thing, downloading information from the thing, offloading information from the thing, and code recognition/viewing of the information.
